(19) United States
(12) Patent Application Publication
(10) Pub. No.: US 2022/0159402 A1
(43) Pub. Date: May 19, 2022

(54) SIGNAL PROCESSING DEVICE AND METHOD, AND PROGRAM

(71) Applicant: SONY GROUP CORPORATION, TOKYO (JP)

(72) Inventors: TETSU MAGARIYACHI, TOKYO (JP); YUHKI MITSUFUJI, TOKYO (JP)

(21) Appl. No.: 17/440,550

(22) PCT Filed: Mar. 16, 2020
(86) PCT No.: PCT/JP2020/011361

§ 371 Date: Sep. 17, 2021

(30) Foreign Application Priority Data
Mar. 28, 2019 (JP) 2019-063882

(51) Int. Cl. H04S 7/00; H04R 5/033

(52) U.S. Cl. CPC H04S 7/304; H04R 5/033; H04S 2400/11; H04S 2400/01; H04S 2420/11; H04S 2420/01

(57) ABSTRACT

The present technology relates to a signal processing device, a signal processing method, and a program that enable more efficient sound reproduction.

A signal processing device includes an order determination unit that determines an order for limiting an operation amount of an operation related to a rotation matrix corresponding to head rotation of a listener, a rotation operation unit that rotates a head-related transfer function of a spherical harmonic domain by the operation in which the rotation matrix is limited by the order, and a synthesis unit that generates a headphone drive signal by synthesizing the head-related transfer function after rotation obtained by the operation with a sound signal in the spherical harmonic domain. The present technology can be applied to an audio processing device.

### TECHNICAL FIELD

The present technology relates to a signal processing device and method, and a program, and more particularly relates to a signal processing device and method, and a program that enable more efficient sound reproduction.

### BACKGROUND ART

In recent years, development and widespread use of systems for recording, transmitting, and reproducing spatial information from the entire periphery in the field of audio has been in progress. For example, in Super Hi-Vision, broadcasting with three-dimensional 22.2 multi-channel audio is planned.

Furthermore, in the field of virtual reality, devices that reproduce a signal that surrounds the entire periphery also in audio, in addition to a video that surrounds the entire periphery, are spreading in the world.

Among them, there is a method of expressing three-dimensional audio information that is called Ambisonics and can flexibly support any recording and reproduction system, and is attracting attention. In particular, Ambisonics whose degree is second or higher is called higher order Ambisonics (HOA) (see, for example, Non-Patent Document 1).

In a three-dimensional multichannel sound, sound information spreads on a spatial axis in addition to a time axis, and in the Ambisonics, frequency conversion, that is, spherical harmonic transform is performed with respect to an angular direction of three-dimensional polar coordinates to retain information. The spherical harmonic transform can be considered to correspond to time-frequency transform with respect to the time axis of the audio signal.

An advantage of this method is that information can be encoded and decoded from any microphone array to any speaker array without limiting the number of microphones or speakers.

On the other hand, factors that hinder the spread of the Ambisonics include the need for a speaker array including a large number of speakers in a reproduction environment, and a narrow range (sweet spot) in which a sound space can be reproduced.

For example, in order to increase the spatial resolution of sound, a speaker array including more speakers is required, but it is unrealistic to make such a system at home or the like. Furthermore, in a space such as a movie theater, an area where a sound space can be reproduced is narrow, and it is difficult to give a desired effect to all spectators.

### CITATION LIST

### Non-Patent Document

Non-Patent Literature 1: Jerome Daniel, Rozenn Nicol, Sebastien Moreau, “Further Investigations of High Order Ambisonics and Wavefield Synthesis for Holophonic Sound Imaging,” AES 114th Convention, Amsterdam, Netherlands, 2003.

### SUMMARY OF THE INVENTION

### Problems to be Solved by the Invention

Accordingly, it is conceivable to combine the Ambisonics and binaural reproduction technology. The binaural reproduction technology is generally called a virtual auditory display (VAD), and is achieved by using a head-related transfer function (HRTF).

Here, the head-related transfer function represents information regarding how sound is transmitted from all directions surrounding the human head to the eardrums of both ears as a function of a frequency and an arrival direction.

In a case where a synthetic sound of the head-related transfer function from a certain direction with a target sound is presented by the headphones, the listener perceives as if the sound comes not from the headphones but from the direction of the head-related transfer function used. The VAD is a system using such a principle.

By reproducing a plurality of virtual speakers using the VAD, it is possible to achieve the same effect as the Ambisonics in a speaker array system including a large number of speakers, which is difficult in reality, by headphone presentation.

However, it has not been possible with such a system to reproduce sound sufficiently efficiently. For example, in a case where the Ambisonics and the binaural reproduction technology are combined, not only an operation amount such as a convolution operation of a head-related transfer function increases, but also a usage amount of a memory used for the operation and the like increases.

The present technology has been made in view of such a situation, and is intended to enable sound to be reproduced more efficiently.

### Solutions to Problems

A signal processing device according to one aspect of the present technology includes an order determination unit that determines an order for limiting an operation amount of an operation related to a rotation matrix corresponding to head rotation of a listener, a rotation operation unit that rotates a head-related transfer function of a spherical harmonic domain by the operation in which the rotation matrix is limited by the order, and a synthesis unit that generates a headphone drive signal by synthesizing the head-related transfer function after rotation obtained by the operation with a sound signal in the spherical harmonic domain.

A signal processing method or a program according to one aspect of the present technology includes determining an order for limiting an operation amount of an operation related to a rotation matrix corresponding to head rotation of a listener, rotating a head-related transfer function of a spherical harmonic domain by the operation in which the rotation matrix is limited by the order, and generating a headphone drive signal by synthesizing the head-related transfer function after rotation obtained by the operation with a sound signal in the spherical harmonic domain.

In one aspect of the present technology, an order for limiting an operation amount of an operation related to a rotation matrix corresponding to head rotation of a listener is determined, a head-related transfer function of a spherical harmonic domain is rotated by the operation in which the rotation matrix is limited by the order, and a headphone drive signal is generated by synthesizing the head-related transfer function after rotation obtained by the operation with a sound signal in the spherical harmonic domain.

### BRIEF DESCRIPTION OF DRAWINGS

FIG. 1 is a diagram describing simulation of stereophonic sound using a head-related transfer function.

FIG. 2 is a diagram describing calculation of a drive signal in a first method.

FIG. 3 is a diagram describing calculation of a drive signal in a case of performing head tracking.

FIG. 4 is a diagram describing calculation of a drive signal in a second method.

FIG. 5 is a diagram describing calculation of a drive signal in a third method.

FIG. 6 is a diagram describing an operation amount and a necessary memory amount.

FIG. 7 is a diagram describing calculation of a drive signal in a fourth method.

FIG. 8 is a diagram describing a rotation matrix.

FIG. 9 is a diagram describing the rotation matrix.

FIG. 10 is a diagram describing the rotation matrix.

FIG. 11 is a diagram illustrating a configuration example of an audio processing device.

FIG. 12 is a diagram describing a difference in an elevation angle direction.

FIG. 13 is a flowchart describing drive signal generation processing.

FIG. 14 is a diagram illustrating a configuration example of an audio processing device.

FIG. 15 is a flowchart describing drive signal generation processing.

FIG. 16 is a diagram illustrating a configuration example of a control system.

FIG. 17 is a diagram describing a reset and an operation amount.

FIG. 18 is a diagram describing resetting for each degree.

FIG. 19 is a diagram describing resetting for each time frequency.

FIG. 20 is a diagram illustrating a configuration example of a control system.

FIG. 21 is a diagram illustrating a configuration example of an audio processing device.

FIG. 22 is a flowchart describing drive signal generation processing.

FIG. 23 is a diagram describing a reset timing.

FIG. 24 is a diagram describing a reset timing.

FIG. 25 is a diagram illustrating a configuration example of an audio processing device.

FIG. 26 is a flowchart describing drive signal generation processing.

FIG. 27 is a diagram illustrating a configuration example of an audio processing device.

FIG. 28 is a flowchart describing drive signal generation processing.

FIG. 29 is a diagram describing setting of an allowable error for each time frequency.

FIG. 30 is a diagram describing setting of an allowable error according to a degree.

FIG. 31 is a diagram illustrating a configuration example of a computer.

### MODE FOR CARRYING OUT THE INVENTION

Hereinafter, embodiments to which the present technology is applied will be described with reference to the drawings.

### First Embodiment

<First Method>

The present technology obtains a head-related transfer function in a spherical harmonic domain according to the rotation of the head using stacking of minute rotations, and synthesizes the head-related transfer function with an input signal of sound to be reproduced in the spherical harmonic domain, thereby achieving a more efficient reproduction system in terms of the operation amount and the memory usage.

For example, a spherical harmonic transform for the function f(θ, φ) on the spherical coordinates is expressed by following Equation (1).

[Equation 1]

Fₙ^{m}=∫₀^{2π}∫₀^{π}f(θ,ϕ)Y̅ₙ̅^̅{̅m̅}̅(θ,ϕ)sin θdθdϕ (1)

In Equation (1), θ and φ represent an elevation angle and a horizontal angle in spherical coordinates, respectively, and Yₙ^{m}(θ, φ) represents spherical harmonics. Furthermore, a symbol “-” above the spherical harmonics Yₙ^{m}(θ, φ) represents a complex conjugate of the spherical harmonics Yₙ^{m}(θ, φ).

Here, the spherical harmonics Yₙ^{m}(θ, φ) is expressed by following Equation (2).

$$[ Equation 2 ]$$

$${Y}_{n}^{m} ( θ , ϕ ) = {( - 1 )}^{m} \sqrt{\frac{( 2 n + 1 ) ( n - m ) !}{4 π ( n + m ) !}} {P}_{n}^{m} ( cos θ ) {e}^{im ϕ} \qquad ( 2 )$$

In Equation (2), n and m represent the degree and order of the spherical harmonics Yₙ^{m}(θ, φ), and −n≤m≤n. The order m is also referred to as an order, a period, or the like, and hereinafter, when it is not necessary to particularly distinguish n and m, the degree n and the order m will also be collectively referred to as a degree.

Furthermore, in Equation (2), i represents a pure imaginary number, and Pₙ^{m}(x) is an associated Lujandre function.

When n≥0 and 0≤m≤n, the associated Lujandre function Pₙ^{m}(x) is expressed by following Equation (3) or (4). Note that Equation (3) is a case where m=0.

$$\begin{matrix}[ Equation 3 ] & \\ {P}_{n}^{0} ( x ) = \frac{1}{{2}^{n} n !} \frac{{d}^{n}}{{dx}^{n}} {( {x}^{2} - 1 )}^{n} & ( 3 ) \\ [ Equation 4 ] & \\ {P}_{n}^{m} ( x ) = {( 1 - {x}^{2} )}^{m \text{/} 2} \frac{{d}^{n}}{{dx}^{n}} {P}_{m}^{0} ( x ) & ( 4 )\end{matrix}$$

Furthermore, in a case where −n≤m≤0, the associated Lujandre function Pₙ^{m}(x) is expressed by following Equation (5).

$$[ Equation 5 ]$$

$${P}_{n}^{m} ( x ) = {( - 1 )}^{- m} \frac{( n + m ) !}{( n - m ) !} {P}_{n}^{- m} ( x ) \qquad ( 5 )$$

Moreover, an inverse transform from the function Fₙ^{m} subjected to the spherical harmonic transform to the function f(θ, φ) on the spherical coordinates is as represented in following Equation (6).

$$[ Equation 6 ]$$

$$f ( θ , ϕ ) = {\sum }_{n = 0}^{∞} {\sum }_{m = - n}^{n} {F}_{n}^{m} {Y}_{n}^{m} ( θ , ϕ ) \qquad ( 6 )$$

From the above, conversion from the sound input signal D′ₙ^{m}(ω) after performing radial correction, which are retained in the spherical harmonic domain, into speaker drive signals S(xᵢ, ω) of L respective speakers arranged on a spherical surface with a radius R is as represented in following Equation (7).

$$[ Equation 7 ]$$

$$S ( {x}_{i} , ω ) = {\sum }_{n = 0}^{N} {\sum }_{m = - n}^{n} {D}_{n}^{′ m} ( ω ) {Y}_{n}^{m} ( {β}_{i} , {α}_{i} ) \qquad ( 7 )$$

Note that in Equation (7), xᵢ represents the position of the speaker, and ω represents the time frequency of a sound signal. The input signal D′ₙ^{m}(ω) is a sound signal corresponding to each degree n and order m of the spherical harmonics for a given time frequency ω.

Furthermore, xᵢ=(R sin θᵢ cos φᵢ, R sin θᵢ sin φᵢ, R cos θᵢ), where i indicates a speaker index for specifying a speaker. Here, i=1, 2, . . . , L, and θᵢ and φᵢ respectively represent an elevation angle and a horizontal angle indicating the position of an i-th speaker.

Such a transform expressed by Equation (7) is a spherical harmonic inverse transform corresponding to Equation (6). Furthermore, in a case where a speaker drive signal S(xᵢ, ω) is obtained by Equation (7), the number of speakers L that is the number of reproduction speakers and the degree N of the spherical harmonics, that is, the maximum value N of the degree n need to satisfy the relationship represented in following Equation (8).

[Equation 8]

L>(N+1)² (8)

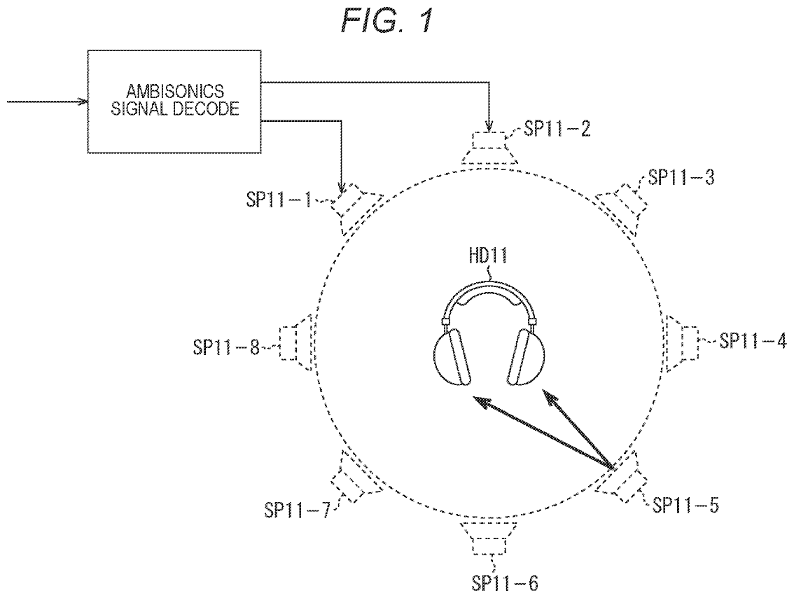

Meanwhile, a general method for simulating stereophonic sound at the ears by headphone presentation is, for example, a method using the head-related transfer function as illustrated in FIG. 1.

In the example illustrated in FIG. 1, the input Ambisonics signal is decoded, and respective speaker drive signals of virtual speakers SP11-1 to SP11-8, which are a plurality of virtual speakers, are generated. The signal decoded at this time corresponds to, for example, the above-described input signal D′ₙ^{m}(ω).

Here, the virtual speakers SP11-1 to SP11-8 are arranged in a loop and virtually arranged, and the speaker drive signal of each virtual speaker is obtained by the above-described calculation of Equation (7). Note that, hereinafter, the virtual speakers SP11-1 to SP11-8 will also be simply referred to as the virtual speakers SP11 in a case where it is not particularly necessary to distinguish them.

When the speaker drive signals of the respective virtual speakers SP11 are obtained in this manner, left and right drive signals (binaural signals) of headphones HD11 that actually reproduce sound are generated by the convolution operation using the head-related transfer function for each of the virtual speakers SP11. Then, the sum of the respective drive signals of the headphones HD11 obtained for the respective virtual speakers SP11 is set as the final drive signal.

Note that such a method is described in detail in, for example, “ADVANCED SYSTEM OPTIONS FOR BINAURAL RENDERING OF AMBISONIC FORMAT (Gerald Enzner et. al. ICASSP 2013)” or the like.

The head-related transfer function H(x, ω) used to generate the left and right drive signals of the headphones HD11 is obtained by normalizing a transfer characteristic H₁(x, ω) from a sound source position x to an eardrum position of the user in a state where the head of the user who is a listener exists in the free space with a transfer characteristic H₀(x, ω) from the sound source position x to a head center O in a state where the head does not exist. That is, the head-related transfer function H(x, ω) for the sound source position x is obtained by following Equation (9).

$$[ Equation 9 ]$$

$$H ( x , ω ) = \frac{{H}_{1} ( x , ω )}{{H}_{0} ( x , ω )} \qquad ( 9 )$$

Here, by convolving the head-related transfer function H(x, ω) into any audio signal and presenting the audio signal with headphones or the like, it is possible to give the listener a perceptual illusion as if the sound is heard from the direction of the convoluted head-related transfer function H(x, ω), that is, the direction of the sound source position x.

In the example illustrated in FIG. 1, the left and right drive signals of the headphones HD11 are generated using such a principle.

Specifically, the position of each virtual speaker SP11 is set as a position xᵢ, and the speaker drive signal of each virtual speaker SP11 is set as S(xᵢ, ω).

Furthermore, the number of virtual speakers SP11 is L (here, L=8), and the final left and right drive signals of the headphones HD11 are Pₗ and Pᵣ, respectively.

In this case, when the speaker drive signal S(xᵢ, ω) is simulated by the presentation of the headphones HD11, the left and right drive signals Pₗ and Pᵣ of the headphones HD11 can be obtained by calculating following Equation (10).

$$[ Equation 10 ]$$

$${P}_{l} = {\sum }_{i = 1}^{L} S ( {x}_{i} , ω ) {H}_{l} ( {x}_{i} , ω ) \\ {P}_{r} = {\sum }_{i = 1}^{L} S ( {x}_{i} , ω ) {H}_{r} ( {x}_{i} , ω ) \qquad ( 10 )$$

Note that, in Equation (10), Hₗ(xᵢ, ω) and Hᵣ(xᵢ, ω) represent normalized head-related transfer functions from the position xᵢ of the virtual speaker SP11 to the left and right eardrum positions of the listener, respectively.

By such operation, an input signal D′ₙ^{m}(ω) in the spherical harmonic domain can be finally reproduced by headphone presentation. That is, it is possible to achieve the same effect as Ambisonics by headphone presentation.

Note that in the following description, the drive signal Pₗ and the drive signal Pᵣ for the time frequency ω will also be simply referred to as drive signals P(ω) in a case where it is not particularly necessary to distinguish the drive signal Pₗ and the drive signal Pᵣ. Furthermore, hereinafter, in a case where it is not particularly necessary to distinguish the head-related transfer function Hₗ(xᵢ, ω) and the head-related transfer function Hᵣ(xᵢ, ω) from each other, they will also be simply referred to as head-related transfer functions H(xᵢ, ω).

Moreover, in the following description, a method of combining Ambisonics and binaural reproduction technology described above will also be referred to as a first method.

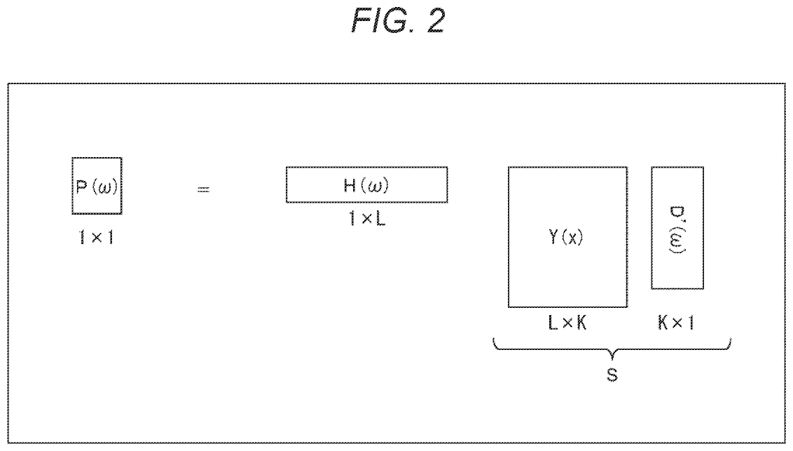

In the first method, for example, the operation illustrated in FIG. 2 is performed to obtain the drive signal P(ω) of 1×1, that is, one row and one column.

In FIG. 2, H(ω) represents a vector (matrix) of 1×L including L head-related transfer functions H(xᵢ, ω). Furthermore, D′(ω) represents a vector including the input signal D′ₙ^{m}(ω), and when the number of input signals D′ₙ^{m}(ω) in a bin of the same time frequency ω is K, a vector D′(ω) is K×1. Moreover, Y(x) represents a matrix including spherical harmonics Yₙ^{m}(θᵢ, φᵢ) of each degree, and the matrix Y(x) is a matrix of L×K.

Therefore, in the first method, a matrix (vector) S obtained from a matrix operation of the L×K matrix Y(x) and the K×1 vector D′(ω) is obtained, and a matrix operation of the matrix S and the vector (matrix) H(ω) of 1×L is further performed to obtain one drive signal P(ω).

Furthermore, in a case where the head of the listener wearing the headphones HD11 rotates in a predetermined direction represented in a rotation matrix gⱼ (hereinafter, also referred to as a direction gⱼ), for example, a drive signal Pₗ(gⱼ, ω) of the left headphone of the headphones HD11 is as represented in following Equation (11).

$$[ Equation 11 ]$$

$${P}_{l} ( {g}_{j} , ω ) = {\sum }_{i = 1}^{L} S ( {x}_{i} , ω ) {H}_{l} ( {g}_{j}^{- 1} {x}_{i} , ω ) \qquad ( 11 )$$

Note that the rotation matrix gⱼ is a three-dimensional, that is, a 3×3 rotation matrix represented by α, β, and γ which are rotation angles of Euler angles. Furthermore, in Equation (11), the drive signal Pₗ(gⱼ, ω) indicates the drive signal Pₗ described above, and here, the drive signal Pₗ(gⱼ, ω) is described in order to clarify the position, that is, the direction gⱼ and the time frequency ω.

In this case, it is only required to acquire the rotation direction of the head of the listener, that is, the direction gⱼ of the head of the listener by some sensor, and calculate the left and right drive signals of the headphones HD11 by using the head-related transfer function of a relative direction gⱼ⁻¹xᵢ of each virtual speaker SP11 viewed from the head of the listener among the plurality of head-related transfer functions. Thus, as in a case of using a real speaker, even in a case where sound is reproduced by the headphones HD11, a sound image position viewed from the listener can be fixed in the space.

<Second Method>

Furthermore, the convolution of the head-related transfer function performed in the time-frequency domain in the first method may be performed in the spherical harmonic domain. In this manner, the operation amount and the memory amount required can be reduced as compared with the first method, and sound can be reproduced more efficiently. A method for performing the convolution of the head-related transfer function in such a spherical harmonic domain is also referred to as a second method, and this second method will be described below.

For example, focusing on the left headphone, a vector Pₗ(ω) including each drive signal Pₗ(gⱼ, ω) of the left headphone with respect to all rotation directions of the head of the user (listener) who is the listener is expressed as represented in following Equation (12).

$$[ Equation 12 ]$$

$$\begin{matrix}{P}_{l} ( ω ) = H ( ω ) S ( ω ) \\ = H ( ω ) Y ( x ) {D}^{′} ( ω )\end{matrix} \qquad ( 12 )$$

Note that in Equation (12), S(ω) is a vector including the speaker drive signal S(xᵢ, ω), and S(ω)=Y(x)D′(ω). Furthermore, in Equation (12), Y(x) represents a matrix including spherical harmonics Yₙ^{m}(xᵢ) of each degree and the position xᵢ of each virtual speaker, which is expressed by following Equation (13). Here, i=1, 2, . . . , L, and the maximum value (maximum degree) of the degree n is N.

D′(ω) represents a vector (matrix) including the input signal D′ₙ^{m}(ω) of the sound corresponding to each degree indicated by following Equation (14). Each input signal D′ₙ^{m}(ω) is a sound signal in the spherical harmonic domain.

Moreover, in Equation (12), H(ω) represents a matrix including the head-related transfer function H(gⱼ⁻¹xᵢ, ω) of the relative direction gⱼ⁻¹xᵢ of each virtual speaker viewed from the head of the listener in a case where the direction of the head of the listener is the direction gⱼ, which is expressed by following Equation (15). In this example, head-related transfer functions H(gⱼ⁻¹xᵢ, ω) of the respective virtual speakers are prepared for a total of M respective directions from the direction g₁ to the direction g_{M}.

$$\begin{matrix}[ Equation 13 ] & \\ Y ( x ) = ( \begin{matrix}{Y}_{0}^{0} ( {x}_{1} ) & ⋯ & {Y}_{N}^{N} ( {x}_{1} ) \\ ⋮ & ⋱ & ⋮ \\ {Y}_{0}^{0} ( {x}_{L} ) & ⋯ & {Y}_{N}^{N} ( {x}_{L} )\end{matrix} ) & ( 13 ) \\ [ Equation 14 ] & \\ {D}^{′} ( ω ) = ( \begin{matrix}{D}_{0}^{′0} ( ω ) \\ ⋮ \\ {D}_{N}^{′ N} ( ω )\end{matrix} ) & ( 14 ) \\ [ Equation 15 ] & \\ H ( ω ) = ( \begin{matrix}H ( {g}_{1}^{- 1} {x}_{1} , ω ) & ⋯ & H ( {g}_{1}^{- 1} {x}_{L} , ω ) \\ ⋮ & ⋱ & ⋮ \\ H ( {g}_{M}^{- 1} {x}_{1} , ω ) & ⋯ & H ( {g}_{M}^{- 1} {x}_{L} , ω )\end{matrix} ) & ( 15 )\end{matrix}$$

Upon calculating the drive signal Pₗ(gⱼ, ω) of the left headphone when the head of the listener is facing the direction gⱼ, it is only required to perform the calculation of Equation (12) by selecting a row corresponding to the direction gⱼ that is the direction of the head of the listener, that is, a row including the head-related transfer function H(gⱼ⁻¹xᵢ, ω) for the direction gⱼ from the matrix H(ω) of the head-related transfer functions.

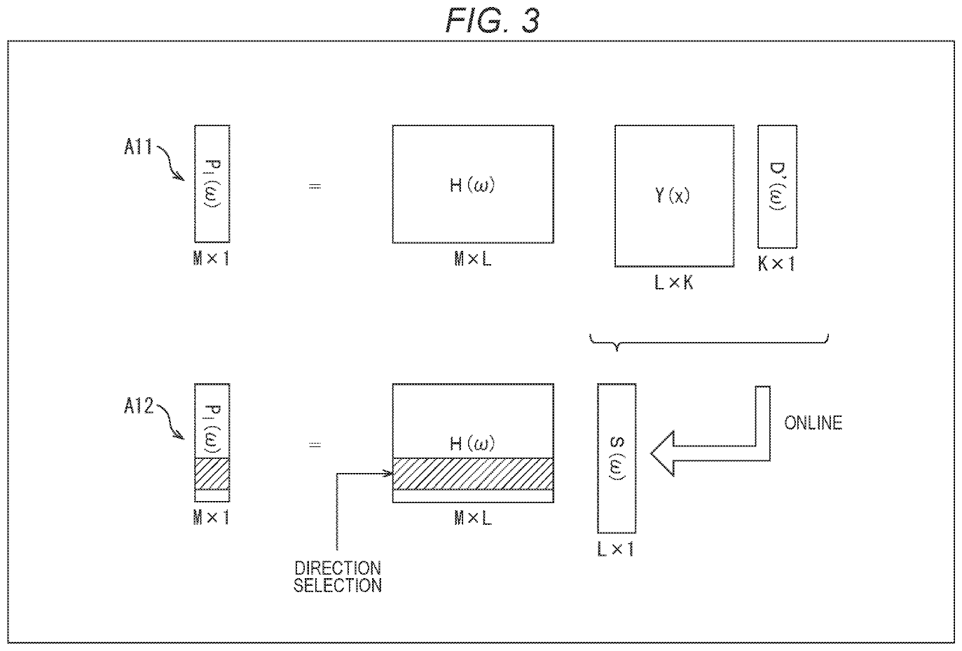

In this case, for example, only necessary rows are calculated as illustrated in FIG. 3.

In this example, since the head-related transfer function is prepared for each of the M directions, the matrix calculation represented in Equation (12) is as indicated by an arrow A11.

That is, when the number of input signals D′ₙ^{m}(ω) of the time frequency ω is K, the vector D′(ω) is K×1, that is, a matrix of K rows and one column. Furthermore, the matrix Y(x) of the spherical harmonics is L×K, and the matrix H(ω) is M×L. Therefore, in the calculation of Equation (12), the vector Pₗ(ω) is M×1.

Here, if the vector S(ω) is obtained by first performing a matrix operation (product-sum operation) of the matrix Y(x) and the vector D′(ω) in the online operation, at the time of calculating the drive signal Pₗ(gⱼ, ω), a row corresponding to the direction gⱼ of the head of the listener can be selected from the matrix H(ω) as indicated by an arrow A12, so as to reduce the operation amount. In FIG. 3, a hatched portion in the matrix H(ω) represents a row corresponding to the direction gⱼ, and the operation of this row and the vector S(ω) are performed to calculate a desired drive signal Pₗ(gⱼ, ω) of the left headphone.

Here, when a matrix H′(ω) is defined as represented in following Equation (16), the vector Pₗ(ω) represented in Equation (12) can be expressed by following Equation (17).

[Equation 16]

H′(ω)=H(ω)Y(x) (16)

[Equation 17]

Pₗ(ω)=H′(ω)D′(ω) (17)

In Equation (16), by the spherical harmonic transform using the spherical harmonics, the matrix H(ω) including the head-related transfer function, more specifically, the head-related transfer function in the time-frequency domain is converted into the matrix H′(ω) including the head-related transfer function in the spherical harmonic domain.

Therefore, in the calculation of Equation (17), convolution of the speaker drive signal and the head-related transfer function is performed in the spherical harmonic domain. In other words, the product-sum operation of the head-related transfer function and the input signal is performed in the spherical harmonic domain. Note that the matrix H′(ω) can be calculated and retained in advance.

In this case, upon calculating the drive signal Pₗ(gⱼ, ω) of the left headphone when the head of the listener is directed in the direction gⱼ, it is only required to perform the calculation of Equation (17) by selecting a row corresponding to the direction gⱼ of the head of the listener from the matrix H′(ω) retained in advance.

In such a case, the calculation of Equation (17) is a calculation represented in following Equation (18). Thus, the operation amount and the required memory amount can be significantly reduced.

$$[ Equation 18 ]$$

$${P}_{l} ( {g}_{j} , ω ) = {\sum }_{n = 0}^{N} {\sum }_{m = - n}^{n} {H}_{n}^{′ m} ( {g}_{j} , ω ) {D}_{n}^{′ m} ( ω ) \qquad ( 18 )$$

In Equation (18), H′ₙ^{m}(gⱼ, ω) represents a head-related transfer function of the spherical harmonic domain to be one element of the matrix H′(ω), that is, a component (element) corresponding to the direction gⱼ of the head in the matrix H′(ω). n and m in the head-related transfer function H′ₙ^{m}(gⱼ, ω) indicate the degree n and the order m of the spherical harmonics.

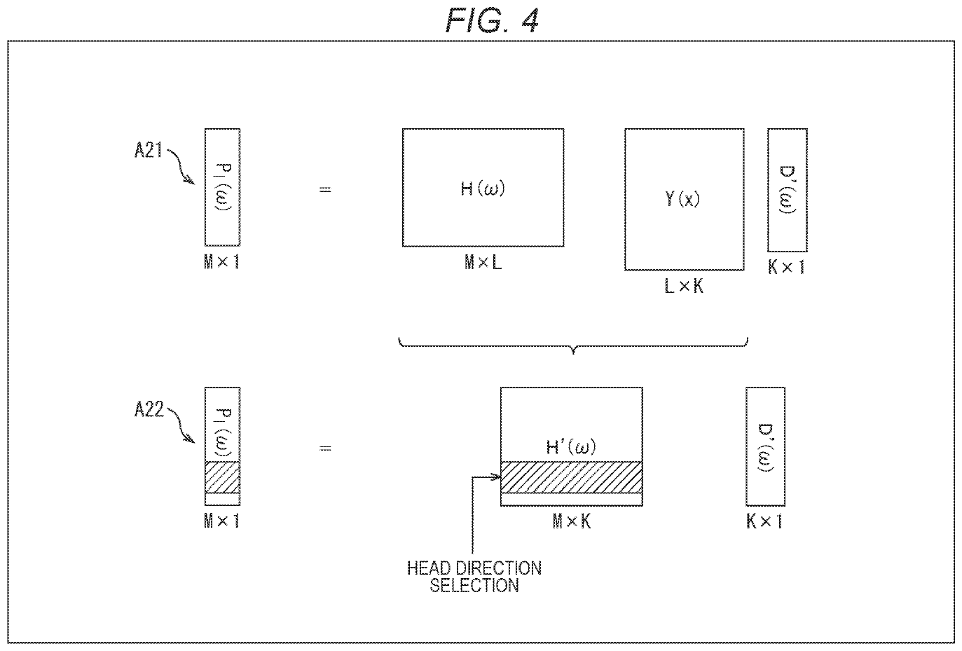

In such an operation represented in Equation (18), the operation amount is reduced as illustrated in FIG. 4. That is, the calculation represented in Equation (12) is a calculation for obtaining a product of the matrix H(ω) of M×L, the matrix Y(x) of L×K, and the vector D′(ω) of K×1 as indicated by an arrow A21 in FIG. 4.

Here, since H(ω)Y(x) is the matrix H′(ω) as defined in Equation (16), the calculation indicated by the arrow A21 eventually becomes as indicated by an arrow A22. In particular, since the calculation of obtaining the matrix H′(ω) can be performed offline, that is, in advance, if the matrix H′(ω) is obtained and retained in advance, it is possible to reduce the operation amount when obtaining the drive signal of the headphones online by that amount.

If the matrix H′(ω) is obtained in advance in this manner, the calculation indicated by the arrow A22, that is, the above-described calculation of Equation (18) is performed when the drive signal of the headphones is actually obtained.

That is, a row corresponding to the direction gⱼ of the head of the listener is selected from the matrix H′(ω) as indicated by the arrow A22, and the drive signal Pₗ(gⱼ, ω) of the left headphone is calculated by a matrix operation of the selected row and the vector D′(ω) including the input signal D′ₙ^{m}(ω). In FIG. 4, a hatched portion in the matrix H′(ω) represents a row corresponding to the direction gⱼ, and an element constituting this row is the head-related transfer function H′ₙ^{m}(gⱼ, ω) represented in Equation (18).

<Third Method>

Incidentally, in the second method described above, while the operation amount and the necessary memory amount can be greatly reduced, it is necessary to retain all rotation directions of the head of the listener, that is, rows corresponding to respective directions gⱼ on the memory as the matrix H′(ω) of the head-related transfer function.

Therefore, a matrix (row vector) including the head-related transfer function of the spherical harmonic domain for one direction gⱼ may be set as H_{S}(ω)=H′(gⱼ), only a row vector H_{S}(ω), which is a row corresponding to one direction gⱼ of the matrix H′(ω), may be retained, and a rotation matrix R′(gⱼ) for performing rotation corresponding to head rotation of the listener in the spherical harmonic domain may be retained by the number of a plurality of respective directions gⱼ. Hereinafter, such a method will be referred to as a third method.

The rotation matrix R′(gⱼ) in each direction gⱼ is different from the matrix H′(ω) and has no time-frequency dependence. Thus, in the third method, the memory amount can be significantly reduced as compared with a case where the matrix H′(ω) has the component of the rotation direction gⱼ of the head.

First, a product H′(gⱼ⁻¹, ω) of a row H(g ω) corresponding to a predetermined direction gⱼ of the matrix H(ω) and a matrix Y(x) of the spherical harmonics is considered as represented in following Equation (19).

[Equation 19]

H′(gⱼ⁻¹,ω)=H(gⱼ⁻¹x,ω)Y(x) (19)

In the second method described above, coordinates of the head-related transfer function to be used with respect to the rotation direction gⱼ of the head of the listener are rotated from x to gⱼ⁻¹x, but the same result can be obtained even if the coordinates of the spherical harmonics are rotated from x to gⱼx without changing the coordinates of the position x of the head-related transfer function. That is, following Equation (20) holds.

[Equation 20]

H′(gⱼ⁻¹,ω)=H(gⱼ⁻¹x,ω)Y(x)=H(x,ω)Y(gⱼx) (20)

Moreover, the matrix Y(gⱼx) of the spherical harmonics is a product of the matrix Y(x) and a rotation matrix R′(gⱼ⁻¹) and is as represented in following Equation (21). Note that the rotation matrix R′(gⱼ⁻¹) is a matrix that rotates coordinates by gⱼ in the spherical harmonic domain.

[Equation 21]

Y(gⱼx)=Y(x)R′(gⱼ⁻¹) (21)

Here, for a set Q represented in following Equation (22), elements other than elements in a (n²+n+1+k) row and a (n²+n+1+m) column, where (n²+n+1+k), (n²+n+1+m)ϵQ, of the rotation matrix R′(gⱼ) are zero.

[Equation 22]

Q={q|n²+1≤q≤(n+1)²,q,nϵ{0,1,2 . . . }} (22)

Therefore, spherical harmonics Yₙ^{m}(gⱼx), which is an element of the matrix Y(gⱼx), can be expressed by following Equation (23) using an element R′⁽ⁿ⁾_{k, m}(gⱼ) of the (n²+n+1+k) row and the (n²+n+1+m) column of the rotation matrix R′(gⱼ).

$$[ Equation 23 ]$$

$${Y}_{n}^{m} ( {g}_{j} x ) = {\sum }_{k = - n}^{n} {Y}_{n}^{k} ( x ) {R}_{k , m}^{′ ( n )} ( {g}_{j}^{- 1} ) \qquad ( 23 )$$

Here, the element R′⁽ⁿ⁾_{k, m}(gⱼ) is expressed by following Equation (24).

$$[ Equation 24 ]$$

$${R}_{k , m}^{′ ( n )} ( {g}_{j} ) = {e}^{- im α} {r}_{k , m}^{( n )} ( β ) {e}^{- ik γ} \qquad ( 24 )$$

Note that, in Equation (24), i represents a pure imaginary number, β, α, and γ represent the rotation angles of the Euler angles of the rotation matrix, and r⁽ⁿ⁾_{k, m}(β) is expressed by following Equation (25).

$$[ Equation 25 ]$$

$${r}_{k , m}^{( n )} ( β ) = \sqrt{\frac{( n + k ) ! ( n - k ) !}{( n + m ) ! ( n - m ) !}} {\sum }_{σ} ( \begin{matrix}n + m \\ n - k - σ\end{matrix} ) ( \begin{matrix}n - m \\ σ\end{matrix} ) {( - 1 )}^{n - k - σ} {( cos \frac{β}{2} )}^{2 σ + k + m} {( sin \frac{β}{2} )}^{2 n - 2 σ - k - m} \qquad ( 25 )$$

From the above, a binaural reproduction signal reflecting the rotation of the head of the listener using the rotation matrix R′(gⱼ⁻¹), for example, the drive signal Pₗ(gⱼ, ω) of the left headphone is obtained by calculating following Equation (26). Furthermore, in a case where the left and right head-related transfer functions may be regarded as symmetric, by performing inversion using a matrix R_{ref} that horizontally inverts either the matrix D′(ω) of the input signal or the row vector H_{S}(ω) of the left head-related transfer function as preprocessing of Equation (26), the right headphone drive signal can be obtained by just retaining only the row vector H_{S}(ω) of the left head-related transfer function. However, a case where different left and right head-related transfer functions are basically required will be described below.

$$[ Equation 26 ]$$

$$\begin{matrix}{P}_{l} ( {g}_{j} , ω ) = H ( {g}_{j}^{- 1} x , ω ) Y ( x ) {D}^{′} ( ω ) \\ = H ( x , ω ) Y ( x ) {R}^{′} ( {g}_{j}^{- 1} ) {D}^{′} ( ω ) \\ = {H}_{S} ( ω ) {R}^{′} ( {g}_{j}^{- 1} ) {D}^{′} ( ω )\end{matrix} \qquad ( 26 )$$

In Equation (26), the drive signal Pₗ (gⱼ, ω) is obtained by synthesizing the row vector H_{S}(ω), the rotation matrix R′(gⱼ⁻¹), and the vector D′(ω).

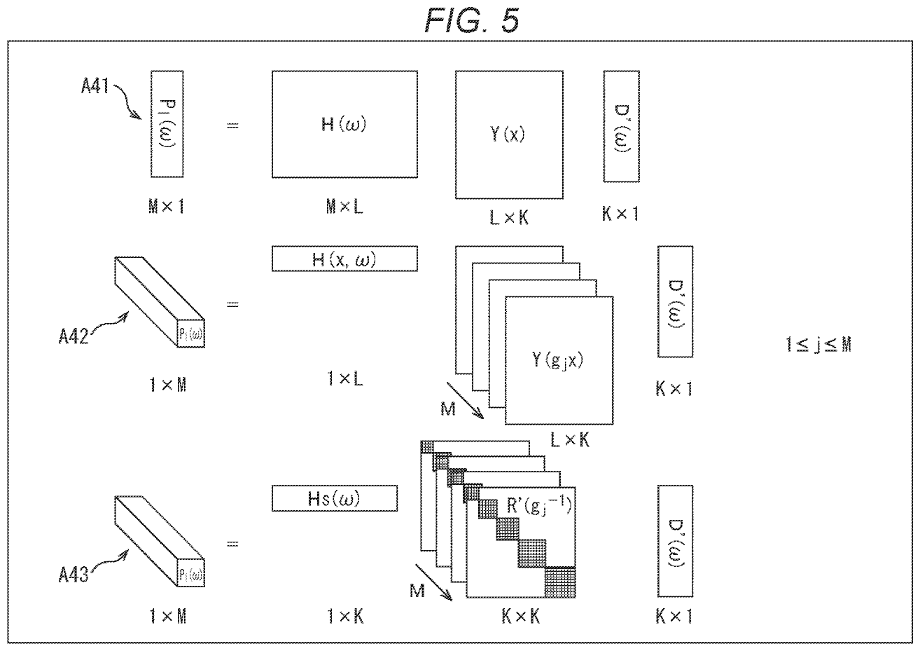

The above calculation is, for example, the calculation illustrated in FIG. 5. That is, the vector Pₗ(ω) including the drive signal Pₗ(gⱼ, ω) of the left headphone is obtained by the product of the matrix H(ω) of M×L, the matrix Y(x) of L×K, and the vector D′(ω) of K×1 as indicated by an arrow A41 in FIG. 5. This matrix operation is as represented in above-described Equation (12).

When this operation is expressed using the matrix Y(gⱼx) of the spherical harmonics prepared for each of the M directions gⱼ, the operation is as indicated by an arrow A42. That is, the vector Pₗ(ω) including the drive signal Pₗ (gⱼ, ω) corresponding to each of the M directions gⱼ is obtained by a product of a predetermined row H(x, ω) of the matrix H(ω), the matrix Y(gⱼx), and the vector D′(ω) from the relationship represented in Equation (20).

Here, the row H(x, ω) as a vector is 1×L, the matrix Y(gⱼx) is L×K, and the vector D′(ω) is K×1. When this is further transformed using the relationships represented in Equations (17) and (21), the result is as indicated by an arrow A43. That is, as represented in Equation (26), the vector Pₗ(ω) is obtained by a product of the row vector H_{S}(ω) of 1×K, the rotation matrix R′(gⱼ⁻¹) of K×K in each of the M directions gⱼ, and the vector D′(ω) of K×1.

Note that, in FIG. 5, hatched portions of the rotation matrix R′(gⱼ⁻¹) represent non-zero elements of the rotation matrix R′(gⱼ⁻¹).

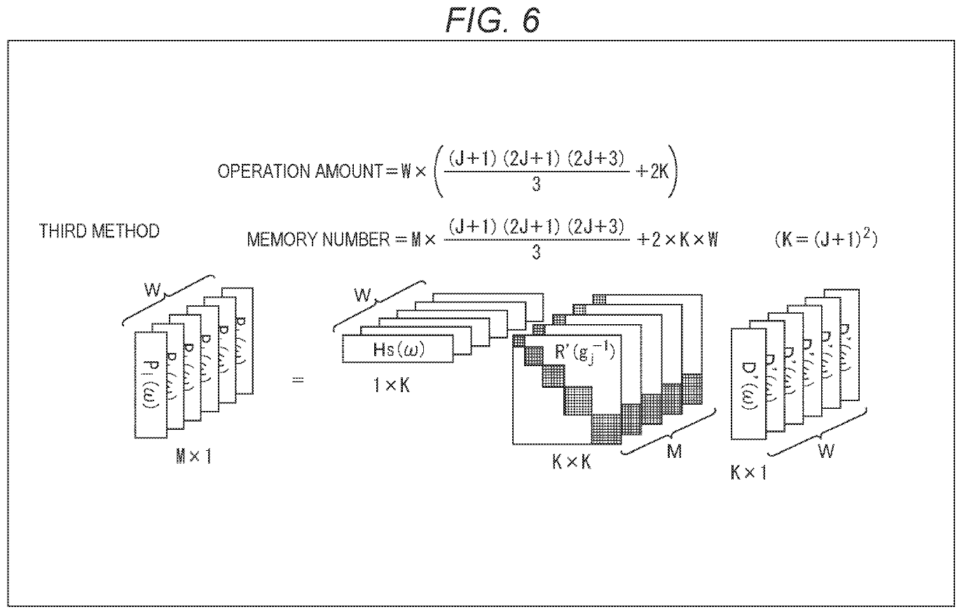

Furthermore, the operation amount and the necessary memory amount in such a third method are as illustrated in FIG. 6.

That is, as illustrated in FIG. 6, it is assumed that a row vector H_{S} (ω) of 1×K is prepared for each time-frequency bin co, the rotation matrix R′(gⱼ⁻¹) of K×K is prepared for the M directions gⱼ, and the vector D′(ω) is K×1. Furthermore, it is assumed that the number of time-frequency bins ω is W, and a maximum value of the degree n of the spherical harmonics, that is, the maximum degree is J.

At this time, since the number of non-zero elements of the rotation matrix R′(gⱼ⁻¹) is (J+1) (2J+1) (2J+3)/3, a sum calc/W of the number of product-sum operations per each time-frequency bin ω in the third method is as represented in following Equation (27).

$$[ Equation 27 ]$$

$$calc \text{/} W = \frac{( J + 1 ) ( 2 J + 1 ) ( 2 J + 3 )}{3} + 2 K \qquad ( 27 )$$

Furthermore, for the operation by the third method, it is necessary to retain the row vector H_{S}(ω) of 1×K for each time-frequency bin ω for the left and right ears, and it is further necessary to retain non-zero elements of the rotation matrix R′(gⱼ⁻¹) by the amount of each of the M directions. Therefore, the memory amount needed for the operation by the third method is as represented in following Equation (28).

$$\begin{matrix}[ Equation 28 ] & \\ memory = M \times \frac{( J + 1 ) ( 2 J + 1 ) ( 2 J + 3 )}{3} + 2 \times K \times W & ( 28 )\end{matrix}$$

In the third method, by retaining the number of non-zero elements of the rotation matrix R′(gⱼ⁻¹), the required memory amount can be greatly reduced as compared with the second method.

<Fourth Method>

Note that, in the third method, it is necessary to retain the rotation matrix R′(gⱼ⁻¹) by the amount of rotation of the three axes of the head of the listener, that is, by the amount of each of any M directions gⱼ. Retaining such a rotation matrix R′(gⱼ⁻¹) requires a certain memory amount even through it is smaller than retaining the matrix H′(ω) having time-frequency dependence.

Accordingly, the rotation matrix R′(gⱼ⁻¹) for performing rotation in the spherical harmonic domain with the head of the listener being a rotation center may be sequentially obtained at the time of operation. Hereinafter, such a method will also be referred to as a fourth method.

Here, the rotation matrix R′(g) can be expressed by following Equation (29). Furthermore, g in Equation (29) is a rotation matrix, and is expressed by a product of a matrix u(α), a matrix a(β), and a matrix u(γ) as represented in following Equation(30).

[Equation 29]

R′(g)=R′(u(α)a(β)u(γ))=R′(u(α))R′(a(β))R′(u(γ)) (29)

[Equation 30]

g=u(α)a(β)u(γ) (30)

Note that in Equation (29), a(β) and u(α) are rotation matrices that rotate coordinates by an angle β and an angle α with a coordinate axis of a coordinate system in which the position of the head of the listener is the origin being a rotation axis. Furthermore, u(γ) is a rotation matrix that is different from u(α) only in the rotation angle and rotates the coordinates by an angle γ with the same coordinate axis being a rotation axis. Note that the rotation angles of the respective matrices u(α), a(β), and u(γ), that is, the angle α, the angle β, and the angle γ are Euler angles.

For example, it is assumed that there is an orthogonal coordinate system in which the position of the head of the listener is the origin and the x axis, the y axis, and the z axis orthogonal to each other are respective axes. Here, a positive direction of the x axis is a direction directly forward of the listener in a state where the listener faces directly forward, and the z axis is an axis in an up and down direction, that is, a vertical direction, as viewed from the listener facing directly forward. The angle α, the angle β, and the angle γ are rotation angles in respective rotation directions with reference to a state in which the listener faces directly forward, that is, the positive direction of the x axis.

Specifically, a rotation angle of the head when the head is moved in the up and down direction with the y axis being the rotation axis in a state where the listener is looking directly forward is the angle β that is an elevation angle. Moreover, a rotation angle of the head when the head is moved in the horizontal direction as viewed from the listener with the z axis being the rotation axis in a state where the listener is facing directly forward is the angle α that is a horizontal angle.

The matrix a(β) is a rotation matrix that rotates the coordinates (coordinate system) by the angle β with the y axis being the rotation axis, and the matrix u(α) is a rotation matrix that rotates the coordinates (coordinate system) by the angle α with the z axis being the rotation axis. Specifically, the matrix a(β) and the matrix u(α) are as represented in following Equations (31) and (32), respectively.

$$\begin{matrix}[ Equation 31 ] & \\ \{ a ( β ) = ( \begin{matrix}cos β & 0 & sin β \\ 0 & 1 & 0 \\ - sin β & 0 & cos β\end{matrix} ) \vert β ∈ [ 0 , 2 π ] \} & ( 31 ) \\ [ Equation 32 ] & \\ \{ u ( α ) = ( \begin{matrix}cos α & - sin α & 0 \\ sin α & cos α & 0 \\ 0 & 0 & 1\end{matrix} ) \vert α ∈ [ 0 , 2 π ] \} & ( 32 )\end{matrix}$$

Therefore, for example, when the matrix a(β) is applied to any position v=(vₓ, v_{y}, v_{z})^{T} in the coordinate system with the position of the head of the listener being the origin, rotation with the y axis being the rotation axis can be given to the position v, and a position v₂ after rotation of the position v is expressed by following Equation (33).

Similarly, when the matrix u(α) is applied to the position v, rotation with the z axis being the rotation axis can be given to the position v, and a position v₃ after rotation of the position v is expressed by following Equation (34).

[Equation 33]

v₂=a(β)v (33)

[Equation 34]

v₃=u(α)v (34)

Therefore, the rotation matrix R′(g)=R′(u(α)a(β)u(γ)) is a rotation matrix that rotates the coordinate system by the angle α in a horizontal angle direction in the spherical harmonic domain, thereafter rotates the coordinate system after rotation of the angle α by the angle β in an elevation angle direction as viewed from this coordinate system, and further rotates the coordinate system after rotation of the angle β by the angle γ in the horizontal angle direction as viewed from the coordinate system.

Furthermore, R′(u(α)), R′(a(β), and R′(u(γ)) indicate the rotation matrix R′(g) when the coordinates are rotated by each of the matrix u(α), the matrix a(β), and the matrix u(γ).

In other words, the rotation matrix R′(u(α)) is a rotation matrix that rotates coordinates by the angle α in the horizontal angle direction in the spherical harmonic domain, and the rotation matrix R′(a(β) is a rotation matrix that rotates coordinates by the angle β in the elevation angle direction in the spherical harmonic domain. Furthermore, the rotation matrix R′(u(γ)) is a rotation matrix that rotates coordinates in the horizontal angle direction by the angle γ in the spherical harmonic domain.

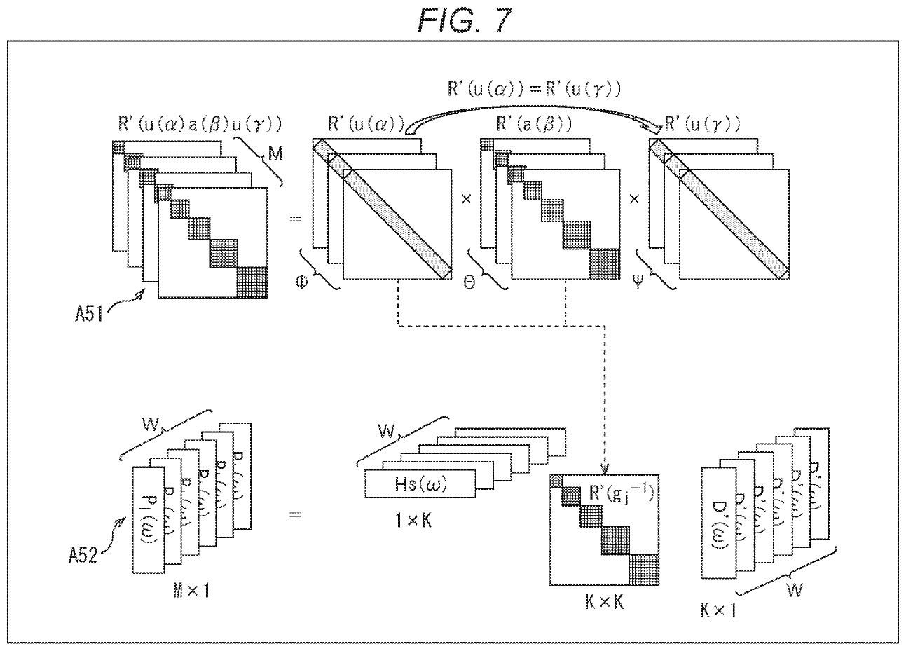

Therefore, for example, as indicated by an arrow A51 in FIG. 7, the rotation matrix R′(g)=R′(u(α)a(β)u(γ)) for rotating the coordinates three times using the angle α, the angle and the angle γ being rotation angles can be expressed by a product of the three rotation matrices R′(u(α)), R′(a(β), and R′(u(γ)).

In this case, as data for obtaining the rotation matrix R′(gⱼ⁻¹), each of the rotation matrix R′(u(α)), the rotation matrix R′(a(β), and the rotation matrix R′(u(γ)) for respective values of the rotation angles α, β, and γ is only required to be retained in a memory in a table. Furthermore, in a case where the same head-related transfer function may be used for the left and right, the rotation matrix for the opposite ear can be obtained by retaining the row vector H_{S}(ω) for only one ear, also retaining the above-described matrix R_{ref} for inverting the left and right in advance, and obtaining a product of this and the generated rotation matrix.

Furthermore, when the vector Pₗ(ω) is actually calculated, one rotation matrix R′(gⱼ⁻¹) is calculated by calculating a product of each rotation matrix read from the table. Then, as indicated by an arrow A52, for each time-frequency bin co, a product of the row vector H_{S}(ω) of 1×K, the rotation matrix R′(gⱼ⁻¹) of K×K common to all time-frequency bins co, and the vector D′(ω) of K×1 is calculated to obtain the vector Pₗ(ω).

Here, for example, in a case where the rotation matrix R′(gⱼ⁻¹) itself of each rotation angle is retained in the table, when accuracy of the angle α, the angle β, and the angle γ of each rotation is one degree (1°), it is necessary to retain 360³=46656000 rotation matrices R′(gⱼ⁻¹).

On the other hand, in a case where the accuracy of the angle α, the angle β, and the angle γ of respective rotations is one degree (1°), and the rotation matrix R′(u(α)), the rotation matrix R′(a(β), and the rotation matrix R′(u(γ)) of each rotation angle are retained in the table, it is only necessary to retain 360×3=1080 rotation matrices.

Therefore, while it has been necessary to retain data of the order of O(n³) when retaining the rotation matrix R′(gⱼ⁻¹) itself, it is only necessary to retain data of the order of O(n) when retaining the rotation matrix R′(u(α)), the rotation matrix R′(a(β), and the rotation matrix R′(u(γ)), and the memory amount can be greatly reduced.

Moreover, as indicated by an arrow A51, since the rotation matrix R′(u(α)) and the rotation matrix R′(u(γ)) are diagonal matrices, it is only required to retain only diagonal components.

Furthermore, since both the rotation matrix R′(u(α)) and the rotation matrix R′(u(γ)) are rotation matrices that perform rotation in the horizontal angle direction, the rotation matrix R′(u(α)) and the rotation matrix R′(u(γ)) can be obtained from the same common table. That is, the table of the rotation matrix R′(u(α)) and the table of the rotation matrix R′(u(γ)) can be the same.

Note that, in FIG. 7, a hatched portion of each rotation matrix represents a non-zero element.

Moreover, with respect to k and m when (n²+n+1+k) and (n²+n+1+m) belong to the set Q represented in the above-described Equation (22), elements other than the (n²+n+1+k) row and the (n²+n+1+m) column among the elements of the rotation matrix R′(a(β) are zero, and thus it is only required to retain only non-zero elements as the rotation matrix R′(a(β), and the memory amount can be reduced.

From the above, the memory amount required to retain data for obtaining the rotation matrix R′(gⱼ⁻¹) can be further reduced.

Specifically, for example, when Φ, Θ, and Ψ rotation matrices R′(u(α)), R′(a(β), and R′(u(γ)) are retained, the number M of rotation directions gⱼ of the head is M=Φ×Θ×Ψ.

In the fourth method, since the rotation matrix R′(a(β) is retained by the amount for accuracy of the angle β, that is, Θ rotation matrices, the memory amount necessary for retaining the rotation matrix R′(a(β) is memory (α)=Θ×(J+1) (2J+1) (2J+3)/3.

Furthermore, a common table can be used for the rotation matrix R′(u(α)) and the rotation matrix R′(u(γ)), and when the accuracy of the angle α and the accuracy of the angle γ are the same, it is only required to retain the rotation matrices by the amount of the angle α, that is, Φ, and it is only required to retain diagonal components of these rotation matrices. Therefore, when the length of the vector D′(ω) is K, the memory amount necessary for retaining the rotation matrix R′(u(α)) and the rotation matrix R′(u(γ)) is memory (b)=Φ×K.

Moreover, when the number of time-frequency bins ω is W, the memory amount required to retain the row vector H_{S}(ω) of 1×K for the left and right ears by the amount of each time-frequency bin ω is 2×K×W.

Therefore, when these are summed, the memory amount required by the fourth method is memory=memory (a)+memory (b)+2KW.

Such a fourth method can significantly reduce the memory amount required with approximately the same operation amount as that of the third method. In particular, the fourth method is more effective, for example, when the accuracy of the angle α, the angle β, and the angle γ is set to one degree(1°) or the like so that a head tracking function can withstand more practical use when it is achieved.

<Fifth Method>

Incidentally, in the fourth method, the number of rotation matrices to be retained can be reduced to 1080 by having rotation with respect to three axes, for example, every one degree, that is, by setting the accuracy of the angle α, the angle β, and the angle γ to one degree (1°).

However, in the fourth method, in terms of the operation amount, the maximum degree J of the degree n of the spherical harmonics can be reduced only to the order of the cube.

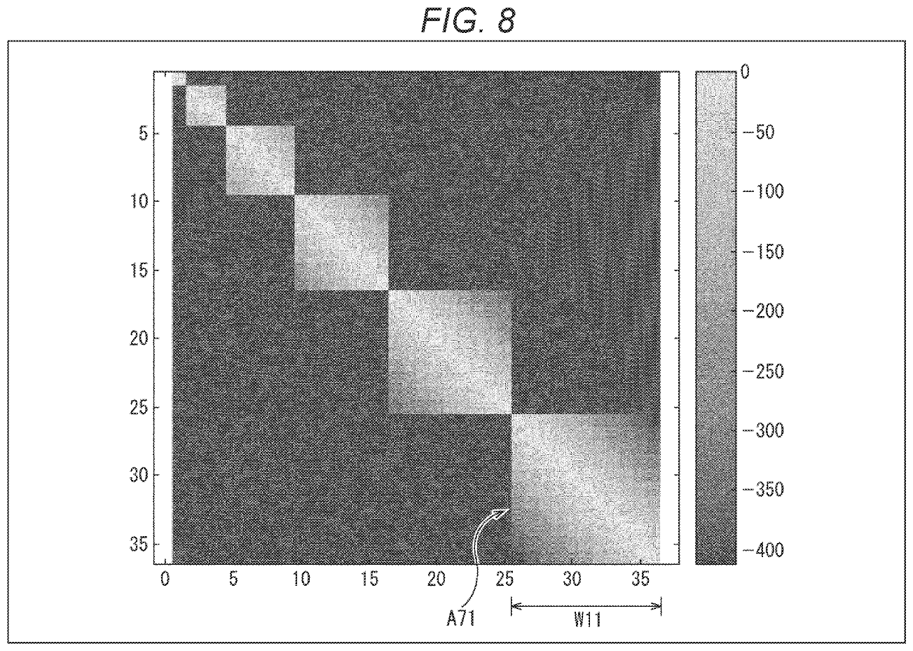

The reason is that the rotation matrix R′(a(β) for following the rotation of the head of the listener (user) is a block diagonal matrix as illustrated in FIG. 8, for example.

Note that, in FIG. 8, the horizontal axis represents the components of the columns of the rotation matrix R′(a(β), and the vertical axis represents the components of the rows of the rotation matrix R′(a(β)). Furthermore, in FIG. 8, shading at respective positions of the rotation matrix R′(a(β) indicates a level (dB) of the element of the rotation matrix R′(a(β) corresponding to those positions.

FIG. 8 illustrates a rotation matrix R′(a(β)) when the rotation angle β is one degree. In this example, when attention is paid to an element having a value of, for example, −400 dB or more in the rotation matrix R′(a(β)), a portion including the element having such a value is a block having a size of (2n+1)×(2n+1) with respect to the degree n. For example, a square portion indicated by an arrow A71 is a portion of one block of the block diagonal matrix, and a width (thickness) W11 of the block is 2n+1. That is, in the square portion indicated by the arrow A71, (2n+1) elements are arranged in the row direction, and (2n+1) elements are also arranged in the column direction.

When the rotation matrix R′(a(β)) that is such a block diagonal matrix is used, the operation amount can be reduced to some extent, but if the operation amount can be further reduced, the drive signal can be obtained more quickly and efficiently.

Accordingly, in the fifth method, attention is paid to characteristics of the rotation matrix with respect to minute rotation, and the operation amount can be reduced to the order of the square with respect to the degree J by following the rotation of the head of the listener (user) by accumulation of the minute rotation.

Hereinafter, the fifth method will be specifically described.

Among three axes of rotation of the head of the listener, that is, the rotation matrix R′(u(α)), the rotation matrix R′(a(β)), and the rotation matrix R′(u(γ)), only the rotation matrix R′(a(β)) is the block diagonal matrix, and the other rotation matrices R′(u(α)) and R′(u(γ)) are complete diagonal matrices.

However, depending on how to select the rotation axis, two or more rotation matrices may be block diagonal matrices. In the example of the present description, although a rotation axis in which two or more rotation matrices are block diagonal matrices is not used, the present technology can also be applied to a case where two or more rotation matrices are block diagonal matrices.

It is assumed that the angle β when the listener is facing the front direction in the up and down direction (vertical direction), that is, the elevation angle direction is zero degrees.

When the listener moves the head by +1 degree in the upward direction (a positive direction of the z axis) from the state where the angle β is zero degrees, that is, when the listener rotates the head by +1 degree in the positive direction of the z axis with the y axis being the rotation axis, the angle β is one degree.

As described above, the rotation matrix R′(a(β)) when the angle β is one degree is as illustrated in FIG. 8.

In the example illustrated in FIG. 8, it can be seen that the rotation matrix R′(a(β) is a block diagonal matrix, and the portion of each block of the block diagonal matrix is a square having (2n+1) elements on one side for each degree n. At the same time, a rotation matrix R′(g) that is a synthesis of the rotation matrix R′(a(β), the rotation matrix R′(u(α)) that is a diagonal matrix, and the rotation matrix R′(u(γ)) that is a diagonal matrix is also a similar block diagonal matrix. Here, since the direction gⱼ may be either a discrete value or a continuous value, gⱼ will also be simply referred to as g in the following description.

Now, when the head-related transfer function of the spherical harmonic domain is rotated for one block of the rotation matrix R′(g), which is a block diagonal matrix, that is, a certain degree n, the head-related transfer function H′ₙ^{m}(g⁻¹) after the rotation is expressed by following Equation (35). That is, when the head-related transfer function of the spherical harmonic domain is rotated by the angle of a direction g by using the portion of the block of the degree n of the rotation matrix R′(g), the head-related transfer function H′ₙ^{m}(g⁻¹) after the rotation is expressed by following Equation (35).

$$\begin{matrix}[ Equation 35 ] & \\ {H}_{n}^{′ m} ( {g}^{- 1} ) = {\sum }_{k = - n}^{n} {H}_{n}^{′ k} {R}_{k , m}^{′ ( n )} ( g ) & ( 35 )\end{matrix}$$

Note that in Equation (35), k represents the order before rotation, and m represents the order after rotation. Furthermore, H′ₙ^{k} indicates elements of the degree n and an order k in the row vector H_{S}(ω).

From the calculation of such equation (35), it can be seen that all (2n+1) elements R′⁽ⁿ⁾_{k, m}(g) are used to obtain the element of the order m after one rotation.

However, in the rotation when the angle β is minute, such as when the angle β=1 degree, most of the respective elements of the rotation matrix R′(a(β)) which is a block diagonal matrix have minute values. Therefore, most of the respective elements R′⁽ⁿ⁾_{n, m}(g) of the rotation matrix R′(g) also have minute values.

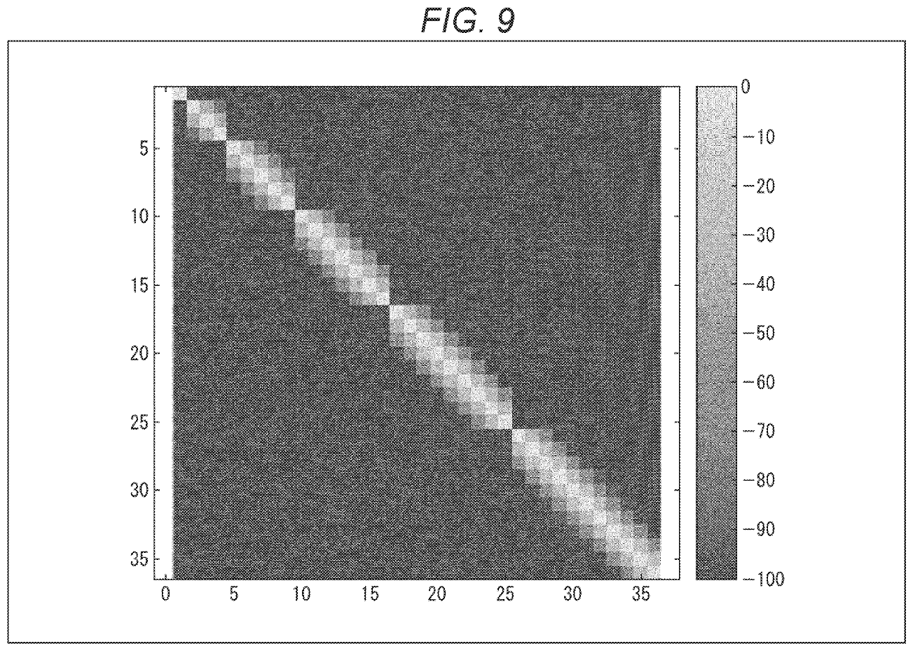

That is, for example, the rotation matrix R′(a(β)) illustrated in FIG. 9 indicates the rotation matrix R′(a(β)) when the angle β is one degree, which is the same as the rotation matrix R′(a(β)) illustrated in FIG. 8.

That is, in FIG. 9, the horizontal axis represents the components of the columns of the rotation matrix R′(a(β)), and the vertical axis represents the components of the rows of the rotation matrix R′(a(β)). Furthermore, shading at respective positions of the rotation matrix R′(a(β)) indicates a level (dB) of the element of the rotation matrix R′(a(β)) corresponding to those positions.

However, while the range of the level of each element of the rotation matrix R′(a(β)) is −400 dB to zero dB in FIG. 8, the range of the level of each element of the rotation matrix R′(a(β)) is limited to −100 dB to zero dB in FIG. 9.

As in the example illustrated in FIG. 9, when an element having a valid value in the rotation matrix R′(a(β) is an element having a level of −100 dB to 0 dB, it can be seen that an element having a valid value exists only around the diagonal components.

Moreover, it can be seen that the number of elements having valid values when one row of the rotation matrix R′(a(β) is viewed, that is, the number of elements having valid values (hereinafter, also referred to as effective element width) arranged continuously in the horizontal direction in FIG. 9 is almost the same in all degrees n.

Thus, the number of elements having valid values in each degree n is only on the order of the square of J, which is approximately the maximum value of the degree n, even with increasing degree n.

Accordingly, if an element of a value within a range of a predetermined level such as an element at a level from −100 dB to zero dB of the rotation matrix R′(a(β) is set as an effective element, and an operation of rotating the head-related transfer function in the spherical harmonic domain is performed using only the effective element, the operation amount can be reduced. In other words, if the element of the value within the range of the predetermined level of the rotation matrix R′(g) is set as the effective element, and the operation of rotating the head-related transfer function in the spherical harmonic domain is performed using only the effective element, the operation amount can be reduced. An effective element width of the rotation matrix R′(g) is the same as the effective element width of the rotation matrix R′(a(β)).

For example, in a case where the effective element width is 2C+1, the above-described calculation of Equation (35) is as represented in following Equation (36).

$$\begin{matrix}[ Equation 36 ] & \\ {H}_{n}^{′ m} ( {g}^{- 1} ) ≅ {\sum }_{k = max ( - n , m - C )}^{min ( n , m + C )} {H}_{n}^{′ k} {R}_{k , m}^{′ ( n )} ( g ) & ( 36 )\end{matrix}$$

However, in Equation (36), min(a, b) represents a function for selecting the smaller one of a and b. Furthermore, in Equation (36), max(a, b) represents a function for selecting the larger one of a and b.

In Equation (35), (2n+1) elements R′⁽ⁿ⁾_{k, m}(g) in which the order k is from −n to n are used for each degree n, but in the calculation of Equation (36), only (2C+1) elements R′⁽ⁿ⁾_{k, m}(g) in which the order k is within a range from m−C to m+C with m being a center are used, and reduction in the operation amount is achieved. Note that, in a case where k is larger than n or in a case where k is smaller than −n, the operation is performed with k up to n or k up to −n, respectively, so as not to exceed the range of the matrix. In this manner, the operation amount can be reduced by performing the operation while limiting the order k, that is, by performing the operation only for the element in which the order k is a value within the range determined by C.

In this case, since the effective element width 2C+1 is the same in all the degrees n, it can be seen that the fifth method is more advantageous in terms of operation as the degree J is larger as compared with the fourth method described above.

Note that, in Equation (36), a constant C determined from the effective element width is applied to all the degrees n. However, the C that determines the effective element width 2C+1 is not limited to a constant, and a function C(n) (where C(n)<n) of the degree n may be used as the C, or a function C(n, k) of the degree n and the order k may be used as the C. Here, the function C(n) and the function C(n, k) may be natural numbers smaller than the degree n. That is, it is only required to perform the operation with the number of elements as smaller as possible than that in performing the operation using the elements of the entire block of the rotation matrix R′(a(β) that is the block diagonal matrix, that is, the rotation matrix R′(g).

Furthermore, an element used for the operation of the rotation matrix R′(a(β) may be the element itself of the rotation matrix R′(a(β) or an approximate value of the element of the rotation matrix R′(a(β)).

That is, more generally speaking, it is assumed that the rotation matrix R′(a(β) can be expressed as R′(a(β)=A₁+A₂+A₃+ . . . by a combination of a plurality of matrices. In this case, for an approximate rotation matrix Rs′(a(β)) represented by the sum of some of those matrices that constitute the rotation matrix R′(a(β), it is only required to perform the operation by using fewer elements than (2n+1)×(2n+1) in the next nth-order block.

For example, an nth-order block diagonal matrix R′⁽ⁿ⁾(a(β) of the rotation matrix R′(a(β) can be expressed by following Equation (37).

$$\begin{matrix}[ Equation 37 ] & \\ \begin{matrix}{R}^{′ ( n )} ( a ( β ) ) = exp ( i β {V}_{y}^{( n )} ) \\ = E + i β {V}_{y}^{( n )} - \frac{{β}^{2}}{2 !} {V}_{y}^{( n ) 2} - \frac{i {β}^{3}}{3 !} {V}_{y}^{( n ) 3} + …\end{matrix} & ( 37 )\end{matrix}$$

Here, the matrix V_{y}⁽ⁿ⁾ in Equation (37) is expressed as following Equation (38). In a case where it is desired to set a thickness of the approximate rotation matrix Rs′(a(β)) to C using the matrix V_{y}⁽ⁿ⁾, it is only required to perform the calculation by limiting the calculation up to the C-th power in the polynomial of the matrix represented in Equation (37).

$$\begin{matrix} [ Equation 38 ] & \\ {V}_{y}^{( n )} = \frac{1}{2 i} ( \begin{matrix}0 & \sqrt{2 n} & 0 & … & 0 \\ - \sqrt{2 n} & 0 & \sqrt{2 ( 2 n - 1 )} & 0 & ⋮ \\ 0 & - \sqrt{( 2 n - 1 ) 2} & ⋱ & ⋱ & 0 \\ ⋮ & 0 & ⋱ & 0 & \sqrt{2 n} \\ 0 & 0 & … & - \sqrt{2 n} & 0\end{matrix} ) & ( 38 )\end{matrix}$$

In this manner, in the rotation matrix Rs′(a(β) used as the rotation matrix R′(a(β), elements having non-zero values are substantially only diagonal components. Therefore, if a rotation operation of rotating the head-related transfer function using a non-zero element of the rotation matrix R′(g) obtained using the rotation matrix Rs′(a(β), that is, a matrix operation of the rotation matrix R′(g) and the row vector H_{S}(ω) is performed, consequently, an operation with a limited order of the rotation matrix R′(g) is performed, and the operation amount can be reduced.

Note that in this case, for example, the rotation matrix R′(u(α)), the rotation matrix Rs′(a(β), and the rotation matrix R′(u(γ)) are synthesized to form a rotation matrix R′(g), and a matrix operation with limited orders is performed.

In a case of following the rotation of the head of the listener by the fifth method as described above, for example, it is assumed that the listener has rotated the head by 30 degrees in the upward direction, that is, the elevation angle direction. That is, it is assumed that the elevation angle (angle β) indicating the direction of the head of the listener is 30 degrees.

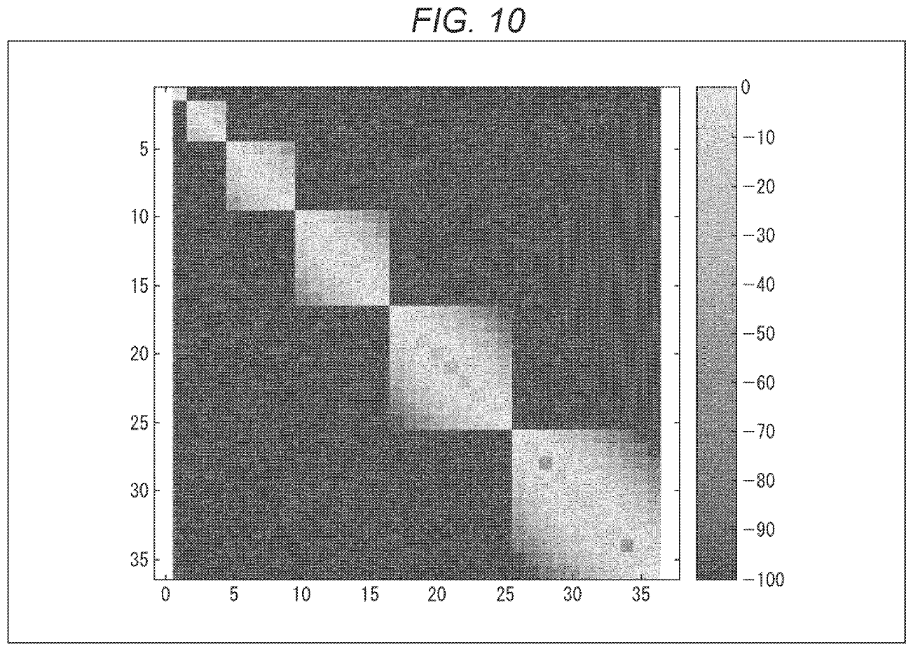

In this case, the rotation matrix R′(a(β) is as illustrated in FIG. 10. Note that in FIG. 10, the horizontal axis represents components of the columns of the rotation matrix R′(a(β), and the vertical axis represents components of the rows of the rotation matrix R′(a(β)). Furthermore, shading at respective positions of the rotation matrix R′(a(β)) indicates a level (dB) of the element of the rotation matrix R′(a(β)) corresponding to those positions.

In FIG. 10, as in the case of FIG. 9, the range of the level of each element of the rotation matrix R′(a(β)) is from −100 dB to 0 dB.

However, in the example illustrated in FIG. 10, as the degree n increases, the effective element width of the block for the degree n increases (enlarges). That is, even if the components of −100 dB or less are discarded, the rotation matrix R′(a(β)) becomes a block diagonal matrix having a large effective element width.

As described above, with the rotation matrix R′(a(β)), while the effective element width is narrow and the operation amount can be reduced as described with reference to FIG. 9 when the rotation angle β is small, the effective element width increases and the operation amount reduction effect decreases as the rotation angle β increases.

Furthermore, if this continues, as the rotation of the head with respect to the elevation angle direction of the listener increases, the constant C for determining the effective element width 2C+1 has to be increased.

In order to follow the rotation of the head up to the rotation angle β in the large elevation angle direction while keeping the operation amount small, it is only required to use accumulation of minute rotations.

That is, for example, the direction of the head of the listener (user) at a predetermined time is expressed as (α, β, γ) using the Euler angle. Here, the angle α, the angle β, and the angle γ respectively correspond to the rotation angle α, the rotation angle β, and the rotation angle γ described above. Note that here, the direction g, which is the rotation direction of the head of the listener, is represented using the Euler angle, but may be represented by another method such as quaternion, for example. Hereinafter, the description will be continued assuming that the direction g is represented using the Euler angle unless otherwise specified.

In particular, the angle α and the angle γ are horizontal angles viewed from the listener, and the angle β is an elevation angle viewed from the listener. Hereinafter, in particular, the angle β at time t is referred to as an angle βₜ. Similarly, hereinafter, the angle α and the angle γ at time t are referred to as an angle αₜ and an angle γₜ, respectively.

In a case where accumulation of minute rotations is used, it is only required to obtain a difference Δgₜ=gₜgₜ₋₁⁻¹ between an angle gₜ indicating the direction g at time t and an angle gₜ₋₁ at time (t−1) immediately before time t, that is, time (t−1) before time t, and rotate the rotation matrix R′(gₜ₋₁) obtained last time by the amount of the difference Δgₜ, thereby updating the rotation matrix R′(gₜ). That is, a product of the rotation matrix R′(gₜ₋₁) at the previously obtained time (t−1) and the rotation matrix R′(Δgₜ) corresponding to the difference Δgₜ is only required to be set as the rotation matrix R′(gₜ) at time t.

Thus, it is possible to obtain the rotation matrix R′(gₜ) with a smaller operation amount using the rotation matrix R′(Δgₜ)=R′(u(Δαₜ))Rs′(a(Δβₜ))R′(u(Δγₜ)) obtained by synthesizing the rotation matrix Rs′(a(Δβₜ)) having a small effective element width for the difference Δβₜ of the difference Δgₜ which are minute rotation angles, the rotation matrix R′(u(Δαₜ)) which is a diagonal matrix for the difference Δαₜ of the difference Δgₜ, and the rotation matrix R′(u(Δγₜ)) which is a diagonal matrix for the difference Δγₜ of the difference Δgₜ.

Note that the difference Δαₜ, the difference Δβₜ, and the difference Δγₜ are Euler angles such that Δgₜ=u(Δαₜ)a(Δβₜ)u(Δγₜ).

<Configuration Example of Audio Processing Device>

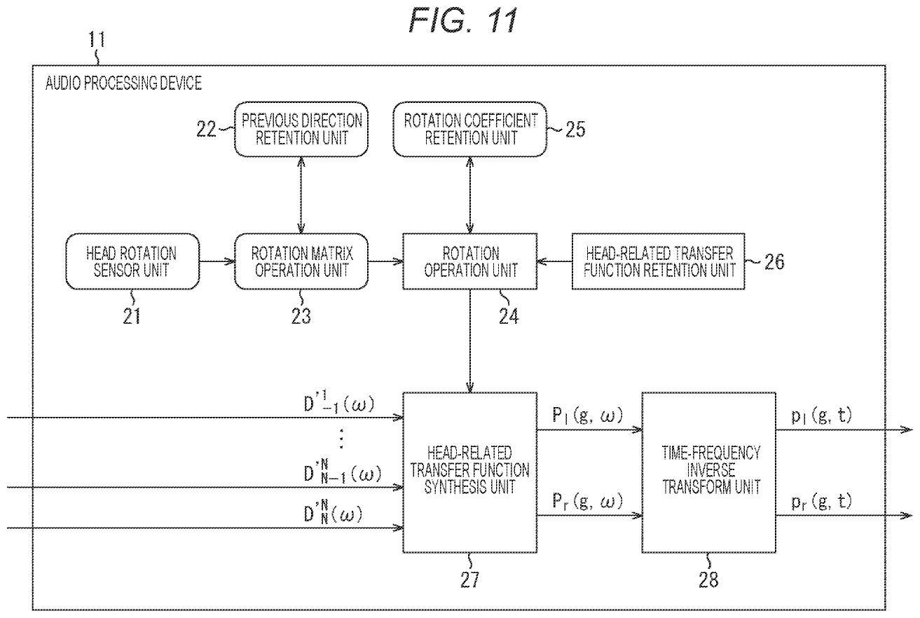

Here, an audio processing device to which the present technology described above is applied will be described. FIG. 11 is a diagram illustrating a configuration example of one embodiment of the audio processing device to which the present technology is applied.

An audio processing device 11 illustrated in FIG. 11 is a signal processing device that is built in, for example, a headphone or the like, receives an input signal D′ₙ^{m}(ω) of a spherical harmonic domain that is an acoustic signal of a sound to be reproduced, and outputs drive signals of sounds of two channels in a time domain. Note that, although an example in which the audio processing device 11 is incorporated in the headphones will be described here, the audio processing device 11 may be incorporated in another device different from the headphones or may be another device different from the headphones or the like.

The audio processing device 11 includes a head rotation sensor unit 21, a previous direction retention unit 22, a rotation matrix operation unit 23, a rotation operation unit 24, a rotation coefficient retention unit 25, a head-related transfer function retention unit 26, a head-related transfer function synthesis unit 27, and a time-frequency inverse transform unit 28.

The head rotation sensor unit 21 includes, for example, an acceleration sensor, an image sensor, or the like attached to the head of the listener (user) as necessary, detects rotation (movement) of the head of the listener, and supplies a detection result to the rotation matrix operation unit 23.

Note that the listener here is a user wearing headphones, that is, a user who listens to sound reproduced by the headphones on the basis of drive signals of the left and right headphones obtained by the time-frequency inverse transform unit 28.

In the head rotation sensor unit 21, an angle αₜ, an angle βₜ, and an angle γₜ at the current time t are obtained as detection results of the rotation of the head of the listener, that is, the direction in which the head of the listener faces. Hereinafter, the information indicating the direction (rotation) of the head of the listener including the angle αₜ, the angle βₜ, and the angle γₜ will also be referred to as head rotation information. The direction at certain time t indicated by the head rotation information is an angle gₜ corresponding to the above-described direction g, and is, for example, angle information indicating the direction of the head with reference to the x-axis direction.

The previous direction retention unit 22 retains the angle at each time supplied from the rotation matrix operation unit 23 as previous direction information, and supplies the previous direction information retained to the rotation matrix operation unit 23 at the next time. Therefore, for example, when the head rotation information at time t is supplied from the head rotation sensor unit 21 to the rotation matrix operation unit 23, the angle gₜ₋₁ at time (t−1) is supplied from the previous direction retention unit 22 to the rotation matrix operation unit 23 as the previous direction information.

The rotation matrix operation unit 23 retains a table indicating the rotation matrix R′(u(α)) at each angle α and a table indicating the rotation matrix R′(a(β) at each angle β. Note that the table indicating the rotation matrix R′(u(α)) is also used when the rotation matrix R′(u(γ)) is obtained. That is, the tables of the rotation matrix R′(u(α)) and the rotation matrix R′(u(γ)) are used in common.

The rotation matrix operation unit 23 obtains and outputs the rotation matrix R′(u(Δαₜ)), a rotation matrix R′(a(Δβₜ)), and the rotation matrix R′(u(Δγₜ)) on the basis of the retained table, the head rotation information supplied from the head rotation sensor unit 21, and the previous direction information supplied from the previous direction retention unit 22. The rotation matrix operation unit 23 supplies the rotation matrix R′(u(Δαₜ)), the rotation matrix R′(a(Δβₜ)), and the rotation matrix R′(u(Δγₜ)) to the rotation operation unit 24.

The rotation matrix R′(Δgₜ) that is a synthesis of the rotation matrix R′(u(Δαₜ)), the rotation matrix R′(a(Δβₜ)), and the rotation matrix R′(u(Δγₜ)) is a rotation matrix that performs rotation by an angle (difference Δgₜ) of a difference between the rotation gₜ of the head of the listener at time t and the rotation gₜ₋₁ of the head of the listener at time (t−1).

Note that, for the rotation matrix R′(u(Δαₜ)), the rotation matrix R′(a(Δβₜ)), and the rotation matrix R′(u(Δγₜ)), the rotation matrix operation unit 23 may obtain the rotation matrix R′(u(Δαₜ)), the rotation matrix R′(a(Δβₜ)), and the rotation matrix R′(u(Δγₜ)) by operation on the basis of the differences Δαₜ, Δβₜ, and Δγₜ instead of using a table. Furthermore, the table of the rotation matrix R′(a(Δβₜ)) may indicate the rotation matrix Rs′(a(Δβₜ)) that is an approximation of the rotation matrix R′(a(Δβₜ)), and the rotation matrix Rs′(a(Δβₜ)) may be obtained by operation instead of from the table.

Furthermore, the rotation matrix operation unit 23 supplies the head rotation information gₜ supplied from the head rotation sensor unit 21 to the previous direction retention unit 22 as the previous direction information, and causes the previous direction retention unit 22 to retain the information.

The rotation operation unit 24 calculates a row vector H′(gₜ⁻¹, ω) and supplies the row vector H′(gₜ⁻¹, ω) to the rotation coefficient retention unit 25 and the head-related transfer function synthesis unit 27.

Here, the row vector H′(gₜ⁻¹, ω) is a row vector obtained by performing a rotation operation of rotating the head-related transfer function of the spherical harmonic domain, that is, the row vector H_{S}(ω) by the angle gₜ on the basis of the rotation matrix R′(gₜ) at time t.

In practice, the rotation operation unit 24 calculates the row vector H′(gₜ⁻¹, ω) at time t on the basis of the rotation matrix R′(Δgₜ) supplied from the rotation matrix operation unit 23 and the row vector H′(gₜ₋₁⁻¹, ω) at time (t−1) supplied from the rotation coefficient retention unit 25.

Such an operation is a rotation operation of further performing rotation by an angle indicated by the difference Δgₜ with respect to an operation result of the rotation operation at time (t−1), that is, the head-related transfer function after rotation obtained by the rotation operation of rotating the row vector H_{S} (ω) by the angle gₜ₋₁.

Moreover, the rotation operation based on the rotation matrix R′(Δgₜ) is a matrix operation in which a calculation is performed only for an element having the order k within a range determined by a predetermined value C in the rotation matrix R′(Δgₜ), that is, an operation limited by the order k is performed. Therefore, it can be said that the rotation matrix R′(Δgₜ) is a rotation matrix in which only the element having the order k within the range determined by the predetermined value C is an element having a non-zero valid value, that is, limited by the order k.

Note that at the start of processing, that is, in a state where there is no row vector H′(gₜ₋₁⁻¹, ω), the rotation operation unit 24 calculates the row vector H′(gₜ⁻¹, ω) on the basis of the row vector H_{S}(ω) of the head-related transfer function supplied from the head-related transfer function retention unit 26 and the rotation matrix R′(Δgₜ) supplied from the rotation matrix operation unit 23. In this case, since the angle gₜ₋₁ is zero degrees, the rotation matrix R′(Δgₜ) is equivalent to the rotation matrix R′(gₜ).

The rotation coefficient retention unit 25 retains the row vector H′(gₜ⁻¹, ω) at time t supplied from the rotation operation unit 24, and supplies the row vector H′(gₜ⁻¹, ω) retained at next time (t+1) to the rotation operation unit 24.

The head-related transfer function retention unit 26 retains a predetermined row vector H_{S} (ω) or a row vector H_{S} (ω) supplied from the outside, and supplies the retained row vector H_{S}(ω) to the rotation operation unit 24. Note that the row vector H_{S}(ω) may be prepared for each listener (user), or the row vector H_{S}(ω) common to all listeners or a plurality of listeners constituting one group may be prepared.

Here, the row vector H′(g⁻¹, ω) is a matrix obtained by rotating the row vector H_{S}(ω) including the head-related transfer function in the spherical harmonic domain by the rotation matrix R′(g⁻¹), that is, a matrix including the head-related transfer function after rotation. In other words, the row vector H′(g⁻¹, ω) is a matrix (vector) including, as an element, a head-related transfer function rotated by an angle α in the horizontal direction, an angle β in the elevation angle direction, and an angle γ in the horizontal direction by an angle determined by the direction of the head of the listener in the spherical harmonic domain.

Note that, here, the example has been described in which the head-related transfer function is rotated by the amount of the difference between rotations at time t and time (t−1) using the row vector H′(gₜ₋₁⁻¹, ω) that is the operation result at time (t−1) in all the directions of the angle the angle α, and the angle γ. However, it is not limited thereto, and the result of the rotation operation of the head-related transfer function at time (t−1) may be further rotated by the amount of the difference between the angles at time t and time (t−1) with respect to the direction (rotation direction) of at least one of the angle α, the angle β or the angle γ.

The head-related transfer function synthesis unit 27 synthesizes the input signal D′ₙ^{m}(ω) for each time-frequency bin ω that is a sound signal in the spherical harmonic domain supplied from the outside with the row vector H′(gₜ⁻¹, ω) supplied from the rotation operation unit 24 to generate drive signals of the left and right headphones.

That is, the head-related transfer function synthesis unit 27 calculates a drive signal Pₗ(g, ω) and a drive signal Pᵣ(g, ω) of the left and right headphones by obtaining a product of the row vector H′(gₜ⁻¹, ω) and the matrix D′(ω) including the input signal D′ₙ^{m}(ω), which is a sound signal in the spherical harmonic domain, for each of the left and right headphones, and supplies the drive signal Pₗ(g, ω) and the drive signal Pᵣ(g, ω) to the time-frequency inverse transform unit 28.

Here, the drive signal Pₗ(g, ω) is a drive signal (binaural signal) of the left headphone in the time-frequency domain, and the drive signal Pᵣ(g, ω) is a drive signal (binaural signal) of the right headphone in the time-frequency domain.

In the head-related transfer function synthesis unit 27, synthesis of the head-related transfer function with respect to the input signal and spherical harmonic inverse transform with respect to the input signal are simultaneously performed.

The time-frequency inverse transform unit 28 performs the time-frequency inverse transform on the drive signal in the time-frequency domain supplied from the head-related transfer function synthesis unit 27 for each of the left and right headphones to obtain the drive signal pₗ(g, t) of the left headphone in the time domain and the drive signal pᵣ(g, t) of the right headphone in the time domain, and outputs these drive signals to the subsequent stage. In a reproduction device that reproduces sound in two channels or a plurality of channels, such as headphones in a subsequent stage, more specifically, headphones including an earphone or a speaker using a transaural technology, sound is reproduced on the basis of the drive signal output from the time-frequency inverse transform unit 28. Note that in a case where an input signal has not been subjected to the time-frequency conversion, a time-frequency transform unit is provided at an input part of the signal, that is, for example, at a preceding stage of the head-related transfer function synthesis unit 27, or a convolution operation in the time domain is performed by the head-related transfer function synthesis unit 27.

Here, processing in each unit of the audio processing device 11 will be specifically described.

For example, the rotation matrix operation unit 23 obtains the head rotation information at time t, that is, a difference Δgₜ=gₜgₜ₋₁⁻¹ between the angle gₜ at time t and the angle gₜ₋₁ at time (t−1). Then, the rotation matrix operation unit 23 obtains the difference Δβₜ, the difference Δαₜ, and the difference Δγₜ from the difference Δgₜ, and reads the rotation matrix R′(a(β)) when the angle β is the difference Δβₜ and the rotation matrix R′(u(α)) when the angle α is the difference Δαₜ and the difference Δγₜ from the retained tables of the rotation matrix R′(a(β)) and the rotation matrix R′(u(α)) to obtain the rotation matrix R′(a(Δβₜ)), the rotation matrix R′(u(Δαₜ)), and the rotation matrix R′(u(Δγₜ)).

Moreover, the rotation matrix operation unit 23 performs an operation similar to the above-described Equation (29) to synthesize the rotation matrix R′(u(Δαₜ)), the rotation matrix R′(a(Δβₜ)), and the rotation matrix R′(u(Δγₜ)) obtained in this manner to obtain a rotation matrix R′(Δgₜ).

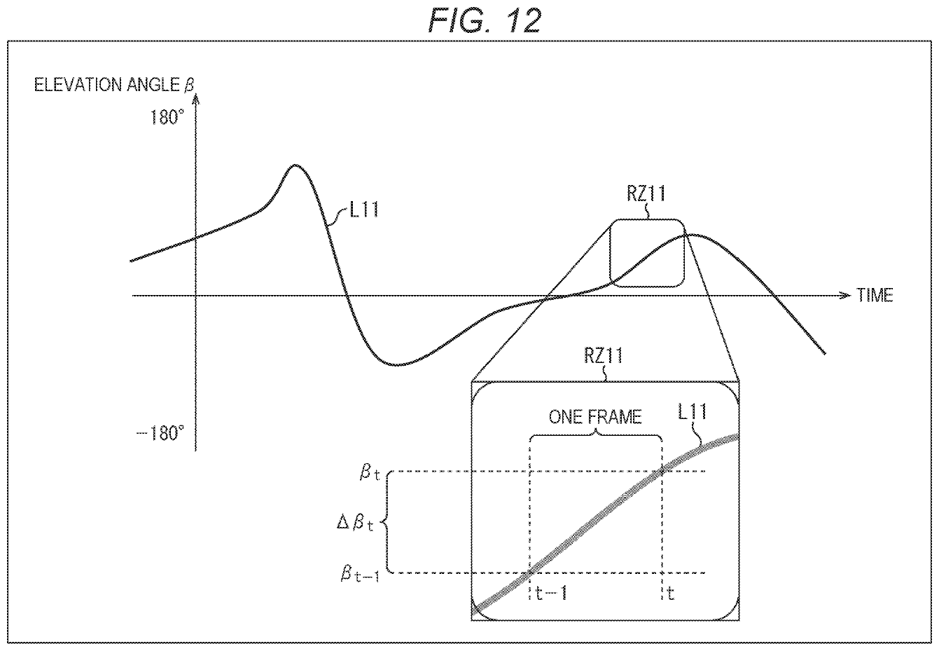

For example, when the difference Δβₜ is obtained for each frame of the input signal D′ₙ^{m}(ω), that is, for each one frame, the difference Δβₜ is as illustrated in FIG. 12. Note that in FIG. 12, the vertical axis represents the angle β (elevation angle β) at each time, and the horizontal axis represents the time.

In the example illustrated in FIG. 12, a curve L11 indicates the angle β at each time, and a portion of a region RZ11 in the curve L11 is enlarged as illustrated on a lower side in the drawing.

Here, a period from time (t−1) to time t is a period of one frame. Thus, the difference between the angle βₜ, which is the angle β at time t, and the angle βₜ₋₁, which is the angle β at time (t−1), is Δβₜ.

In the rotation matrix operation unit 23, the rotation matrix R′(Δgₜ) obtained on the basis of the difference Δgₜ is supplied to the rotation operation unit 24, and the angle gₜ at time t is supplied to the previous direction retention unit 22 to update the previous direction information. That is, the newly supplied angle gₜ at time t is retained as the updated previous direction information.

The rotation operation unit 24 calculates the row vector H′(gₜ⁻¹, ω) at time t on the basis of the rotation matrix R′(Δgₜ) and the row vector H′(gₜ₋₁⁻¹, ω) at time (t−1).

For example, following Equation (39) holds for any rotation matrix g₁ and rotation matrix g₂.

[Equation 39]

R′(g₁g₂)=R′(g₁)R′(g₂) (39)

From this, following Equation (40) holds, and it can be seen that the row vector H′(gₜ⁻¹, ω) is obtained by obtaining the product of the row vector H′(gₜ₋₁⁻¹, ω) and the rotation matrix R′(Δgₜ).

[Equation 40]

H′(gₜ⁻¹,ω)=H′(gₜ₋₁⁻¹,ω)R′(Δgₜ) (40)

That is, elements of the degree n and the order m of the row vector H′(gₜ⁻¹, ω) are H′ₙ^{m}(gₜ₋₁, ω), elements of the degree n and the order m of the rotation matrix R′(Δgₜ) are R′⁽ⁿ⁾_{k, m}(Δgₜ), and a constant that determines an effective element width in the degree n of the rotation matrix R′(Δgₜ) is C. In this case, following Equation (41) holds. That is, each non-zero element of the row vector H′(gₜ⁻¹, ω) can be obtained by the operation of following Equation (41).

$$\begin{matrix} [ Equation 41 ] & \\ {H}_{n}^{′ m} ( {g}_{t}^{- 1} , ω ) = {\sum }_{k = - n}^{n} {H}_{n}^{′ k} ( {g}_{t - 1}^{- 1} , ω ) {R}_{k , m}^{′ ( n )} ( Δ {g}_{t} ) ≅ {\sum }_{k = max ( - n , m - C )}^{min ( n , m + C )} {H}_{n}^{′ k} ( {g}_{t - 1}^{- 1} , ω ) {R}_{k , m}^{′ ( n )} ( Δ {g}_{t} ) & ( 41 )\end{matrix}$$

The rotation operation unit 24 obtains the row vector H′(gₜ⁻¹, ω) by calculating Equation (41). In an operation of Equation (41), only (2C+1) elements whose order k is within the range from m−C to m+C centered on m are calculated, similarly to Equation (36) described above. However, the range is limited to −n≤k≤n. That is, the operation is a rotation operation in which the order k is limited, in which the operation is performed only for an element whose order k is a value within a range determined by C, and the operation amount is reduced.

Note that the rotation matrix operation unit 23 may sequentially obtain the rotation matrix R′(a(Δβₜ)) by calculation, or may select the rotation matrix R′(a(Δβₜ)) from one or more candidates prepared in advance.

Moreover, by combining a method of operating the rotation matrix R′(a(Δβₜ)) according to the time and a method of selecting the rotation matrix R′(a(Δβₜ)) from one or more candidates, the angle of rotating the head-related transfer function may be adjusted by following the actual angle βₜ of rotation of the head of the listener while changing the frequency of using each of these methods.

<Description of Drive Signal Generation Processing>

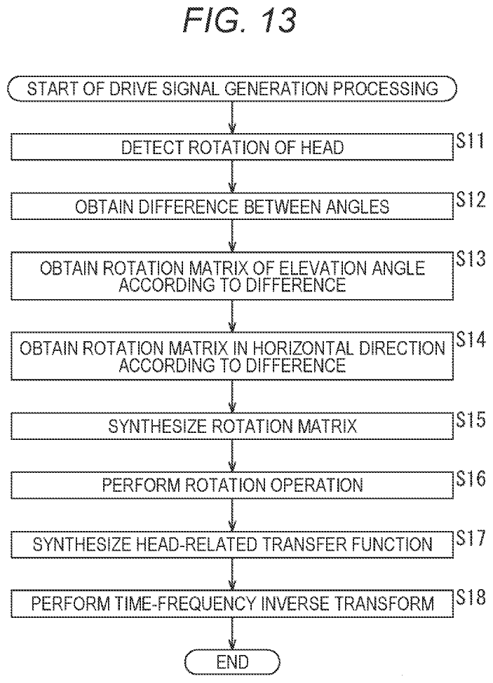

Next, drive signal generation processing performed by the audio processing device 11 will be described with reference to a flowchart of FIG. 13.

In step S11, the head rotation sensor unit 21 detects rotation of the head of the user who is a listener, and supplies the head rotation information obtained as a detection result thereof to the rotation matrix operation unit 23.

In step S12, the rotation matrix operation unit 23 obtains a difference Δgₜ between the angle gₜ of the head rotation information supplied from the head rotation sensor unit 21 and the angle gₜ₋₁ at time (t−1) retained as the previous direction information in the previous direction retention unit 22.

Furthermore, when the difference Δgₜ is obtained, the rotation matrix operation unit 23 supplies the angle gₜ of the head rotation information obtained in step S11 to the previous direction retention unit 22 to update the previous direction information. The previous direction retention unit 22 updates the previous direction information so that the angle gₜ supplied from the rotation matrix operation unit 23 becomes new previous direction information, and retains an update result thereof.

In step S13, the rotation matrix operation unit 23 obtains the rotation matrix R′(a(Δβₜ)) in the elevation angle direction according to the difference Δβₜ of the difference Δgₜ on the basis of the difference Δgₜ obtained in step S12. Note that in step S13, the rotation matrix operation unit 23 may obtain the rotation matrix Rs′(a(Δβₜ)) according to the difference Δβₜ corresponding to the above-described rotation matrix Rs′(a(β) as the rotation matrix R′(a(Δβₜ)).

In step S14, on the basis of the difference Δαₜ and the difference Δγₜ of the head rotation obtained from the difference Δgₜ obtained in step S12, the rotation matrix operation unit 23 obtains the rotation matrix R′(u(Δαₜ)) and the rotation matrix R′(u(Δγₜ)) in the horizontal direction according to the differences.

In step S15, the rotation matrix operation unit 23 synthesizes the rotation matrix R′(a(Δβₜ)) in the elevation angle direction obtained in step S13 with the rotation matrix R′(u(Δαₜ)) and the rotation matrix R′(u(Δγₜ)) in the horizontal direction obtained in step S14 to obtain the rotation matrix R′(Δgₜ) that performs rotation by the amount of a difference in the entire rotation of the head, and supplies the rotation matrix R′(Δgₜ) to the rotation operation unit 24.

In step S16, the rotation operation unit 24 performs a rotation operation on the basis of the rotation matrix R′(Δgₜ) supplied from the rotation matrix operation unit 23 and the row vector H′(gₜ₋₁⁻¹, ω) retained in the rotation coefficient retention unit 25.

That is, for example, in step S16, the above-described calculation of Equation (41) is performed as the rotation operation on the basis of the effective element width 2C+1 determined by the constant C, and the row vector H′(gₜ⁻¹, ω) is calculated.

The rotation operation unit 24 supplies the obtained row vector H′(gₜ⁻¹, ω) to the rotation coefficient retention unit 25 to retain, and also supplies the row vector H′(gₜ⁻¹, ω) to the head-related transfer function synthesis unit 27.

In step S17, the head-related transfer function synthesis unit 27 synthesizes the supplied input signal D′ₙ^{m}(ω) and the row vector H′(gₜ⁻¹, ω) of the head-related transfer function supplied from the rotation operation unit 24 to generate drive signals of the left and right headphones.

For example, in step S17, a product of the row vector H′(gₜ⁻¹, ω) and the matrix D′(ω) is obtained for each of the left and right headphones, and the drive signal Pₗ(g, ω) and the drive signal Pᵣ(g, ω) of the left and right headphones are calculated. The head-related transfer function synthesis unit 27 supplies the obtained drive signal Pₗ(g, ω) and drive signal Pᵣ(g, ω) to the time-frequency inverse transform unit 28.

In step S18, the time-frequency inverse transform unit 28 performs the time-frequency inverse transform on the drive signal Pₗ(g, ω) and the drive signal Pᵣ(g, ω) supplied from the head-related transfer function synthesis unit 27, and outputs the drive signal Pₗ(g, t) and the drive signal pᵣ(g, t) obtained as a result to the subsequent stage, and the drive signal generation processing ends.

As described above, the audio processing device 11 obtains the rotation matrix R′(Δgₜ) on the basis of the difference Δgₜ, and obtains the current row vector H′(gₜ⁻¹, ω) on the basis of the rotation matrix R′(Δgₜ) and the previous row vector H′(gₜ₋₁⁻¹, ω).

By accumulating rotation by the difference Δgₜ, which is a minute rotation angle, to obtain the row vector H′(gₜ⁻¹, ω) in this manner, it is possible to reduce the memory amount and the operation amount to be used. Consequently, sound can be reproduced more efficiently. In particular, according to the fifth method described above, it is possible to obtain the drive signals with a memory amount equivalent to that of the fourth method and with a smaller operation amount than that of the fourth method.

### Second Embodiment

<Configuration Example of Audio Processing Device>

Incidentally, in the fifth method described above, since the operation is performed using only the elements in the block having the effective element width 2C+1 determined by the constant C, that is, only the effective elements, not a few errors occur in the rotation matrix R′(gₜ), that is, the row vector H′(gₜ⁻¹, ω).

Furthermore, when the operation in which such errors occur is repeatedly performed for a while, errors are accumulated, and the row vector H′(gₜ⁻¹, ω) becomes a value away from the original value. That is, the error of the row vector H′(gₜ⁻¹, ω) increases.

Accordingly, accumulation of errors may be prevented by performing an operation to obtain the accurate rotation matrix R′(gₜ⁻¹) at a predetermined timing and resetting the values of the rotation matrix R′(gₜ⁻¹), that is, the row vector H′(gₜ⁻¹, ω) (hereinafter, also simply referred to as reset). Hereinafter, a method of performing reset at a predetermined timing in the fifth method will also be referred to as a sixth method.

In the sixth method, an operation with an operation amount on the order of the cube of the degree n is required to obtain the row vector H′(gₜ⁻¹, ω) at the time of reset, but the reset is not performed frequently, so that the operation amount can be reduced as a whole.

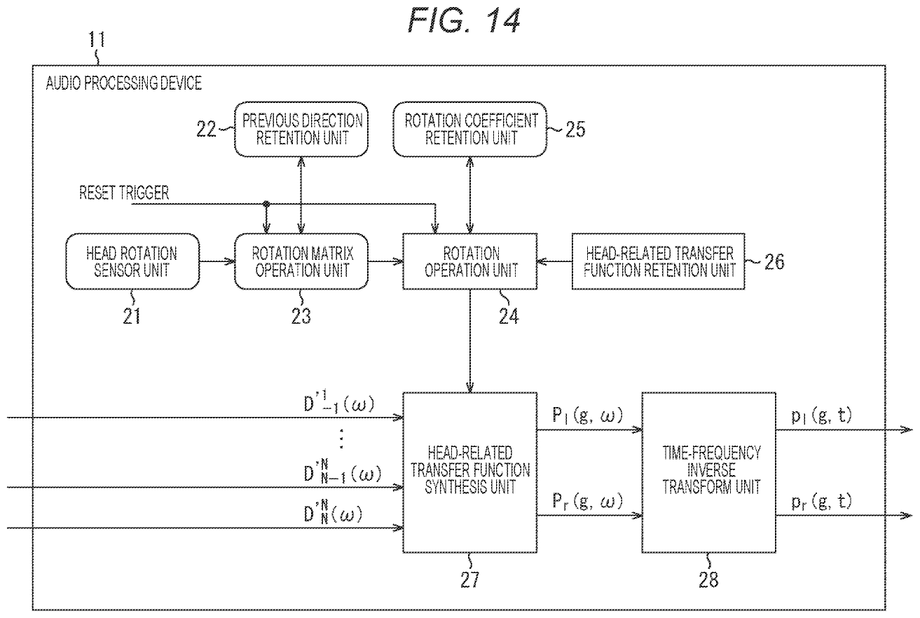

As described above, in a case where the reset is appropriately performed, the audio processing device 11 is configured as illustrated in FIG. 14. Note that in FIG. 14, parts corresponding to those in the case of FIG. 11 are denoted by the same reference numerals, and the description thereof will be omitted as appropriate.

The audio processing device 11 illustrated in FIG. 14 includes a head rotation sensor unit 21, a previous direction retention unit 22, a rotation matrix operation unit 23, a rotation operation unit 24, a rotation coefficient retention unit 25, a head-related transfer function retention unit 26, a head-related transfer function synthesis unit 27, and a time-frequency inverse transform unit 28.

The audio processing device 11 illustrated in FIG. 14 is the same as the audio processing device 11 in FIG. 11 in including the head rotation sensor unit 21 to the time-frequency inverse transform unit 28, but is different from the audio processing device 11 in FIG. 11 in that a reset trigger, which is a signal indicating a timing to reset, is supplied to the rotation matrix operation unit 23 and the rotation operation unit 24.

When the reset trigger is not supplied, that is, when the reset trigger is off, the rotation matrix operation unit 23 obtains the rotation matrix R′(Δgₜ) on the basis of the angle gₜ of the head rotation information and the angle gₜ₋₁ as the previous direction information, and supplies the rotation matrix R′(Δgₜ) to the rotation operation unit 24.

On the other hand, when the reset trigger is supplied, that is, when the reset trigger is on, the rotation matrix operation unit 23 obtains the rotation matrix R′(gₜ) on the basis of the angle gₜ of the head rotation information and supplies the rotation matrix R′(gₜ) to the rotation operation unit 24. That is, the reset is performed to obtain the accurate rotation matrix R′(gₜ). In other words, the absolute rotation matrix R′(gₜ) is obtained instead of one obtained by the difference of the rotation matrix R′(Δgₜ) or the like.

Furthermore, in a case where the reset trigger is off, the rotation operation unit 24 calculates the row vector H′(gₜ⁻¹, ω) on the basis of the rotation matrix R′(Δgₜ) supplied from the rotation matrix operation unit 23 and the row vector H′(gₜ₋₁⁻¹, ω) retained in the rotation coefficient retention unit 25.

On the other hand, in a case where the reset trigger is on, the rotation operation unit 24 calculates the row vector H′(gₜ⁻¹, ω) on the basis of the rotation matrix R′(gₜ) supplied from the rotation matrix operation unit 23 and the row vector H_{S}(ω) of the head-related transfer function retained in the head-related transfer function retention unit 26.

In this case, the rotation operation unit 24 performs a calculation similar to the above described Equation (35) or (36) to calculate the row vector H′(gₜ⁻¹, ω). That is, a product of the rotation matrix R′(gₜ) and the row vector H_{S} (ω) is obtained, and the row vector H′(gₜ⁻¹, ω) is calculated.

In this manner, by performing reset in response to the input of the reset trigger and obtaining the accurate rotation matrix R′(gₜ) and row vector H′(gₜ⁻¹, ω), it is possible to obtain drive signals with less error while suppressing the necessary memory amount and operation amount.

Note that here, an example in which the reset trigger is turned on and off at any timing will be described, but the reset trigger may be always turned on. That is, the rotation matrix R′(gₜ) may be always calculated.

Furthermore, the reset trigger may be turned on at any timing. For example, the timing at which the reset trigger is turned on may be a predetermined regular (periodic) timing such as a predetermined time interval, may be a timing at which the difference Δβₜ becomes equal to or more than a threshold value, or may be a timing at which the angle βₜ becomes equal to or more than a predetermined value, and the like.

<Description of Drive Signal Generation Processing>

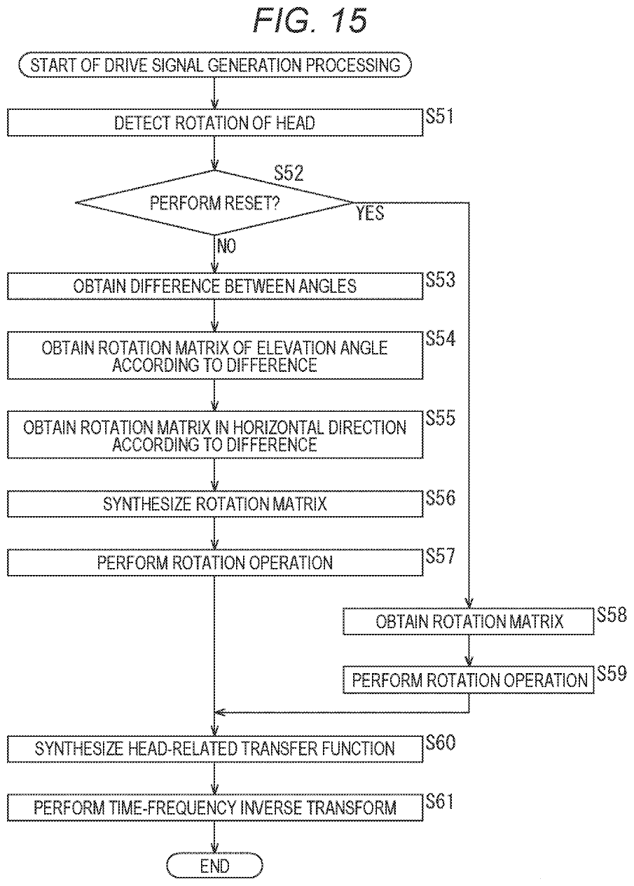

Next, drive signal generation processing performed by the audio processing device 11 of FIG. 14 will be described with reference to a flowchart of FIG. 15.

Note that processing of step S51 is similar to the processing of step S11 in FIG. 13, and thus the description thereof will be omitted.

In step S52, the rotation matrix operation unit 23 determines whether or not to perform reset on the basis of a reset trigger supplied from the outside. For example, in a case where the reset trigger is turned on, it is determined to perform the reset.

In a case where it is determined in step S52 not to perform the reset, the processing proceeds to step S53, and the processing of steps S53 to S57 is performed.

Note that the processing of steps S53 to S57 is similar to the processing of steps S12 to S16 in FIG. 13, and thus the description thereof will be omitted.

When the processing of step S57 is performed, the rotation operation unit 24 supplies the obtained row vector H′(gₜ⁻¹, ω) to the head-related transfer function synthesis unit 27 and the rotation coefficient retention unit 25, and thereafter, the processing proceeds to step S60.

On the other hand, in a case where it is determined in step S52 to perform the reset, in step S58, the rotation matrix operation unit 23 obtains the rotation matrix R′(a(βₜ)) in the elevation angle direction, and the rotation matrix R′(u(γₜ)) and the rotation matrix R′(u(γₜ)) in the horizontal direction on the basis of the angle gₜ of the head rotation information supplied from the head rotation sensor unit 21.

Moreover, the rotation matrix operation unit 23 synthesizes the rotation matrix R′(a(βₜ)), the rotation matrix R′(u(αₜ)), and the rotation matrix R′(u(γₜ)) to obtain the rotation matrix R′(gₜ), and supplies the rotation matrix R′(gₜ) to the rotation operation unit 24. Note that, in step S58, the rotation matrix R′(a(βₜ)) may be obtained from a table on the basis of the angle βt, or the rotation matrix R′(a(βₜ)) may be obtained by operation on the basis of the angle βₜ. Similarly, the rotation matrix R′(u(αₜ)) and the rotation matrix R′(u(γₜ)) may be obtained by operation on the basis of the angle αₜ and the angle γₜ, or the rotation matrix R′(u(αₜ)) and the rotation matrix R′(u(γₜ)) may be obtained from a table on the basis of the angle αₜ and the angle γₜ.

In step S59, the rotation operation unit 24 performs a rotation operation on the basis of the rotation matrix R′(gₜ) supplied from the rotation matrix operation unit 23 and the row vector H_{S}(ω) of the head-related transfer function retained in the head-related transfer function retention unit 26, and calculates the row vector H′(gₜ⁻¹, ω). For example, in step S59, a calculation similar to the above described Equation (35) or (36) is performed to calculate the row vector H′(gₜ⁻¹, ω).

When the row vector H′(gₜ⁻¹, ω) is obtained, the rotation operation unit 24 supplies the obtained row vector H′(gₜ⁻¹, ω) to the head-related transfer function synthesis unit 27 and the rotation coefficient retention unit 25, and thereafter, the processing proceeds to step S60.

When the processing of step S57 or step S59 is performed, the processing of steps S60 and S61 is subsequently performed and the drive signal generation processing ends, but since the processing of these steps is similar to the processing of steps S17 and S18 in FIG. 13, the description thereof will be omitted.

As described above, when the reset trigger is turned on, the audio processing device 11 obtains the accurate rotation matrix R′(gₜ) and row vector H′(gₜ⁻¹, ω) and generates the drive signals. In this manner, it is possible to obtain drive signals with fewer errors while suppressing the necessary memory amount and operation amount.

Note that, for example, in a case where the head of the listener rapidly rotates greatly in the elevation angle direction, the difference Δβₜ rapidly increases. Thus, when it is attempted to obtain the row vector H′(gₜ⁻¹, ω) following rotation of the head of the listener, if it is attempted to accurately obtain the row vector H′(gₜ⁻¹, ω), the operation amount increases, and if it is attempted to obtain the row vector H′(gₜ⁻¹, ω) with a small operation amount, the error increases.

In such a case, for example, in a case where it is desired to suppress the operation amount to be low, when the actual difference Δβₜ becomes equal to or more than a predetermined threshold value such as 30 degrees or more, the rotation matrix operation unit 23 may obtain the rotation matrix R′(a(Δβₜ)) by limiting the value of the difference Δβₜ to a value of one degree or less regardless of the value of the actual difference Δβₜ.

In this manner, although it cannot be followed and an error occurs in the rotation matrix R′(a(Δβₜ)) until the actual difference Δβₜ becomes less than the threshold value, the operation amount can be suppressed low. Note that such processing can be performed independently of on and off of the reset trigger.

Furthermore, for example, in a case where the actual difference Δβₜ is equal to or more than a predetermined threshold value such as 30 degrees or more, the rotation matrix operation unit 23 may set C that determines the effective element width 2C+1 to a predetermined value, and obtain the rotation matrix R′(a(βₜ)) only for the elements in the block having the effective element width 2C+1 determined for C, that is, effective elements. In this case, in the rotation operation unit 24, the calculation of Equation (36) is performed only for the effective element determined for C, and the row vector H′(gₜ⁻¹, ω) is obtained.

In this example, although the operation amount increases since the rotation matrix R′(gₜ) is used, the operation of only the effective element determined by C that determines the effective element width 2C+1 is sufficient, so that the operation amount can be kept low to some extent while following rotation of the head of the listener. Such processing can also be performed independently of on and off of the reset trigger.

Moreover, for example, in a case where the actual difference Δβₜ is equal to or more than a predetermined threshold value such as 30 degrees or more, the rotation matrix R′(a(Δβₜ)) is obtained and the row vector H′(gₜ₋₁⁻¹, ω) is obtained from the rotation matrix R′(Δgₜ) obtained by the rotation matrix R′(a(Δβₜ)) and the row vector H′(gₜ₋₁⁻¹, ω), but at this time, the rotation operation unit 24 may temporarily set C that determines the effective element width 2C+1 to be larger than that at the normal time. Here, the value of C may be a constant, or may be determined by the degree n, the difference Δβₜ, or the like.

In this manner, although the operation amount at the time of obtaining the row vector H′(gₜ⁻¹, ω) increases, it is possible to follow the rotation of the head of the listener. Also in this case, the processing of changing the value of C can be performed independently of the on and off of the reset trigger.

In addition, for example, the reset may be performed when the angle βₜ of the head rotation information becomes a predetermined value (hereinafter, also referred to as a reset point).

Specifically, for example, the rotation matrix operation unit 23 retains the rotation matrix R′(a(β)) obtained in advance for the angle β that is a reset point for each of one or more reset points. For example, it is assumed that a rotation matrix R′(a(β₁)) is retained in advance for an angle β₁ determined as a reset point.

In this case, for example, when the angle βₜ is the angle β1, the rotation matrix operation unit 23 obtains the rotation matrix R′(gₜ) by using the retained rotation matrix R′(a(β₁)) as the rotation matrix R′(a(βₜ)), and supplies the rotation matrix R′(gₜ) to the rotation operation unit 24. In this manner, although a memory for retaining the rotation matrix R′(a(β)) is necessary for each reset point, it is not necessary to perform the operation of the rotation matrix R′(a(βₜ)), and thus it is possible to suppress the operation amount to be low while performing reset so that the rotation matrix R′(a(β₁)) becomes accurate.

### Modification Example 1 of Second Embodiment

<Reset Control in Plurality of Devices>

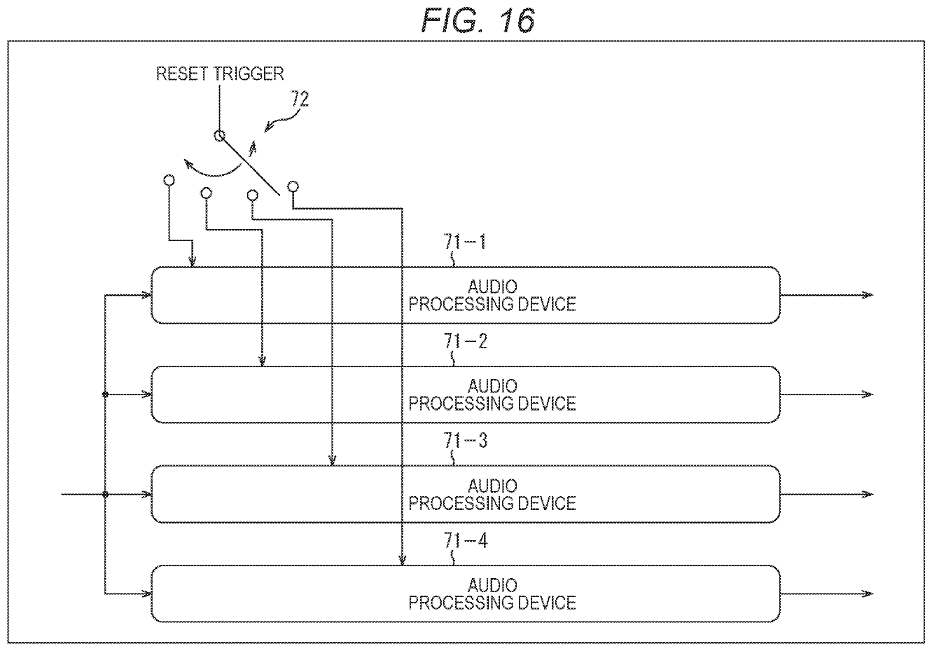

Furthermore, for example, it is assumed that there is a plurality of listeners in a space, and there is a control system in which each of a plurality of audio processing devices outputs a drive signal to each of headphones or the like worn by the respective listeners, as illustrated in FIG. 16.

The control system illustrated in FIG. 16 includes audio processing devices 71-1 to 71-4 and a switch 72.

Here, each of the audio processing device 71-1 to the audio processing device 71-4 has the same configuration as the audio processing device 11 illustrated in FIG. 14. Note that, hereinafter, in a case where it is not particularly necessary to distinguish the audio processing device 71-1 to the audio processing device 71-4, they will also be simply referred to as the audio processing device 71.

Each audio processing device 71 receives the input signal D′ₙ^{m}(ω) as input, performs processing similar to the drive signal generation processing described with reference to FIG. 15, and outputs the left and right drive signals Pₗ(g, t) and pᵣ(g, t) of the headphones.

Note that each audio processing device 71 may be one independent device, or the audio processing devices 71 may be provided in one device, but here, each audio processing device 71 is provided in one computer system (device) at the center.

The switch 72 controls supply of the reset trigger to the audio processing device 71 so that the reset trigger is supplied to any one of the audio processing devices 71-1 to 71-4 at any timing.

In such a control system, each of the plurality of listeners is wearing a headphone, and each of the headphones reproduces sound on the basis of a drive signal supplied from each of the audio processing devices 71 different from each other.

Then, each of the audio processing devices 71 detects movement (rotation) of the headphones, which is the output destination of the drive signal, that is, the head of the listener wearing the headphones by the head rotation sensor unit 21, rotates the head-related transfer function following the movement of the head of the listener, and generates the drive signal.

In the control system, since the switch 72 supplies the reset trigger to each of the four audio processing devices 71 at different timings, a plurality of the audio processing devices 71 is not simultaneously reset. Therefore, it is possible to suppress an unexpected increase in the operation load in the entire control system. That is, it is possible to prevent the operation amount from temporarily increasing.

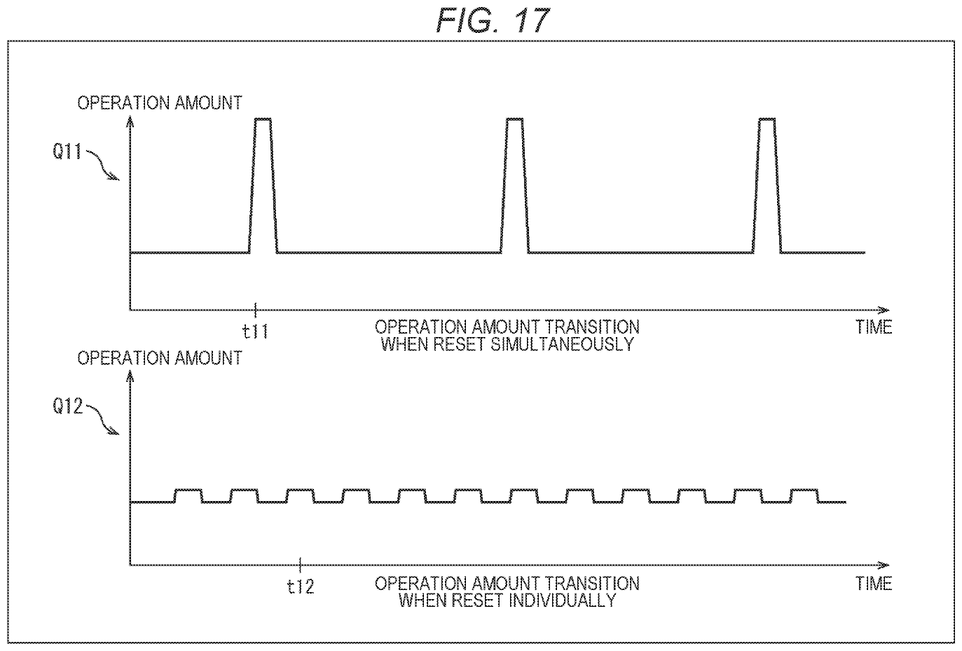

In the control system, in a case where four audio processing devices 71 are simultaneously reset, for example, as indicated by an arrow Q11 in FIG. 17, the operation amount in the entire control system temporarily increases (enlarges) at the time when the reset is performed.

Note that in FIG. 17, the vertical axis represents the operation amount in the entire control system, and the horizontal axis represents the time.

For example, in the example indicated by the arrow Q11, in the control system, four audio processing devices 71 are simultaneously reset at predetermined cycles. For example, the reset is performed at time t11 and the operation amount increases (enlarges) at time t11, but the operation amount is kept low at other times at which the reset is not performed.

In this case, although the frequency of increase in the operation amount is low, the operation load in the control system temporarily increases at the time of reset.

On the other hand, for example, in the example indicated by an arrow Q12, the plurality of audio processing devices 71 is not reset at the same time, and the respective audio processing devices 71 are reset at different timings. In this case, although the frequency of increase in the operation amount increases, the operation amount at each time does not increase so much. That is, although the operation amount increases at the time of reset, the increase in the operation amount at that time is only required by the amount of reset in one audio processing device 71, and thus an operation load is not applied as much as when the reset is performed simultaneously in the plurality of audio processing devices 71.

For example, at time t12, one audio processing device 71 performs the reset, but the operation amount is kept low as compared with time t11 in the example indicated by the arrow Q11.

Note that, here, although the example in which the reset is performed for each audio processing device 71 has been described, if the reset is not performed simultaneously in all the audio processing devices 71, the operation load can be suppressed. For example, all the audio processing devices 71 may be divided into a plurality of groups including one or more audio processing devices 71, and reset may be performed for each of the groups.

As described above, in a case where there is a plurality of audio processing devices 71, the reset is performed in each of the audio processing devices 71 at different timings, so that it is possible to suppress a temporary increase in the operation amount.

### Modification Example 2 of Second Embodiment

<Reset for Each Degree or Order>

Furthermore, regardless of the example of the audio processing device 11 illustrated in FIG. 14 or the example of the control system illustrated in FIG. 16, that is, regardless of whether there are one or more listeners, the reset may be performed for each degree n or for each order m. Also in this manner, it is possible to suppress an increase in the operation load at the time of reset.

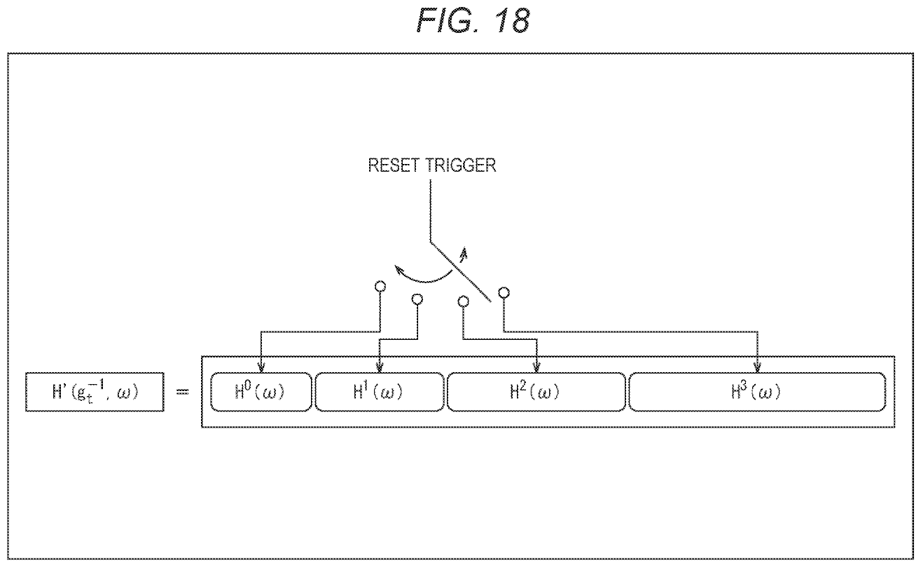

For example, as illustrated in FIG. 18, it is assumed that the row vector H′(gₜ⁻¹, ω) includes a matrix H⁰(ω) including elements of the degree n=0, a matrix H¹(ω) including elements of the degree n=1, a matrix H²(ω) including elements of the degree n=2, and a matrix H³(ω) including elements of the degree n=3.

In such a case, for example, only components of a predetermined degree may be reset for the degree n. At that time, the components of respective degrees may be reset at different timings, or the components of several degrees may be reset simultaneously.

For example, in a case where only a zeroth-order component of the degree n, that is, a component of the degree n=0 is reset, a product of the rotation matrix R′(gₜ) and the row vector H_{S}(ω) is obtained for the zeroth-order component, and the matrix H⁰(ω) is generated.

On the other hand, for the first-order to third-order components of the degree n, a product of the rotation matrix R′(Δgₜ) and the row vector H′(gₜ₋₁⁻¹, ω) is obtained, that is, the calculation of Equation (41) is performed to generate the matrix H¹(ω), the matrix H²(ω), and the matrix H³(ω).

Then, the final row vector H′(gₜ⁻¹, ω) is obtained from the matrix H⁰(ω), the matrix H¹(ω), the matrix H²(ω), and the matrix H³(ω) obtained in this manner.

Thus, for example, in the audio processing device 11 illustrated in FIG. 14, at the timing when only the zeroth-order component of the degree n is reset, the processing of steps S58 and S59 of FIG. 15 is performed on the zeroth-order component, and the matrix H⁰(ω) is generated. On the other hand, for the first-order to third-order components of the degree n, the processing in steps S53 to S57 is performed to generate the matrix H¹(ω), the matrix H²(ω), and the matrix H³(ω). Then, the row vector H′(gₜ⁻¹, ω) is generated from the matrix H⁰(ω), the matrix H¹(ω), the matrix H²(ω), and the matrix H³(ω).

Note that even in a case where the reset is performed for each degree, for example, some groups such as a group including the zeroth order and the first order of the degree n may be provided, and the reset may be performed for each of the groups.

For example, in the example illustrated in FIG. 18, since the number of elements is small from the zeroth order to the second order of the degree n, the zeroth order to the second order of the degree n may be set as one group, so that the zeroth order, the first order, and the second order components of the degree n are reset at the same time. In this case, the reset timing of the zeroth-order, first-order, and second-order components of the degree n and the reset timing of the third-order components of the degree n are different from each other.

Note that, here, the case where the reset is performed for each degree n has been described as a specific example, but a case where the reset is performed for each order m is similar to the case where the reset is performed for each degree n.

### Modification Example 3 of Second Embodiment

<Reset for Each Time Frequency>

Furthermore, the reset may be performed for each time frequency ω regardless of the example of the audio processing device 11 illustrated in FIG. 14 or the example of the control system illustrated in FIG. 16, that is, regardless of whether one or more listeners are present. Also in this manner, it is possible to suppress an increase in the operation load at the time of reset.

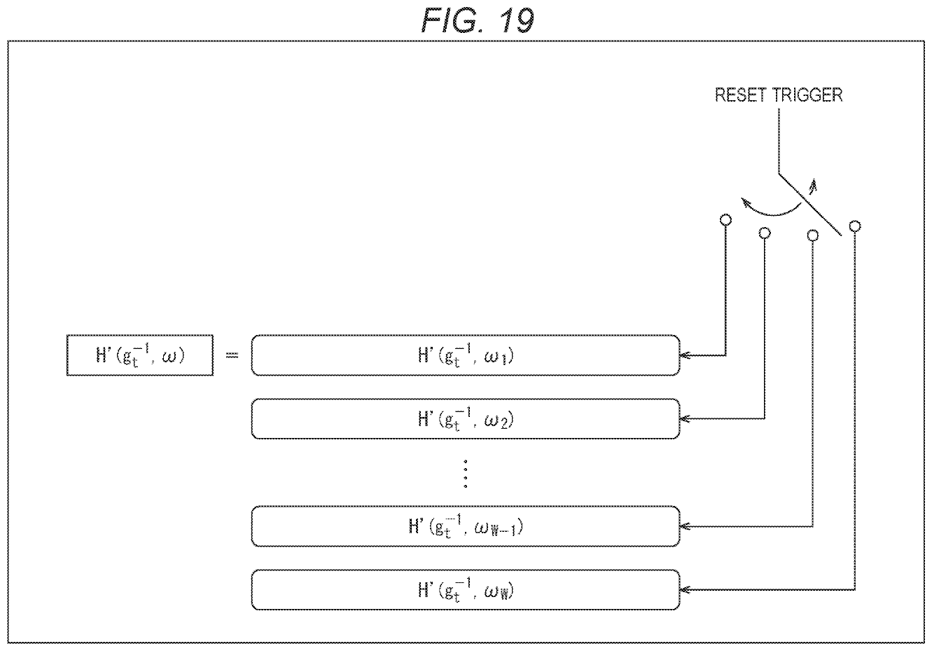

For example, as illustrated in FIG. 19, it is assumed that the number of time-frequency bins ω is W, and the row vector H′(gₜ⁻¹, ω) is obtained for W time-frequencies ω₁ to ω_{W}. That is, it is assumed that row vectors H′(gₜ⁻¹, ω₁) to H′(gₜ⁻¹, ω_{W}) are obtained.

In such a case, for example, the reset may be performed only for a predetermined time frequency ω. At that time, the reset may be performed at different timings for each time frequency ω, or the reset may be simultaneously performed at several time frequencies ω.

For example, in the audio processing device 11 illustrated in FIG. 14, at the timing when the reset is performed only for the time frequency ω₁, the processing of steps S58 and S59 of FIG. 15 is performed for the time frequency ω₁, and the row vector H′(gₜ⁻¹, ω₁) is generated.

On the other hand, for the time frequency ω₂ to the time frequency ω_{W}, the processing in steps S53 to S57 in FIG. 15 is performed to generate row vectors H′(gₜ⁻¹, ω₂) to H′(gₜ⁻¹, ω_{W}).

Note that even in a case where the reset is performed for each time frequency ω, some groups including one or more time frequencies ω may be provided, and the reset may be performed for each of the groups.

### Modification Example 4 of Second Embodiment

<Another Example of Control System>

Furthermore, in the control system illustrated in FIG. 16, a case has been assumed where the audio processing devices 71 corresponding to a plurality of listeners are operated by one computer system at the center.

However, in a case where the number of listeners dynamically changes, it is difficult to determine performance of the central computer system in advance.

Therefore, in a case where a system (slave) for each listener such as a smartphone independently performs a process of generating a drive signal for each listener, and the slave side does not have sufficient processing performance for performing the above-described reset, a central device (master) to which the slave is connected may perform a part or all of the operation at the time of reset.

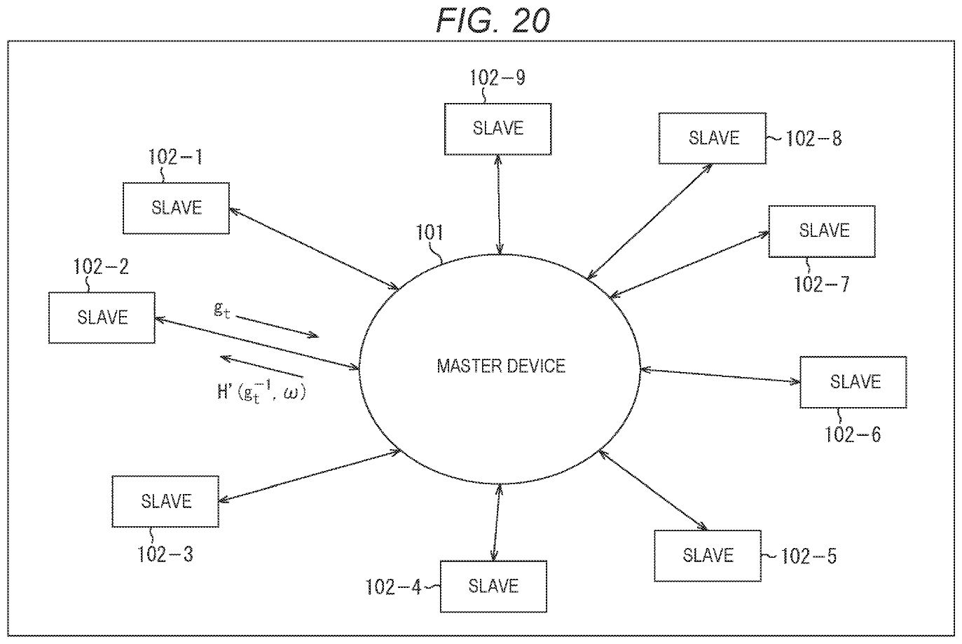

In such a case, the control system is configured as illustrated in FIG. 20, for example.

The control system illustrated in FIG. 20 includes a master device 101 and slaves 102-1 to 102-9.

In this example, the master device 101 and each of the slaves 102-1 to 102-9 are connected to each other via a wired or wireless network. Note that, hereinafter, in a case where it is not necessary to particularly distinguish the slave 102-1 to the slave 102-9, they will also be simply referred to as the slave 102.

The master device 101 substitutes the slave 102 for a part of the operation (processing) originally performed in the slave 102, and supplies the operation result to the slave 102.

The slave 102 includes, for example, a headphone, a smartphone, or the like, and corresponds to the audio processing device 11 illustrated in FIG. 14. The slave 102 performs the drive signal generation processing described with reference to FIG. 15 according to the rotation of the head of the listener or the like and outputs the drive signal, and requests the master device 101 to perform a part of the operation of the drive signal generation processing such as the operation at the time of reset.

As a specific example, for example, the master device 101 can perform operation at the time of reset.

In this case, the slave 102 transmits an operation request to the master device 101 for requesting calculation of the row vector H′(gₜ⁻¹, ω) together with the angle gₜ or the rotation matrix R′(gₜ).

Then, the master device 101 that has received the operation request and the angle gₜ or the rotation matrix R′(gₜ) from the slave 102 performs the operation of following Equation (42) in response to the operation request, and transmits the row vector H′(gₜ⁻¹, ω) obtained as a result to the slave 102.

[Equation 42]

H′(gₜ⁻¹,ω)=Hₛ(ω)R′(gₜ) (42)

Note that the row vector H_{S}(ω) used for the operation of Equation (42) may be acquired in advance by the master device 101 from the slave 102, or may be retained in advance in the master device 101.

In this manner, the slave 102 can obtain the drive signal of the sound to be presented to the listener with a small operation amount using the row vector H′(gₜ⁻¹, ω) received from the master device 101.

Note that, as described above, the reset may be performed for each listener, for each degree n, for each order m, for each time frequency ω, or the like, and the operation load in the master device 101 can be reduced by appropriately determining the timing of the reset. For example, if each slave 102 is reset at different timings from each other, the operation load in the master device 101 can be reduced.

### Modification Example 5 of Second Embodiment

<Another Example of Control System>

Furthermore, contrary to the case of modification example 4 of the second embodiment, the operation at the time of reset may be performed in the slave 102.

In such a case, the master device 101 sequentially receives the angle gₜ, the rotation matrix R′(Δgₜ), and the like from the slave 102, performs an operation represented in following Equation (43), and calculates the row vector H′(gₜ⁻¹, ω).

$$\begin{matrix}[ Equation 43 ] & \\ {H}_{n}^{′ m} ( {g}_{t}^{- 1} , ω ) = {\sum }_{k = max ( - n , m - C )}^{min ( n , m + C )} {H}_{n}^{′ k} ( {g}_{t - 1}^{- 1} , ω ) {R}_{k , m}^{′ ( n )} ( Δ {g}_{t} ) & ( 43 )\end{matrix}$$

Note that in the master device 101, the operation until the row vector H′(gₜ⁻¹, ω) is calculated may be performed, and the remaining operation until the drive signal is obtained may be performed by the slave 102, or the drive signal may be calculated using the row vector H′(gₜ⁻¹, ω) in the master device 101 and supplied to the slave 102.

Furthermore, at the time of reset, the operation of the above-described Equation (42) is performed on the slave 102 side, and the row vector H′(gₜ⁻¹, ω) obtained as a result is transmitted from the slave 102 to the master device 101. Thus, the master device 101 can retain the row vector H′(gₜ⁻¹, ω) received from the slave 102 for use in the operation of Equation (43) performed next time.

By performing the operation at the time of reset on the slave 102 side in this manner, the master device 101 can normally update the row vector H′(gₜ⁻¹, ω) calculated on the basis of the difference to the more accurate row vector H′(gₜ⁻¹, ω), and reset the error.

Note that the row vector H_{S}(ω) required for the operation at the time of reset may be acquired in advance by the slave 102 from the master device 101, may be retained in advance in the slave 102, or may be retained in advance in both the master device 101 and the slave 102.

Furthermore, in a case where only one of the master device 101 and the slave 102 retains the row vector H_{S}(ω) or the like, the row vector H_{S}(ω) or the like retained by the one device may be transmitted to the other device at any timing such as at a time of connection or initialization.

Moreover, also in the case of this embodiment, the reset may be performed for each listener, for each degree n, for each order m, for each time frequency ω, or the like, and the reset timing can be appropriately determined. However, in a case where the operation at the time of reset is performed on the slave 102 side, one slave 102 does not simultaneously perform the operation at the time of reset for a plurality of listeners, and thus it is not necessary to distribute the reset timing.

In addition, the master device 101 and the slave 102 may share and perform the drive signal generation processing described with reference to FIGS. 13 and 15. That is, the master device 101 holding some functions for performing the drive signal generation processing enables a case where the number of listener dynamically increases, and the like to be flexibly coped with.

### Third Embodiment

<Proposed Method>

Incidentally, in the fifth method and the sixth method described above, it is not possible to analytically obtain an error of a rotation matrix with a limited order.

Therefore, it is not known how much error is included in the row vector H′(gₜ⁻¹, ω) after the operation, and it becomes difficult to control the quality. Accordingly, the proposed method enables the upper limit of the error with respect to the limit amount of the order to be quantitatively obtained. Thus, the following (A1) to (A6) can be achieved.

(A1) An order that can be limited is automatically determined by setting an allowable amount of error

(A2) A maximum error is obtained by setting an upper limit of the operation load

(A3) An order for limiting operation is automatically determined for each spherical harmonic degree n

(A4) An order for limiting operation is automatically determined for each time frequency ω

(A5) An upper limit of the accumulated error is obtained

(A6) The reset trigger is applied when the upper limit of the accumulated error exceeds a certain value

Here, derivation of allowable error according to the order of limitation will be described. Furthermore, limitation of the order k by Taylor expansion of the rotation matrix R′(gₜ) will be described.

In the rotation matrix R′(gₜ)=R′(u(α))R′(a(β)R′(u(γ)), diagonal matrices are the rotation matrix R′(u(α)) and the rotation matrix R′(u(γ)), and a block diagonal matrix is the rotation matrix R′(a(β), and thus the limitation on the order of the rotation matrix R′(a(β) is considered.

In the rotation matrix R′(a(β), an nth-order block diagonal matrix R′⁽ⁿ⁾(a(β) can be expressed as above-described Equation (37).

When the matrix exponential function is expanded, the thickness of the diagonal component of the matrix changes according to the degree l of the Taylor expansion.

For example, a term (matrix) corresponding to the degree l=0 is an identity matrix E, and the identity matrix E is a diagonal matrix. Furthermore, in the term corresponding to the degree l=1, elements of ±first diagonal, that is, two diagonal elements are not zero.

Similarly, in the term corresponding to the degree l=2, a total of three diagonal elements of the zeroth and ±second diagonal are non-zero elements. Moreover, in the term corresponding to the degree l=3, a total of four diagonal elements of ±first and ±third diagonal are non-zero elements.

As described above, when the block diagonal matrix R′⁽ⁿ⁾(a(β) is Taylor expanded, as the degree l of the Taylor expansion is larger, the magnitude of the influence on the block diagonal matrix R′⁽ⁿ⁾(a(β) decreases.

Accordingly, in the Taylor expansion of the block diagonal matrix R′⁽ⁿ⁾(a(β), if truncation is performed up to a term of a predetermined degree l=l₀, (l₀+1) terms having a larger influence can be selected, and consequently, the order can be limited to a thickness (width) of 2l₀+1.

Here, an nth-order component of the rotation matrix R′(a(β) corresponding to the block diagonal matrix R′⁽ⁿ⁾(a(β) obtained in a case where the Taylor expansion of the nth-order block diagonal matrix R′⁽ⁿ⁾(a(β) of the rotation matrix R′(a(β) is truncated by terms up to the degree l₀ is described as R₁₀⁽ⁿ⁾(a(β)). That is, the matrix R₁₀⁽ⁿ⁾ (a(β)) that is an nth-order component is a sum of matrices of respective terms from a term of degree 0 to a term of degree l₀.

Furthermore, a matrix of truncation errors between the actual block diagonal matrix R′⁽ⁿ⁾(a(β) and the nth-order component R₁₀⁽ⁿ⁾(a(β) obtained by the Taylor expansion is referred to as an error matrix E_{R}⁽ⁿ⁾.

In order to evaluate the matrix E_{R}⁽ⁿ⁾ of the truncation error, a spectral norm is used. The spectral norm of the predetermined matrix A is defined as represented in following Equation (44), and this spectral norm is the same value as the maximum value of an eigenvalue. This means that an upper limit of the ratio of a norm of an error vector to a norm of a vector of the head-related transfer function (HRTF) of the spherical harmonic domain is given. In addition to the spectral norm, an indication of an error may be analytically given using a Frobenius norm or the like, but only the spectral norm will be described in the present specification.

$$\begin{matrix}[ Equation 44 ] & \\ {‖ A ‖}_{2} = sup \frac{‖ Ax ‖}{{‖ x ‖}_{2}} ( x \neq 0 ) & ( 44 )\end{matrix}$$

Accordingly, if an absolute value of an eigenvalue of the error matrix E_{R}⁽ⁿ⁾ presented in following Equation (45) is calculated, it is expressed as following Equation (46).

$$\begin{matrix}[ Equation 45 ] & \\ {E}_{R}^{( n )} = ( {R}^{′ ( n )} ( a ( β ) ) - {R}_{{l}_{0}}^{( n )} ( a ( β ) ) ) & ( 45 ) \\ [ Equation 46 ] & \\ \vert {e}^{ix} - {\sum }_{l = 0}^{{l}_{0}} \frac{{( ix )}^{l}}{l !} \vert \leq min \{ 2 \frac{\vert {x}^{{l}_{0}} \vert}{{l}_{0} !} , \frac{\vert {x}^{{l}_{0} + 1} \vert}{( {l}_{0} + 1 ) !} \} & ( 46 )\end{matrix}$$

The value illustrated in Equation (46) is an absolute value of a remainder term of the Taylor expansion in a complex exponential function, and a right side of Equation (46) indicates an upper limit thereof. This is described in detail in, for example, “Bobkov, S. G., “Asymptotic Expansions for Products of Characteristic Functions Under Moment Assumptions of Non-integer Orders,” inConvexity and Concentration, pp. 297 to 357, Springer New York, 2017″, and the like.

The spectral norm is obtained from a maximum value (upper limit value) of the absolute values of the eigenvalues of the error matrix E_{R}⁽ⁿ⁾ as represented in following Equation (47).

$$\begin{matrix}[ Equation 47 ] & \\ sup {‖ {E}_{R}^{( n )} ‖}_{2} = sup \sqrt{{λ}_{max} ( {E}_{R}^{( n )} * {E}_{R}^{( n )} )} = \frac{{( n β )}^{{l}_{0} + 1}}{( {l}_{0} + 1 ) !} & ( 47 )\end{matrix}$$

Note that the upper limit is obtained in Equation (47) because the value represented by Equation (46) is uncertain in the derived eigenvalue, and only the upper limit (maximum value) is determined. Furthermore, 2|x¹⁰|/l₀! is selected on the right side of Equation (46) in some cases, but such a case is rare, and thus description is not provided herein.

In order to make the truncation error of the nth-order component R₁₀⁽ⁿ⁾(a(β) indicated by the error matrix E_{R}⁽ⁿ⁾ equal to or less than a predetermined allowable error ε₀ from Equation (47), it is necessary to perform truncation in the degree l₀ of the Taylor expansion satisfying following Equation (48).

$$\begin{matrix}[ Equation 48 ] & \\ \frac{{( n β )}^{{l}_{0} + 1}}{( {l}_{0} + 1 ) !} \leq {ɛ}_{0} ( 0 < {ɛ}_{0} < 1 ) & ( 48 )\end{matrix}$$

Furthermore, by selecting the smallest degree l₀ among the degrees l₀ satisfying Equation (48), the operation amount for the rotation becomes the smallest in the truncation error, that is, the allowable error ε₀.

The allowable error ε₀ in Equation (48) is a ratio of the norm of the error vector to the norm of the vector after rotation, that is, the row vector H′(gₜ⁻¹, ω) or the vector D′(ω) of the input signal.

Incidentally, since the rotation matrix is a unitary matrix (see, for example, “Angular Momentum in Quantum Mechanics (Investigations in Physics) by E. R. Edmonds, 1957”), the norm of the vector after rotation does not change as represented in following Equation (49).

$$\begin{matrix}[ Equation 49 ] & \\ \frac{{‖ {R}^{′} ( g ) {H}^{′} ( ω ) ‖}_{2}}{{‖ {H}^{′} ( ω ) ‖}_{2}} = 1 & ( 49 )\end{matrix}$$

Furthermore, when the norm of an error matrix E_{R}(g) indicating the error of the entire rotation matrix R′(g) is ε, following Equation (50) holds.

$$\begin{matrix}[ Equation 50 ] & \\ {‖ {E}_{R} ( g ) ‖}_{2} = sup \frac{{‖ {E}_{R} ( g ) {H}^{′} ( ω ) ‖}_{2}}{{‖ {H}^{′} ( ω ) ‖}_{2}} = ɛ & ( 50 )\end{matrix}$$

From these Equations (49) and (50), following Equation (51) holds. That is, the norm of the error vector after rotation is equal to or less than ε times the norm of the vector after correct rotation.

[Equation 51]

sup∥E_{R}(g)H′(ω)∥₂=ε∥H′(ω)∥₂=ε∥R′(g)H′(ω)∥₂ (51)

Moreover, the relationship between the error matrix E_{R}⁽ⁿ⁾, that is, the allowable error ε₀ and each of the parameters has become clear from above-described Equation (47). The parameters mentioned here are the degree n, the rotation angle and the degree l₀ of the Taylor expansion.

When three of the four variables of these three parameters and the allowable error ε₀ are determined, the remaining one variable is determined.

First, it can be seen that a value of n in Equation (47) varies for each degree n of the spherical harmonics, that is, each degree n of the spherical harmonic domain.

Furthermore, in a case where the allowable error ε₀ is determined first, a different degree l₀ is obtained for each degree n. On the other hand, in a case where the degree l₀ is set to the same value in all the degrees n, the allowable error ε₀ has a different upper limit for each degree n, and the larger the degree n, the larger the allowable error ε₀. Furthermore, it can also be seen that the larger the rotation angle β, the larger the allowable error ε₀.

Moreover, different values may be specified for these parameters for each time frequency ω. For example, it is also possible to specify the allowable error ε₀ as a function ε₀(ω) of the time frequency ω.

Furthermore, when erroneous rotations are stacked a plurality of times, an error due to the rotation, that is, an error of an approximate rotation matrix with respect to the actual rotation matrix R′(gₜ) is also accumulated. If the matrix including the certain allowable error ε₀ is stacked t times, an upper limit supε of the accumulated error ε is as represented in following Equation (52).

[Equation 52]

supε=(1+ε₀)^{t}−1 (52)

Moreover, in a case where the upper limit of the τ-th error is ε_{τ}, the upper limit supε of the accumulated error up to the τ-th is as represented in following Equation (53).

$$\begin{matrix}[ Equation 53 ] & \\ sup ɛ = [ {\prod }_{τ = 1}^{t} ( 1 + {ɛ}_{τ} ) ] - 1 & ( 53 )\end{matrix}$$

Incidentally, in the sixth method described above, it has been described that the row vector H′(gₜ⁻¹, ω) is calculated by either of a method of stacking minute rotations (hereinafter, also referred to as a minute rotation accumulation method) or a method of constantly rotating the row vector H_{S}(ω) of the head-related transfer function of the spherical harmonic domain before rotation without stacking rotations (hereinafter, also referred to as a non-cumulative rotation method).

That is, in the minute rotation accumulation method, the above-described Equation (41) is calculated to calculate the row vector H′(gₜ⁻¹, ω), and in the non-cumulative rotation method, the above-described Equation (35) or (36) is calculated to calculate the row vector H′(gₜ⁻¹, ω). Similarly, also in the fifth method, the row vector H′(gₜ⁻¹, ω) is calculated by the minute rotation accumulation method.

Accordingly, in the proposed method, for example, in the non-cumulative rotation method, in a case where emphasis is placed on securing a certain or higher quality for the calculated row vector H′(gₜ⁻¹, ω), the allowable error ε₀ is specified, and an appropriate degree l₀ is obtained by calculation from Equation (48) for the rotation angle β=βₜ.

In addition, for example, a table in which the angle β and the degree l₀ are associated with each other may be prepared in advance, and the degree l₀ associated with the angle β=βₜ may be obtained from the table.

Note that in a case where the degree l₀ is obtained for the angle the degree l₀ may be obtained for each degree n of the spherical harmonics, or the common degree l₀ may be obtained for all degrees n.

Since the value of the error sup∥ε⁽ⁿ⁾∥₂ in Equation (47) increases as the degree n increases, it is only required to substitute a value that is the same as or larger than the degree n of each spherical harmonics as the value of the degree n of Equation (48). Here, the value larger than the degree n can be, for example, the maximum degree N of the degree n.

Furthermore, for example, in a case where the obtained degree l₀ is larger than 2n, the value of the constant C may be set as the constant C=2n+1, and in a case where the degree l₀ is 2n or less, the constant C may be set as the constant C=l₀.

Furthermore, a different value may be specified for each time frequency ω as the allowable error co, or whether or not to limit the order k itself may be specified for each time frequency ω. Furthermore, a different value may be specified for each degree n as the allowable error ε₀.

For example, an approximate rotation matrix obtained by limiting the order of the rotation matrix R′(gₜ) may be obtained by the Taylor expansion in which truncation is performed in the degree l₀, or may be obtained using values of elements of the original rotation matrix R′(gₜ) or elements obtained by some method.

Moreover, the proposed method is applicable not only to a case of rotating the row vector H_{S}(ω) in the non-cumulative rotation method, but also to a case of rotating the vector D′(ω) of the input signal.

That is, in the above-described third method, instead of the rotation matrix R′(gⱼ⁻¹), the calculation of Equation (26) may be performed using an approximate rotation matrix obtained by limiting the order k with respect to the rotation matrix R′(gⱼ⁻¹) by the proposed method. In this case, the vector D′(ω) is rotated by the rotation operation based on the approximate rotation matrix.

In addition, for example, in a case where it is desired to keep the operation load in the rotation operation unit 24 or the like constant in the non-cumulative rotation method, the constant C=l₀ may be made constant regardless of the rotation angle βₜ. In this manner, the operation load can be kept constant regardless of the angle β.

At this time, the constant C=l₀ may be set to the same value regardless of the degree n, or may be set to a different value for each degree n.

In this case, an upper limit εₜ of the error varies depending on the angle βₜ, but the system, a user, an operator (engineer) who introduces the system, and the like can successively know the value of the upper limit εₜ by calculating Equation (47).

For example, the value of the upper limit εₜ, which is the maximum error, a graph thereof, and the like may be displayed on a graphical user interface (GUI) and presented to the user or the like, or in a case where an angle βₜ>βₘₐₓ of rotation exceeding a certain error is input, the rotation operation may be performed with the rotation angle set to an angle βₘₐₓ or an angle equal to or less than the angle βₘₐₓ at the expense of localization.

Furthermore, as the angle βₘₐₓ, a different value may be specified for each time frequency ω as a function βₘₐₓ(ω) of the time frequency ω.

Even in a case where the constant C=l₀ is made constant regardless of the rotation angle βₜ in this manner, or the like, the approximate rotation matrix obtained by limiting the order of the rotation matrix R′(gₜ) may be obtained by the Taylor expansion in which truncation is performed in the degree l₀, or may be obtained using values of the elements of the original rotation matrix R′(gₜ) or elements obtained by some method.

In addition, the method of making the constant C=l₀ constant regardless of the rotation angle βₜ is applicable not only to a case of rotating the row vector H_{S}(ω) in the non-cumulative rotation method, but also to a case of rotating the vector D′(ω) of the input signal in the third method.

<Configuration Example of Audio Processing Device>

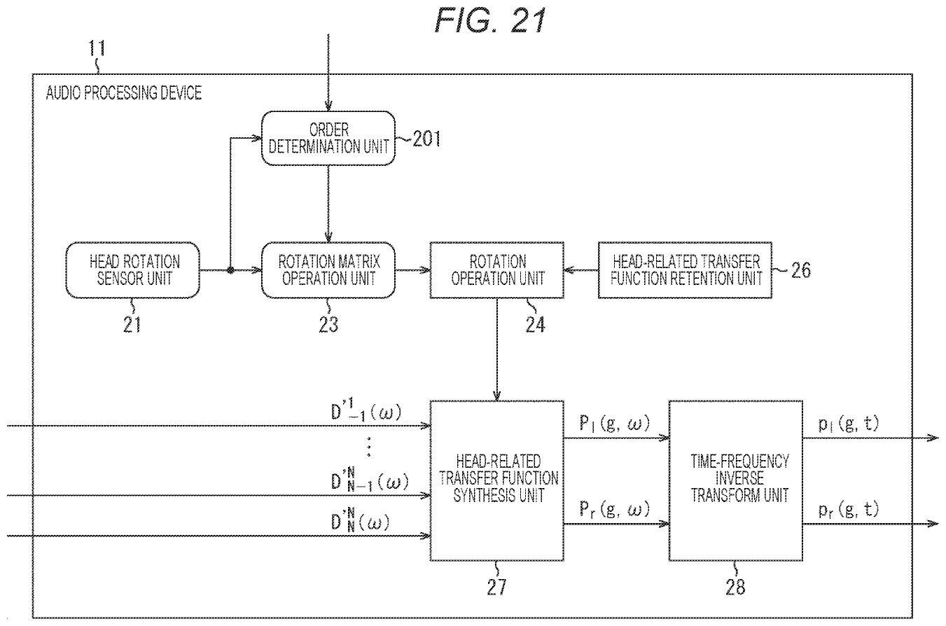

In a case where the above proposed method is employed, the audio processing device 11 is configured as illustrated in FIG. 21, for example. Note that, in FIG. 21, parts corresponding to those in the case of FIG. 11 are denoted by the same reference numerals, and the description thereof will be omitted as appropriate.

The audio processing device 11 illustrated in FIG. 21 includes a head rotation sensor unit 21, an order determination unit 201, a rotation matrix operation unit 23, a rotation operation unit 24, a head-related transfer function retention unit 26, a head-related transfer function synthesis unit 27, and a time-frequency inverse transform unit 28.

The configuration of the audio processing device 11 illustrated in FIG. 21 is different from the configuration of the audio processing device 11 illustrated in FIG. 11 in that the previous direction retention unit 22 and the rotation coefficient retention unit 25 are not provided, and the order determination unit 201 is newly provided, and has the same configuration as the audio processing device 11 in FIG. 11 in other points.

The order determination unit 201 is supplied with specification information indicating the allowable error ε₀ specified by the user or the like, the operation load, and the like, and is supplied with the head rotation information from the head rotation sensor unit 21. It can also be said that the allowable error ε₀ is an allowable error between the rotation matrix R′(gₜ) and the approximate rotation matrix obtained by limiting the order of the rotation matrix R′(gₜ).

The order determination unit 201 determines the order k to limit the rotation operation on the basis of the supplied specification information and the head rotation information supplied from the head rotation sensor unit 21, and supplies a determination result thereof to the rotation matrix operation unit 23.

The rotation matrix operation unit 23 obtains an approximate rotation matrix of the rotation matrix R′(gₜ) on the basis of the head rotation information supplied from the head rotation sensor unit 21 and the determination result of the order k supplied from the order determination unit 201, and supplies the approximate rotation matrix to the rotation operation unit 24.

<Description of Drive Signal Generation Processing>

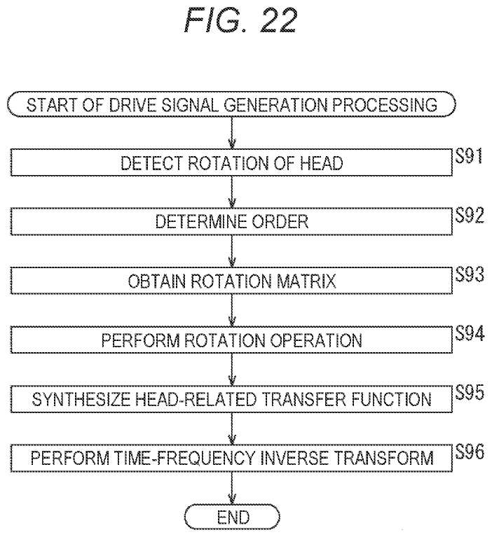

Next, drive signal generation processing performed by the audio processing device 11 illustrated in FIG. 21 will be described with reference to a flowchart in FIG. 22.

Note that the processing in step S91 is similar to the processing in step S11 in FIG. 13, and thus the description thereof will be omitted.

In step S92, the order determination unit 201 determines the order k to limit the rotation operation on the basis of the supplied specification information and the head rotation information supplied from the head rotation sensor unit 21, and supplies a determination result thereof to the rotation matrix operation unit 23.

For example, in a case where information indicating the allowable error ε₀ is supplied as the specification information, the order determination unit 201 obtains the minimum degree l₀ that satisfies Equation (48) for each degree n by calculation on the basis of the allowable error ε₀ and the rotation angle βₜ indicated by the head rotation information.

Note that as described above, the degree l₀ may be obtained from a table or the like prepared in advance, and the degree l₀ may be a common value in all the degrees n.

When the degree l₀ is obtained, the order determination unit 201 determines the constant C on the basis of the degree l₀ and the degree n. Specifically, for example, the order determination unit 201 determines the order k by setting the constant C=2n+1 in a case where l₀>2n and setting the constant C=l₀ in a case where l₀≤2n.

In other words, the order determination unit 201 determines the order k by setting the allowable error ε₀ on the basis of the specification information. Setting the allowable error CO in this manner can also be said to be setting an allowable value of an error of the rotation operation by the approximate rotation matrix of the rotation matrix R′(gₜ) with respect to the rotation operation by the rotation matrix R′(gₜ), that is, an allowable value of the error of the rotation operation corresponding to the allowable error ε₀.

The order k thus determined is for limiting the operation amount of the rotation operation regarding the rotation matrix R′(gₜ) corresponding to the rotation of the head of the listener. In this case, in the rotation operation, for each degree n, only the maximum of (2C+1) elements whose orders are within the range from the order k=m−C to the order k=m+C and within the range from −n to n are used. That is, the operation is performed only for the maximum of (2C+1) elements whose order is within the predetermined range, and consequently, the rotation operation in which the rotation matrix R′(gₜ) is limited by the order k is performed.

Furthermore, for example, in a case where information indicating the operation load is supplied as the specification information, the order determination unit 201 sets the degree l₀ determined for the operation load as the value of the constant C. In other words, the order determination unit 201 determines the order k by setting the upper limit of the operation load, that is, the operation amount of the rotation operation using the approximate rotation matrix on the basis of the specification information.

In this case, the constant C=l₀ is a constant value regardless of the angle βₜ, and the constant C=l₀ may be determined for each degree n or may be common to all degrees n.

In step S93, the rotation matrix operation unit 23 obtains the approximate rotation matrix of the rotation matrix R′(gₜ) on the basis of the head rotation information supplied from the head rotation sensor unit 21 and the order k supplied from the order determination unit 201, and supplies the obtained approximate rotation matrix to the rotation operation unit 24.

For example, the rotation matrix operation unit 23 obtains the rotation matrix R′(gₜ) on the basis of the head rotation information, and extracts a part of the elements of the rotation matrix R′(gₜ) to obtain the approximate rotation matrix of the rotation matrix R′(gₜ).

Specifically, for example, the rotation matrix operation unit 23 extracts the maximum of (2C+1) elements within the range from the order k=m−C to the order k=m+C and from −n to n determined for each degree n in step S92 from each nth-order block diagonal matrix constituting the rotation matrix R′(gₜ).

Then, the rotation matrix operation unit 23 uses the extracted elements as they are as corresponding elements of the approximate rotation matrix and sets the values of other elements to zero, to thereby generate the approximate rotation matrix of the rotation matrix R′(gₜ). Note that instead of using the extracted element as it is, a value or the like obtained from the extracted element and another value may be used as an element of the approximate rotation matrix.

In addition, the rotation matrix operation unit 23 may obtain the approximate rotation matrix of the rotation matrix R′(gₜ) by actually performing the Taylor expansion to the degree l₀ of the block diagonal matrix (nth-order component) of each degree n constituting the rotation matrix R′(gₜ).

In this case, for example, if the degree l₀ is common in each degree n, the rotation matrix R′(gₜ) is represented by the sum of matrices corresponding to terms of each degree l of the Taylor expansion, and the sum of the matrices of each order from the degree 0 to the degree l₀ among a plurality of the matrices is the approximate rotation matrix of the rotation matrix R′(gₜ). Note that in a case of generating the approximate rotation matrix of the rotation matrix R′(gₜ), an approximate rotation matrix of the rotation matrix R′(a(βₜ)), the rotation matrix R′(u(αₜ)), and the rotation matrix R′(u(γₜ)) may be synthesized.

When the approximate rotation matrix is obtained in this manner, the processing of steps S94 to S96 is subsequently performed and the drive signal generation processing ends, but since the processing of these steps is similar to the processing of steps S16 to S18 of FIG. 13, the description thereof will be omitted.

However, in step S94, a calculation similar to Equation (36) is performed on the row vector H_{S}(ω) by using the approximate rotation matrix obtained in step S93, and the head-related transfer function is rotated in the spherical harmonic domain. Consequently, a rotation operation limited by the order k by the rotation matrix R′(gₜ) is achieved.

Note that the rotation matrix R′(gₜ) may be generated in step S93, and the rotation operation may be performed using only elements whose orders are within the range from the order k=m−C to the order k=m+C and from −n to n in the rotation matrix R′(gₜ) in step S94. Also in this manner, the rotation operation limited by the order k can be achieved.

As described above, the audio processing device 11 generates the approximate rotation matrix of the rotation matrix R′(gₜ), and obtains the row vector H′(gₜ⁻¹, ω) after rotation on the basis of the approximate rotation matrix and the row vector H_{S}(ω). In this manner, in the proposed method, the error included in the row vector H′(gₜ⁻¹, ω) can be suppressed within an allowable range, and the sound can be reproduced with sufficient quality and more efficiently.

Note that the proposed method as described above can also be applied to a case where the rotation operation unit 24 of the audio processing device 11 having the configuration illustrated in FIG. 11 calculates the row vector H′(gₜ⁻¹, ω) on the basis of the row vector H_{S} (ω) and the rotation matrix R′(gₜ) in a state where there is no row vector H′(gₜ₋₁⁻¹, ω).

### Fourth Embodiment

<Application to Minute Rotation Accumulation Method>

Meanwhile, the above-described proposed method can also be applied to the minute rotation accumulation method.

For example, when real-time followability is emphasized in the minute rotation accumulation method, the allowable error ε₀ is specified, and an appropriate degree l₀ can be obtained by calculation from Equation (48) with respect to the difference Δβₜ of the rotation angle. In addition, for example, a table in which the difference Δβₜ and the degree l₀ are associated with each other may be prepared in advance, and the degree l₀ associated with the difference Δβₜ may be obtained from the table.

Also in this case, the degree l₀ may be obtained for each degree n of the spherical harmonics, or the common degree l₀ may be obtained for all degrees n.

Since the value of the error of Equation (47) increases as the degree n increases, it is only required to substitute a value that is the same as or larger than the degree n of each spherical harmonics as the value of the degree n of Equation (48). Here, the value larger than the degree n can be, for example, the maximum degree N of the degree n.

For example, in a case where the obtained degree l₀ is larger than 2n, the value of the constant C may be set as the constant C=2n+1, and in a case where the degree l₀ is 2n or less, the constant C may be set as the constant C=l₀.

Furthermore, a different value of the allowable error ε₀ may be specified for each time frequency ω, or whether or not to limit the order k itself may be specified for each time frequency ω.

For example, the approximate rotation matrix obtained by limiting the rotation matrix R′(Δgₜ) by the order k may be obtained by the Taylor expansion in which truncation is performed in the degree l₀, or may be obtained using values of the elements of the original rotation matrix R′(Δgₜ) or elements obtained by some method.

In addition, the upper limit ε of the accumulated error at the time of the t-th rotation in the minute rotation accumulation method can be obtained by calculating the above-described Equation (52).

Accordingly, for example, in a case where the proposed method is applied to the sixth method, the reset trigger may be turned on in a case where the upper limit supε of the accumulated error ε obtained by the calculation of Equation (52) exceeds a predetermined allowable error εₘₐₓ. Note that the allowable error εₘₐₓ may be a value different for each time frequency ω, or may be a constant value regardless of the time frequency ω.

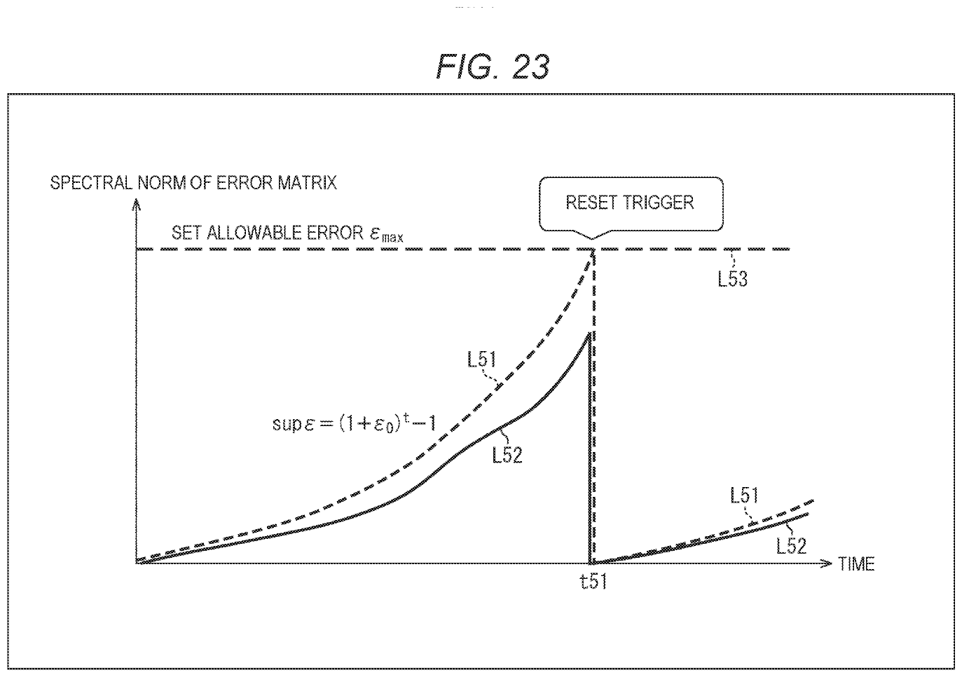

FIG. 23 illustrates a temporal transition of the accumulated error s. Note that in FIG. 23, the vertical axis represents a spectral norm of the error matrix, and the horizontal axis represents the time.

In FIG. 23, a curve L51 indicates an upper limit supε of the accumulated error ε represented in Equation (52) at each time, a curve L52 indicates an actual accumulated error at each time, and a straight line L53 indicates the set allowable error εₘₐₓ.

The actual accumulated error indicated by the curve L52 does not exceed the upper limit of the accumulated error s, but the accumulated error increases every time minute rotations are stacked. Accordingly, in this example, the reset trigger is turned on at the timing of time t51 when the upper limit supε of the accumulated error ε exceeds the allowable error εₘₐₓ.

Moreover, for example, in the minute rotation accumulation method, when emphasis is placed on keeping the operation load constant, the allowable error ε₀ and the upper limit of the constant C=l₀ that determines a thickness (effective element width) of diagonal components of the rotation matrix R′(Δgₜ) may be specified, and the smaller one of the maximum angle β satisfying Equation (48) and the difference Δβₜ of the rotation angle may be set as the angle used for the rotation matrix R′(Δgₜ).

In this case, for example, when the difference Δβₜ is smaller than the maximum angle β satisfying Equation (48), the value of the constant C to be actually used may be set to a smaller value within the range of the allowable error ε₀, that is, within the range satisfying Equation (48).

Furthermore, in a case where the difference Δβₜ is larger than the maximum angle β that satisfies Equation (48), the row vector H′(gₜ⁻¹, ω) obtained by the rotation operation is unable to follow the actual rotation of the head of the listener (user), and the rotation is delayed. However, in the subsequent processing, it is only required to determine the angle used for the rotation matrix R′(Δgₜ), that is, the difference Δβₜ so that the delay of the rotation is eliminated.

As described above, in a case where the upper limit is set for the constant C=l₀, the thickness (width) of the diagonal component of the rotation matrix R′(Δgₜ) is equal to or less than a certain value, and thus the operation load in the rotation operation or the like by the rotation operation unit 24 can also be equal to or less than a certain load. That is, the upper limit of the operation amount in the rotation operation can be set by setting the upper limit of the constant C=l₀.

Therefore, in a case where there is a plurality of listeners, for example, the rotation operation unit 24 can perform the rotation operation in order from the listener with the smaller difference Δβₜ. In this manner, when there is a reserve capacity (margin) in the operation load, the constant C=l₀ can be made larger than those in cases of other listeners in the rotation operation for the listener with the large difference Δβₜ.

Furthermore, the error value of Equation (47) increases as the degree n increases. Thus, even in a case where an upper limit is set for the constant C, it is only required to substitute a value that is the same as or larger than the degree n of each spherical harmonics as the value of the degree n of Equation (48).

Moreover, even in an example in which an upper limit is provided for the constant C, a different value of the allowable error ε₀ may be specified for each time frequency ω, or whether or not to limit the order k itself may be specified for each time frequency ω.

In addition, for example, the approximate rotation matrix obtained by limiting the rotation matrix R′(Δgₜ) by the order k may be obtained by the Taylor expansion in which truncation is performed in the degree l₀, or may be obtained using values of the elements of the original rotation matrix R′(Δgₜ) or elements obtained by some method.

Furthermore, also in this example, since the upper limit supε of the accumulated error at the time of the t-th rotation can be obtained by calculating the above-described Equation (52), the reset trigger may be turned on in a case where the upper limit supε of the accumulated error obtained by the calculation of Equation (52) exceeds the predetermined allowable error εₘₐₓ. Even in such a case, the upper limit supε of the accumulated error and the actual accumulated error change as illustrated in FIG. 23. Note that also in this case, the allowable error εₘₐₓ may be a value different for each time frequency ω, or may be a constant value regardless of the time frequency ω.

Furthermore, in the minute rotation accumulation method, in a case where real-time followability is emphasized while maintaining a constant operation load, the degree l₀ or the constant C may be made constant regardless of the rotation angle, that is, the difference Δβₜ.

In this case, the upper limit εₜ of the error caused by one rotation varies depending on the difference Δβₜ, but the system, the user, the operator, and the like can successively know the value of the upper limit εₜ by calculating Equation (47). Furthermore, for example, the upper limit supε of the accumulated error can be known by calculating Equation (53).

For example, the value of the upper limit εₜ of the error, the upper limit supε of the accumulated error, and the like may be displayed on a GUI and presented to the user or the like, or the reset trigger may be turned on in a case where the upper limit supε of the accumulated error exceeds the predetermined allowable error εₘₐₓ. Note that a different value εₘₐₓ(ω) may be specified for each time frequency ω as the value of the allowable error εₘₐₓ.

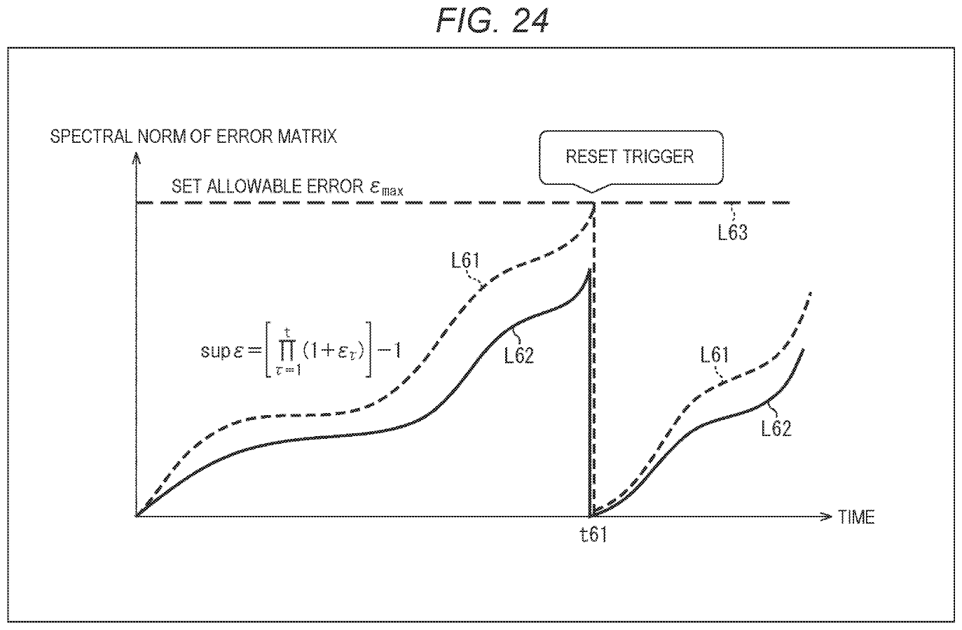

FIG. 24 illustrates a temporal transition of the upper limit εₜ of the accumulated error. Note that in FIG. 24, the vertical axis represents a spectral norm of the error matrix, and the horizontal axis represents the time.

In FIG. 24, a curve L61 indicates the upper limit supε of the accumulated error represented in Equation (53) at each time, a curve L62 indicates an actual accumulated error at each time, and a straight line L63 indicates the set allowable error εₘₐₓ.

Also in the example illustrated in FIG. 24, similarly to the example illustrated in FIG. 23, both of the upper limit sups of the accumulated error indicated by the curve L61 and the actual accumulated error indicated by the curve L62 increase with time, but the actual accumulated error does not exceed the upper limit supε of the accumulated error.

In particular, in the example illustrated in FIG. 24, the upper limit εₜ of the error changes depending on the magnitude of the difference Δβₜ at each time. Thus, the values indicated by the curve L61 and the curve L62 irregularly rise, but since the upper limit supε of the accumulated error can be obtained by Equation (53), the reset can be appropriately performed. Also in the example illustrated in FIG. 24, the reset trigger is turned on at the timing of time t61 when the upper limit supε of the accumulated error exceeds the allowable error εₘₐₓ

<Configuration Example of Audio Processing Device>

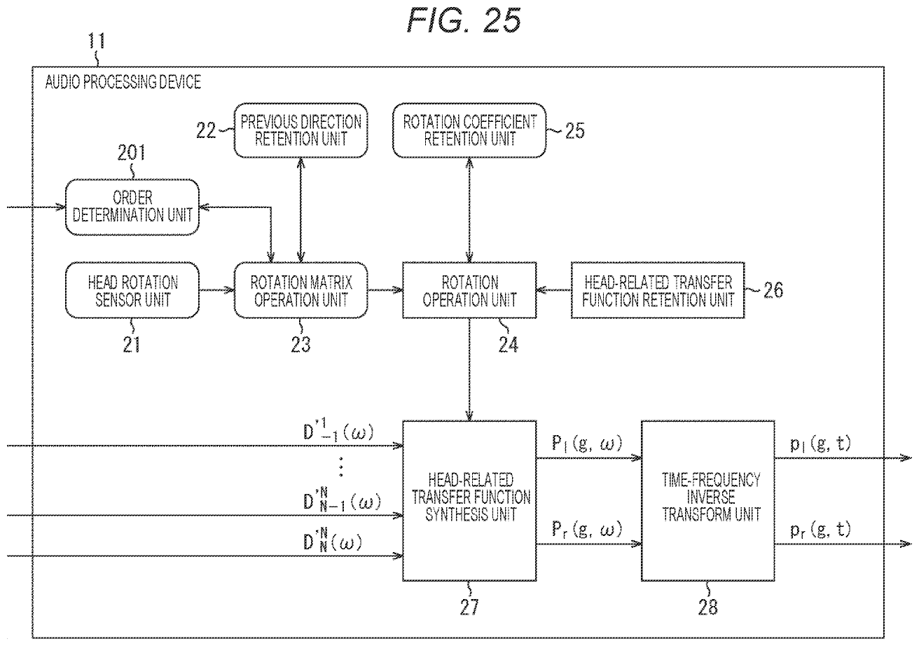

In a case where the proposed method is applied to the minute rotation accumulation method as described above, an audio processing device 11 is configured as illustrated in FIG. 25, for example. Note that, in FIG. 25, parts corresponding to those in FIG. 11 or 21 are denoted by the same reference numerals, and the description thereof will be omitted as appropriate.

The audio processing device 11 illustrated in FIG. 25 includes a head rotation sensor unit 21, an order determination unit 201, a previous direction retention unit 22, a rotation matrix operation unit 23, a rotation operation unit 24, a rotation coefficient retention unit 25, a head-related transfer function retention unit 26, a head-related transfer function synthesis unit 27, and a time-frequency inverse transform unit 28.

The configuration of the audio processing device 11 illustrated in FIG. 25 is different from the configuration of the audio processing device 11 illustrated in FIG. 11 in that the order determination unit 201 is newly provided, and has the same configuration as the audio processing device 11 in FIG. 11 in other points.

The order determination unit 201 determines the order k to limit the rotation operation on the basis of the supplied specification information and the difference Δβₜ supplied from the rotation matrix operation unit 23, and supplies a determination result thereof to the rotation matrix operation unit 23.

The rotation matrix operation unit 23 obtains an approximate rotation matrix of the rotation matrix R′(Δgₜ) on the basis of the head rotation information supplied from the head rotation sensor unit 21, the previous direction information supplied from the previous direction retention unit 22, and the determination result of the order k supplied from the order determination unit 201, and supplies the approximate rotation matrix to the rotation operation unit 24.

<Description of Drive Signal Generation Processing>

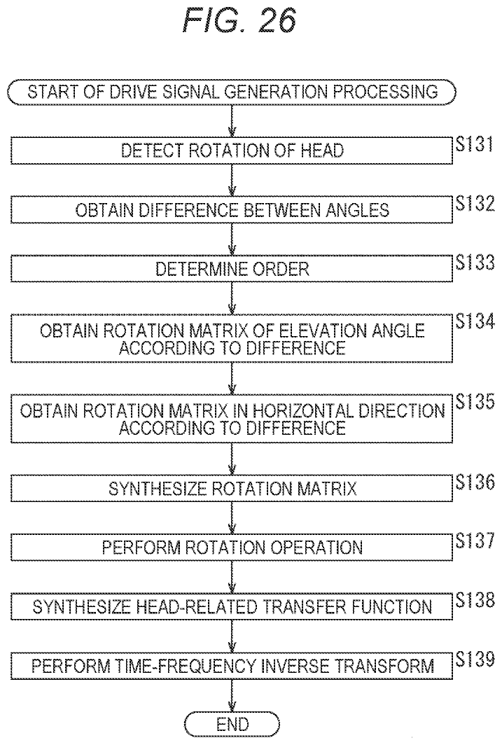

Next, drive signal generation processing performed by the audio processing device 11 illustrated in FIG. 25 will be described with reference to a flowchart in FIG. 26.

Note that processing of steps S131 and S132 is similar to the processing of steps S11 and S12 in FIG. 13, and thus the description thereof will be omitted.

However, in step S132, the difference Δβₜ of the obtained difference Δgₜ is supplied from the rotation matrix operation unit 23 to the order determination unit 201.

In step S133, the order determination unit 201 determines the order k to limit the rotation operation on the basis of the supplied specification information and the difference Δβₜ supplied from the rotation matrix operation unit 23, and supplies a determination result thereof to the rotation matrix operation unit 23.

For example, in a case where information indicating the allowable error ε₀ is supplied as the specification information, the order determination unit 201 obtains the minimum degree l₀ that satisfies Equation (48) for each degree n by calculation on the basis of the allowable error ε₀ and the difference Δβₜ. At this time, the difference Δβₜ is used as the angle β in Equation (48) to determine the degree l₀.

Note that as described above, the degree l₀ may be obtained from a table or the like prepared in advance, and the degree l₀ may be a common value in all the degrees n.

When the degree l₀ is obtained, the order determination unit 201 determines the constant C on the basis of the degree l₀ and the degree n. Specifically, for example, the order determination unit 201 determines the order k by setting the constant C=2n+1 in a case where l₀>2n and setting the constant C=l₀ in a case where l₀ 2n. In this manner, the order determination unit 201 determines the order k by setting the allowable error ε₀ on the basis of the specification information.

As in the case of the third embodiment, the order k determined in this manner is for limiting the operation amount of the rotation operation regarding the rotation matrix R′(a(Δβₜ)) corresponding to the rotation of the head of the listener in the elevation angle direction. In this case, at least in the elevation angle direction, only the maximum of (2C+1) elements whose orders are within the range from the order k=m−C to the order k=m+C and from −n to n are used in each degree n, and the rotation operation in which the rotation matrix R′(a(Δβₜ)) is limited by the order k is performed.

Furthermore, for example, in a case where information indicating the operation load, that is, information indicating an upper limit value of the constant C=l₀ that determines the upper limit of the operation amount of the rotation operation and the allowable error ε₀ is supplied as the specification information, the order determination unit 201 obtains the maximum angle β that satisfies Equation (48) from the upper limit value of the constant C=l₀ and the allowable error co.

Then, the order determination unit 201 compares the obtained angle β with the difference Δβₜ actually obtained from the head rotation information and the previous direction information, and supplies a smaller one of them to the rotation matrix operation unit 23 as a final difference Δβₜ. Furthermore, the order determination unit 201 determines the order determined with respect to the upper limit value of the constant C=l₀ indicated by the specification information as the order k to limit the rotation operation, and also supplies a determination result thereof to the rotation matrix operation unit 23.

Moreover, for example, in a case where a value of the degree l₀ or the constant C is determined to be a constant value regardless of the angle βₜ, the order determination unit 201 determines the order determined for the value of the degree l₀ or the constant C as the order k to limit the rotation operation.

In step S134, the rotation matrix operation unit 23 obtains an approximate rotation matrix Rs′(a(Δβₜ)) of the rotation matrix R′(a (Δβₜ)) in the elevation angle direction according to the difference Δβₜ on the basis of the difference Δgₜ obtained in step S132 and the order k supplied from the order determination unit 201.

For example, the rotation matrix operation unit 23 obtains the rotation matrix R′(a(Δβₜ)) on the basis of the table retained in advance and the difference Δβₜ, and extracts the maximum of (2C+1) elements within the range from the order k=m−C to the order k=m+C and from −n to n determined for each degree n in step S133 from each nth-order block diagonal matrix constituting the rotation matrix R′(a(Δβₜ)).

Then, the rotation matrix operation unit 23 uses the extracted elements as they are as corresponding elements of the approximate rotation matrix Rs′(a(Δβₜ)) and sets the values of the other elements to zero, to thereby obtain the approximate rotation matrix Rs′(a(Δβₜ)). Note that instead of using the extracted elements as they are, values or the like obtained from the extracted elements and other values may be used as elements of the approximate rotation matrix Rs′(a(Δβₜ)).

In addition, the rotation matrix operation unit 23 may obtain the approximate rotation matrix Rs′(a(Δβₜ)) by actually performing the Taylor expansion to the degree l₀ of the block diagonal matrix (nth-order component) of each degree n constituting the rotation matrix R′(a(Δβₜ)).

In this case, for example, when the degree l₀ is common in each degree n, the rotation matrix R′(a(Δβₜ)) is represented by the sum of matrices corresponding to the terms of each degree l of the Taylor expansion, and the sum of the matrices of each order from the degree 0 to the degree l₀ among the plurality of matrices is set as the approximate rotation matrix Rs′(a(Δβₜ)).

Note that in a case where the final difference Δβₜ is supplied from the order determination unit 201 to the rotation matrix operation unit 23, the rotation matrix operation unit 23 obtains the approximate rotation matrix Rs′(a(Δβₜ)) using the difference Δβₜ.

When the approximate rotation matrix Rs′(a(Δβₜ)) is obtained in this manner, the processing of steps S135 to S139 is subsequently performed and the drive signal generation processing ends, but since the processing of these steps is similar to the processing of steps S14 to S18 of FIG. 13, the description thereof will be omitted.

However, in step S136, the approximate rotation matrix Rs′(a(Δβₜ)) obtained in step S134 is synthesized with the rotation matrix R′(u(Δαₜ)) and the rotation matrix R′(u(Δγₜ)) obtained in step S135 to obtain the rotation matrix R′(Δgₜ).

In the rotation operation using the rotation matrix R′(Δgₜ) obtained in this manner, the rotation operation, that is, the operation amount is limited by the order k. In this case, in the rotation operation, only the maximum of (2C+1) elements whose order is within the range from the order k=m−C to order k=m+C and from −n to n are used.

As described above, the audio processing device 11 obtains the rotation matrix R′(Δgₜ) using the approximate rotation matrix Rs′(a(Δβₜ)), and obtains the current row vector H′(gₜ⁻¹, ω) on the basis of the rotation matrix R′(Δgₜ) and the previous row vector H′(gₜ₋₁⁻¹, ω). In this manner, in the proposed method, the error included in the row vector H′(gₜ⁻¹, ω) can be suppressed within an allowable range, and the sound can be reproduced with sufficient quality and more efficiently.

### Modification Example 1 of Fourth Embodiment

<Configuration Example of Audio Processing Device>

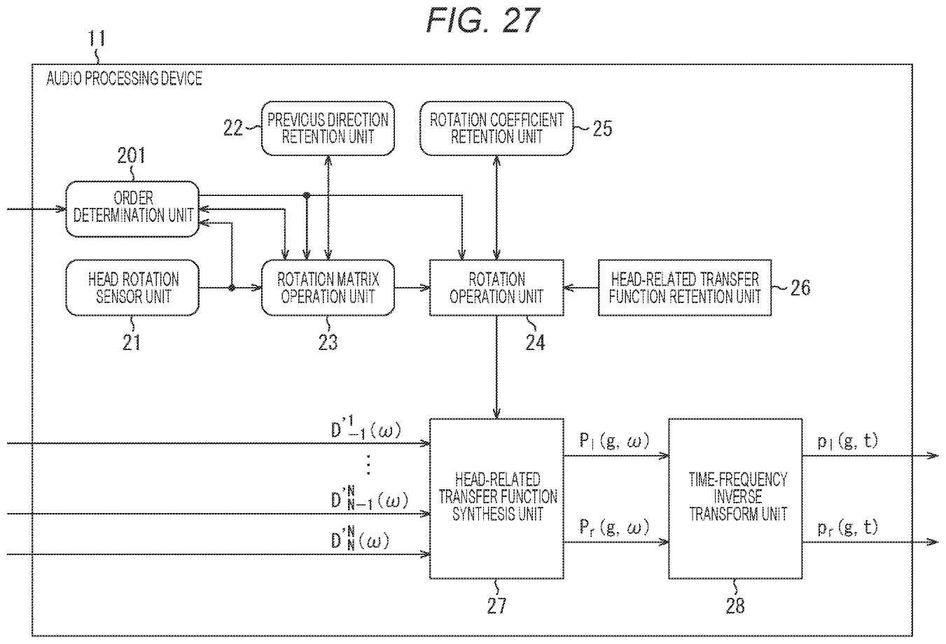

In a case where the proposed method is applied to the minute rotation accumulation method as described above, the configuration of the audio processing device 11 is not limited to the configuration illustrated in FIG. 25, and can be the configuration illustrated in FIG. 27. Note that, in FIG. 27, parts corresponding to those in FIG. 14 or 25 are denoted by the same reference numerals, and the description thereof will be omitted as appropriate.

The audio processing device 11 illustrated in FIG. 27 includes a head rotation sensor unit 21, an order determination unit 201, a previous direction retention unit 22, a rotation matrix operation unit 23, a rotation operation unit 24, a rotation coefficient retention unit 25, a head-related transfer function retention unit 26, a head-related transfer function synthesis unit 27, and a time-frequency inverse transform unit 28.

The audio processing device 11 illustrated in FIG. 27 is different from the audio processing device 11 of FIG. 14 in that the order determination unit 201 is newly provided and a reset trigger is supplied from the order determination unit 201 to the rotation matrix operation unit 23 and the rotation operation unit 24, and has the same configuration as the audio processing device 11 of FIG. 14 in other points.

In the example illustrated in FIG. 27, the order determination unit 201 determines the order k to limit the rotation operation on the basis of the difference Δβₜ supplied from the rotation matrix operation unit 23 or the head rotation information supplied from the head rotation sensor unit 21 and the supplied specification information, and supplies a determination result thereof to the rotation matrix operation unit 23. Furthermore, the order determination unit 201 appropriately generates a reset trigger and supplies the reset trigger to the rotation matrix operation unit 23 and the rotation operation unit 24.

<Description of Drive Signal Generation Processing>

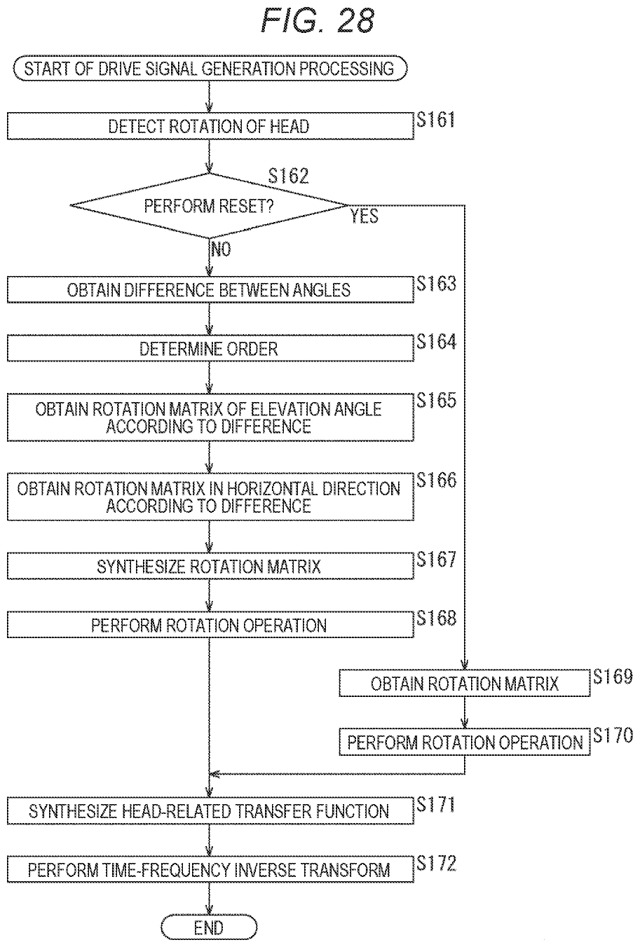

Next, drive signal generation processing performed by the audio processing device 11 illustrated in FIG. 27 will be described with reference to a flowchart in FIG. 28.

Note that the processing in step S161 is similar to the processing in step S131 in FIG. 26, and thus the description thereof will be omitted. However, in step S161, the head rotation information obtained by the head rotation sensor unit 21 is supplied not only to the rotation matrix operation unit 23 but also to the order determination unit 201.

In step S162, the order determination unit 201 determines whether or not to perform reset on the basis of the allowable error ε₀ or the like indicated by the supplied specification information and the predetermined allowable error εₘₐₓ.

For example, the order determination unit 201 calculates Equation (52) or (53) on the basis of the allowable error ε₀ or the like to obtain the upper limit of accumulation of the allowable value of the error of the rotation operation corresponding to the upper limit supε of the accumulated error, in other words, the allowable error ε₀ or the like, and determines to perform the reset in a case where the obtained upper limit supε of the accumulated error is larger than the allowable error εₘₐₓ. Note that this reset may be performed for each degree n, order m, or time frequency ω, or in a case where the drive signal is generated for each of a plurality of listeners, the reset may be performed for each listener.

In a case where it is determined in step S162 not to perform the reset, the order determination unit 201 turns off the reset trigger supplied to the rotation matrix operation unit 23 and the rotation operation unit 24, and subsequently, the processing of steps S163 to S168 is performed.

Note that the processing of these steps S163 to S168 is similar to the processing of steps S132 to S137 in FIG. 26, and thus the description thereof will be omitted.

On the other hand, in a case where it is determined in step S162 to perform the reset, the order determination unit 201 turns on the reset trigger supplied to the rotation matrix operation unit 23 and the rotation operation unit 24, and subsequently, the processing of steps S169 and S170 is performed.

Note that the processing of these steps S169 and S170 is similar to the processing of steps S58 and S59 in FIG. 15, and thus the description thereof will be omitted. In addition, in a case where the reset is performed, the processing of steps S92 to S94 of FIG. 22 may be performed instead of the processing of steps S169 and S170.

Furthermore, when the processing of step S168 or step S170 is performed, the processing of steps S171 and S172 is subsequently performed and the drive signal generation processing ends, but since the processing of these steps is similar to the processing of steps S138 and S139 of FIG. 26, the description thereof will be omitted.

As described above, the audio processing device 11 obtains the row vector H′(gₜ⁻¹, ω) using the approximate rotation matrix Rs′(a(Δβₜ)) while the accumulated error is small, and obtains the accurate rotation matrix R′(gₜ) and row vector H′(gₜ⁻¹, ω) to generate the drive signal when the reset trigger is turned on. In this manner, an error included in the row vector H′(gₜ⁻¹, ω) can be suppressed within an allowable range, and sound can be reproduced with sufficient quality and more efficiently.

### Other Modification Example 1

<Allowable Error for Each Time Frequency>

As described above, the allowable error ε₀ and the allowable error εₘₐₓ may be determined for each time frequency ω. That is, the order k may be determined for each time frequency ω.

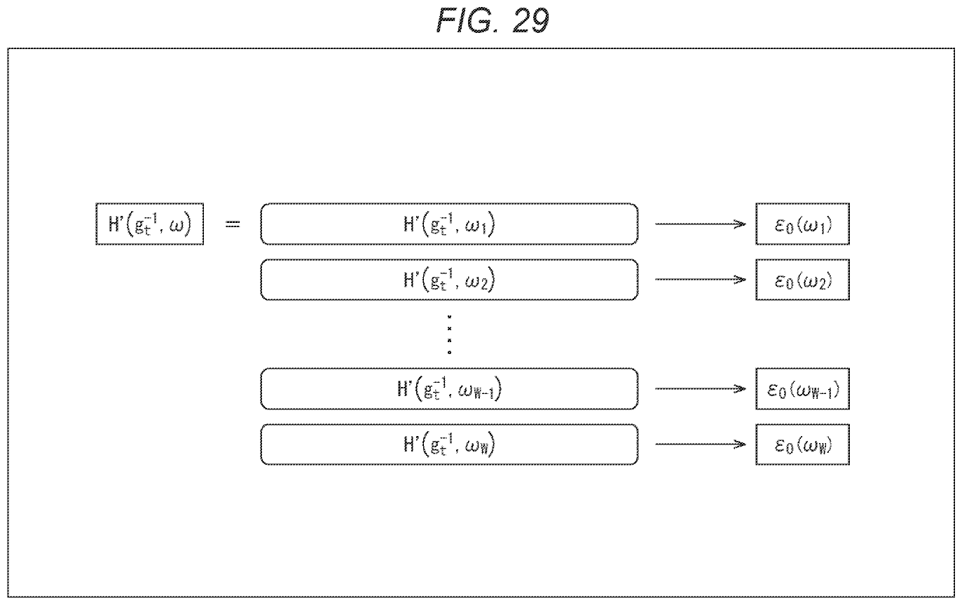

For example, as illustrated in FIG. 29, it is assumed that the number of time-frequency bins ω is W, and the row vector H′(gₜ⁻¹, ω) is obtained for W time-frequencies ω₁ to ω_{W}. That is, it is assumed that row vectors H′(gₜ⁻¹, ω₁) to H′(gₜ⁻¹, ω_{W}) are obtained.

In such a case, the allowable errors ε₀(ω₁) to ε₀(ω_{W}) corresponding to the allowable error ε₀ can be determined for each of the time frequencies ω₁ to ω_{W}.

Note that, in a case where the allowable error ε₀ is determined for each time frequency ω, for example, a small allowable error ε₀ can be set for a band (time frequency ω) that is important for up-down or front-rear sound image localization, and conversely, a large allowable error ε₀ can be set for a band (time frequency ω) that is relatively not important.

Specifically, for example, a small allowable error ε₀ can be set for the time frequency ω corresponding to a band of 5 kHz to 13 kHz or the like, and a large allowable error ε₀ can be set for the time frequency ω corresponding to a band of 16 kHz or more. In this manner, it is possible to generate a drive signal better in terms of audibility even with the same operation amount.

Furthermore, the allowable error ε₀(ω) for each time frequency ω may be set from the matrix H(ω) including the head-related transfer function in the time-frequency domain, the matrix H′(ω) including the head-related transfer function in the spherical harmonic domain, or the like, instead of the above-described prerequisite knowledge.

In such a case, for example, it is conceivable to calculate in advance a norm of the matrix H′(ω), that is, the row vector H′(gₜ⁻¹, ω), and set a large allowable error ε₀ for a time frequency ω with a small value of the obtained norm, and conversely, a small allowable error ε₀ for a time frequency ω with a large norm.

In this manner, it can be expected that the error represented in Equation (47) becomes smaller in a band (time frequency ω) where the signal is larger, and the error in the entire signal becomes small. This is effective in a case where a head-related transfer function (HRTF) is optimized and applied to an individual, or the like.

Moreover, in a case where the allowable error ε₀ or the allowable error εₘₐₓ is determined for each time frequency ω, a method of setting the allowable error ε₀ or the allowable error εₘₐₓ according to the degree of importance of the band with respect to the up-down or front-rear sound image localization described above and a method of setting the allowable error ε₀ or the allowable error εₘₐₓ according to a norm of the row vector H′(gₜ⁻¹, ω) may be combined.

### Other Modification Example 2

<Allowable Error for Each Degree n>

In addition, as described above, the allowable error ε₀ (hereinafter, it is also referred to as an allowable error εₙ) may be determined for each degree n of the spherical harmonics.

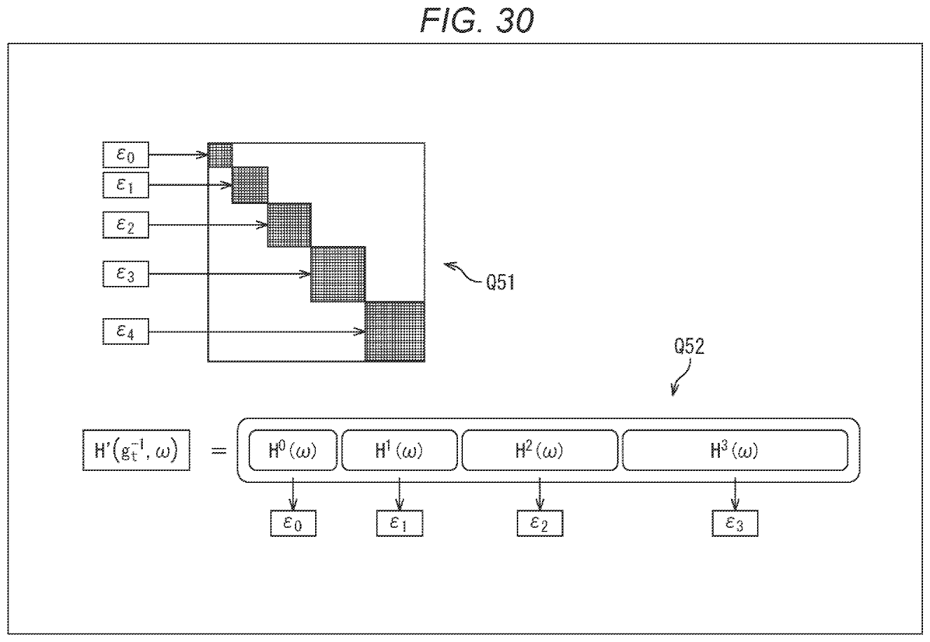

That is, for example, as indicated by an arrow Q51 in FIG. 30, it is assumed that the rotation matrix R′(gₜ) and the rotation matrix R′(Δgₜ) have components of blocks up to the degree n=4. In such a case, it is conceivable to set each of the allowable error ε₀ to the allowable error ε₄ for each of the degrees n=0 to n=4.

In particular, the head-related transfer function in the spherical harmonic domain tends to have a smaller coefficient as the head-related transfer function becomes higher. Accordingly, using such a tendency, a large allowable error εₙ may be set in a higher order, that is, a large degree n, and a small allowable error εₙ may be set in a lower order, that is, a small degree n, so that the error of the entire signal can be reduced.

Furthermore, the tendency of the head-related transfer function in the spherical harmonic domain may be obtained in advance by calculation from the matrix H′(ω), that is, the row vector H′(gₜ⁻¹, ω), and the allowable error εₙ of each degree n may be set on the basis of a calculation result thereof.

For example, as indicated by an arrow Q52 in FIG. 30, it is assumed that a row vector H′(gₜ⁻¹, ω) includes a matrix H⁰(ω) including elements of degree n=0, a matrix H¹(ω) including elements of degree n=1, a matrix H²(ω) including elements of degree n=2, and a matrix H³(ω) including elements of degree n=3.

In such a case, for example, it is only required to obtain norms for the matrices H⁰(ω) to H³(ω) including elements of each degree n, and set the allowable errors ε₀ to ε₃ on the basis of the norms.

Moreover, the allowable error ε₀ may be determined for each time frequency ω for each degree n.

### Other Modification Example 3

In a case where sensor information of the head rotation sensor unit is transmitted to the computer 1 wirelessly or by other means, or in a case where the headphones for reproduction are integrated with the head rotation sensor and the headphone reproduction signal is transmitted wirelessly or by other means from the computer 1, there is a possibility that a delay occurs.

In this case, in a case where the operation amount in the computer 1 is not limited, it is considered that the correct rotation operation is performed, and the rotation Δg corresponding to the delay is performed in the computer 2 mounted on the headphones.

In a case where the operation amount is limited in the computer 2 mounted on the headphones, the rotation operation of the rotation Δg corresponding to the delay can be performed with a limited order.

In this case, the vector D′(g, ω) of the input signal subjected to the rotation operation by the computer 1 is transmitted to the headphones, and the computer 2 synthesizes the rotation operation with the limited order of the rotation Δg with the input signal D′(g, ω) and the vector H′(ω) of the head-related transfer function in the spherical harmonic domain to generate drive signals of the left and right headphones.

<Configuration Example of Computer>

Incidentally, the series of processes described above can be executed by hardware, and can also be executed by software. In a case where the series of processes is executed by software, a program constituting the software is installed in a computer. Here, the computer includes a computer incorporated in dedicated hardware, a general-purpose computer for example that can execute various functions by installing various programs, and the like.

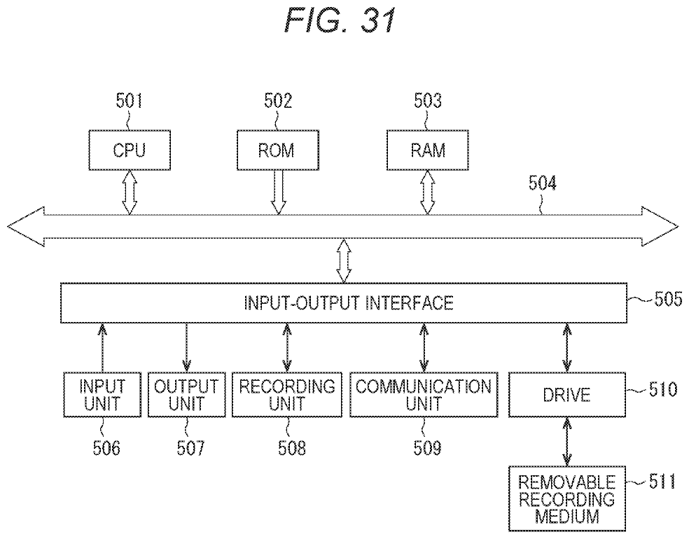

FIG. 31 is a block diagram illustrating a configuration example of hardware of a computer that executes the above-described series of processes by a program.

In the computer, a central processing unit (CPU) 501, a read only memory (ROM) 502, and a random access memory (RAM) 503 are interconnected via a bus 504.

An input-output interface 505 is further connected to the bus 504. An input unit 506, an output unit 507, a recording unit 508, a communication unit 509, and a drive 510 are connected to the input-output interface 505.

The input unit 506 includes a keyboard, a mouse, a microphone, an imaging element, and the like. The output unit 507 includes a display, a speaker array, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input-output interface 505 and the bus 504, and executes the program, so as to perform the above-described series of processes.

The program executed by the computer (CPU 501) can be provided by being recorded on, for example, a removable recording medium 511 as a package medium or the like. Furthermore, the program can be provided via a wired or wireless transmission medium such as a local area network, the Internet, or digital satellite broadcasting.

In the computer, the program can be installed in the recording unit 508 via the input-output interface 505 by mounting the removable recording medium 511 to the drive 510. Furthermore, the program can be received by the communication unit 509 via a wired or wireless transmission medium and installed in the recording unit 508. In addition, the program can be installed in the ROM 502 or the recording unit 508 in advance.

Note that the program executed by the computer may be a program for processing in time series in the order described in the present description, or a program for processing in parallel or at a necessary timing such as when a call is made.

Furthermore, the embodiments of the present technology are not limited to the above-described embodiments, and various modifications are possible without departing from the scope of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

Furthermore, the effects described in the present description are merely examples and are not limited, and other effects may be provided.

Moreover, the present technology can also have the following configurations.

(1)

A signal processing device including:

an order determination unit that determines an order for limiting an operation amount of an operation related to a rotation matrix corresponding to head rotation of a listener;

a rotation operation unit that rotates a head-related transfer function of a spherical harmonic domain by the operation in which the rotation matrix is limited by the order; and

a synthesis unit that generates a headphone drive signal by synthesizing the head-related transfer function after rotation obtained by the operation with a sound signal in the spherical harmonic domain.

(2)

The signal processing device according to (1), in which

the order determination unit determines the order by setting an allowable value of an error of the operation related to the rotation matrix or setting an upper limit of the operation amount.

(3)

The signal processing device according to (2), in which

the order determination unit obtains a degree of Taylor expansion in which a truncation error when the rotation matrix is Taylor expanded is equal to or less than an allowable error corresponding to the allowable value, and determines the order on the basis of the degree of the Taylor expansion.

(4)

The signal processing device according to (2) or (3), in which

the order determination unit determines the order for each time frequency.

(5)

The signal processing device according to any one of (2) to (4), in which

the order determination unit determines the order for each degree of the spherical harmonic domain.

(6)

The signal processing device according to any one of (2) to (5), in which

the rotation operation unit performs an operation of rotating the head-related transfer function by the rotation matrix only for an element of the order in a predetermined range as the operation in which the rotation matrix is limited by the order.

(7)

The signal processing device according to any one of (2) to (5), in which

for a rotation operation of the head-related transfer function with respect to at least one rotation direction, the rotation operation unit obtains the head-related transfer function after the rotation at a predetermined time by performing the rotation operation at the predetermined time using an operation result of the rotation operation in the rotation direction at another time before the predetermined time.

(8)

The signal processing device according to (7), in which

the rotation operation unit performs the rotation operation in the rotation direction at the predetermined time on the basis of a rotation matrix according to a difference between a rotation angle in the rotation direction of the head of the listener at the predetermined time and a rotation angle in the rotation direction of the head of the listener at the another time, and an operation result of the rotation operation in the rotation direction at the another time.

(9)

The signal processing device according to (8), in which the rotation operation unit performs the rotation operation only for an element of the order in a predetermined range as the operation in which the rotation matrix is limited by the order.

(10)

The signal processing device according to (8) or (9), in which

the rotation operation unit performs the rotation operation in the rotation direction at the predetermined time using an operation result of the rotation operation in the rotation direction at the another time for an elevation angle direction as the rotation direction.

(11)

The signal processing device according to any one of (8) to (10), in which

the rotation operation unit

performs, in a case where reset of the rotation matrix is not performed, the rotation operation in the rotation direction at the predetermined time by using an operation result of the rotation operation in the rotation direction at the another time, and

performs, in a case where the reset of the rotation matrix is performed, the rotation operation in the rotation direction at the predetermined time on the basis of a rotation matrix according to a rotation angle in the rotation direction of the head of the listener at the predetermined time and the head-related transfer function.

(12)

The signal processing device according to (11), in which

the order determination unit performs the reset on the basis of an upper limit of accumulation of the allowable value at each time.

(13)

The signal processing device according to (11) or (12), in which

the reset is performed for each degree, for each order, or for each time frequency.

(14)

The signal processing device according to any one of (11) to (13), in which

in a case where the headphone drive signal is generated for each of a plurality of the listeners, the reset is performed for each of the listeners.

(15)

The signal processing device according to any one of (1) to (14), in which

in a case where a rotation matrix for performing rotation in a predetermined rotation direction constituting the rotation matrix corresponding to the head rotation is represented by a sum of a plurality of matrices, the rotation operation unit performs an operation of rotating the head-related transfer function by using a sum of several matrices among the plurality of the matrices as a rotation matrix for performing rotation in the predetermined rotation direction as the operation in which the rotation matrix is limited by the order.

(16)

A signal processing method including:

by a signal processing device,

determining an order for limiting an operation amount of an operation related to a rotation matrix corresponding to head rotation of a listener;

rotating a head-related transfer function of a spherical harmonic domain by the operation in which the rotation matrix is limited by the order; and

generating a headphone drive signal by synthesizing the head-related transfer function after rotation obtained by the operation with a sound signal in the spherical harmonic domain.

(17)

A program for causing a computer to execute processing including steps of:

determining an order for limiting an operation amount of an operation related to a rotation matrix corresponding to head rotation of a listener;

rotating a head-related transfer function of a spherical harmonic domain by the operation in which the rotation matrix is limited by the order; and

generating a headphone drive signal by synthesizing the head-related transfer function after rotation obtained by the operation with a sound signal in the spherical harmonic domain.

### REFERENCE SIGNS LIST

11 Audio processing device
21 Head rotation sensor unit
22 Previous direction retention unit
23 Rotation matrix operation unit
24 Rotation operation unit
25 Rotation coefficient retention unit
26 Head-related transfer function retention unit
27 Head-related transfer function synthesis unit
28 Time-frequency inverse transform unit
201 Order determination unit

1. A signal processing device comprising:
an order determination unit that determines an order for limiting an operation amount of an operation related to a rotation matrix corresponding to head rotation of a listener;
a rotation operation unit that rotates a head-related transfer function of a spherical harmonic domain by the operation in which the rotation matrix is limited by the order; and
a synthesis unit that generates a headphone drive signal by synthesizing the head-related transfer function after rotation obtained by the operation with a sound signal in the spherical harmonic domain.

2. The signal processing device according to claim 1, wherein
the order determination unit determines the order by setting an allowable value of an error of the operation related to the rotation matrix or setting an upper limit of the operation amount.

3. The signal processing device according to claim 2, wherein
the order determination unit obtains a degree of Taylor expansion in which a truncation error when the rotation matrix is Taylor expanded is equal to or less than an allowable error corresponding to the allowable value, and determines the order on a basis of the degree of the Taylor expansion.

4. The signal processing device according to claim 2, wherein
the order determination unit determines the order for each time frequency.

5. The signal processing device according to claim 2, wherein
the order determination unit determines the order for each degree of the spherical harmonic domain.

6. The signal processing device according to claim 2, wherein
the rotation operation unit performs an operation of rotating the head-related transfer function by the rotation matrix only for an element of the order in a predetermined range as the operation in which the rotation matrix is limited by the order.

7. The signal processing device according to claim 2, wherein
for a rotation operation of the head-related transfer function with respect to at least one rotation direction, the rotation operation unit obtains the head-related transfer function after the rotation at a predetermined time by performing the rotation operation at the predetermined time using an operation result of the rotation operation in the rotation direction at another time before the predetermined time.

8. The signal processing device according to claim 7, wherein
the rotation operation unit performs the rotation operation in the rotation direction at the predetermined time on a basis of a rotation matrix according to a difference between a rotation angle in the rotation direction of the head of the listener at the predetermined time and a rotation angle in the rotation direction of the head of the listener at the another time, and an operation result of the rotation operation in the rotation direction at the another time.

9. The signal processing device according to claim 8, wherein
the rotation operation unit performs the rotation operation only for an element of the order in a predetermined range as the operation in which the rotation matrix is limited by the order.

10. The signal processing device according to claim 8, wherein
the rotation operation unit performs the rotation operation in the rotation direction at the predetermined time using an operation result of the rotation operation in the rotation direction at the another time for an elevation angle direction as the rotation direction.

11. The signal processing device according to claim 8, wherein
the rotation operation unit
performs, in a case where reset of the rotation matrix is not performed, the rotation operation in the rotation direction at the predetermined time by using an operation result of the rotation operation in the rotation direction at the another time, and
performs, in a case where the reset of the rotation matrix is performed, the rotation operation in the rotation direction at the predetermined time on a basis of a rotation matrix according to a rotation angle in the rotation direction of the head of the listener at the predetermined time and the head-related transfer function.

12. The signal processing device according to claim 11, wherein
the order determination unit performs the reset on a basis of an upper limit of accumulation of the allowable value at each time.

13. The signal processing device according to claim 11, wherein
the reset is performed for each degree, for each order, or for each time frequency.

14. The signal processing device according to claim 11, wherein
in a case where the headphone drive signal is generated for each of a plurality of the listeners, the reset is performed for each of the listeners.

15. The signal processing device according to claim 1, wherein
in a case where a rotation matrix for performing rotation in a predetermined rotation direction constituting the rotation matrix corresponding to the head rotation is represented by a sum of a plurality of matrices, the rotation operation unit performs an operation of rotating the head-related transfer function by using a sum of several matrices among the plurality of the matrices as a rotation matrix for performing rotation in the predetermined rotation direction as the operation in which the rotation matrix is limited by the order.

16. A signal processing method comprising:
by a signal processing device,
determining an order for limiting an operation amount of an operation related to a rotation matrix corresponding to head rotation of a listener;
rotating a head-related transfer function of a spherical harmonic domain by the operation in which the rotation matrix is limited by the order; and
generating a headphone drive signal by synthesizing the head-related transfer function after rotation obtained by the operation with a sound signal in the spherical harmonic domain.

17. A program for causing a computer to execute processing comprising steps of:
determining an order for limiting an operation amount of an operation related to a rotation matrix corresponding to head rotation of a listener;
rotating a head-related transfer function of a spherical harmonic domain by the operation in which the rotation matrix is limited by the order; and
generating a headphone drive signal by synthesizing the head-related transfer function after rotation obtained by the operation with a sound signal in the spherical harmonic domain.
